(19) United States
(12) Patent Application Publication
(10) Pub. No.: US 2024/0042801 A1
(43) Pub. Date: Feb. 8, 2024

(54) PNEUMATIC TIRE

(71) Applicant: The Yokohama Rubber Co., LTD., Kanagawa (JP)

(72) Inventor: Mizuki KUNINAKA, Kanagawa (JP)

(21) Appl. No.: 18/258,974

(22) PCT Filed: Dec. 7, 2021
(86) PCT No.: PCT/JP2021/045019

§ 371 Date: Jun. 22, 2023

(30) Foreign Application Priority Data
Dec. 28, 2020 (JP) 2020-219405
Oct. 27, 2021 (JP) 2021-175912

(51) Int. Cl. B60C 11/03; B60C 11/13

(52) U.S. Cl. CPC B60C 11/0302; B60C 11/1307; B60C 11/1392; B60C 2011/0341

(57) ABSTRACT

The pneumatic tire of the present disclosure has a designated mounting direction with respect to a vehicle includes a plurality of circumferential main grooves on a tread surface of a tread portion. In a tire plan view, a groove center line of the circumferential main grooves is periodically displaced in a tire width direction as it extends in a tire circumferential direction, and a vehicle mounting inner side chamfered portion, a chamfer width of which is constant, is formed at an edge portion on a vehicle mounting inner side of the circumferential main groove.

### TECHNICAL FIELD

The present disclosure relates to a pneumatic tire that provides improved wet steering stability and dry steering stability.

### BACKGROUND ART

Japan Unexamined Patent Publication No. 2017-24657 A discloses a pneumatic tire that includes four main grooves extending along a tire circumferential direction on a tread surface of a tread portion. In the document, the main grooves are formed in a wave shape having periodic amplitudes and with a groove width being constant in the tire circumferential direction.

Further, according to Japan Unexamined Patent Publication No. 2017-24657 A, since each of the main grooves is formed in a wave shape having periodic amplitudes, the main grooves are as a whole widened and thus can provide good drainage properties and maintain braking performance on wet road surfaces. Further, since the groove width of each main groove is constant in the tire circumferential direction, rigidity near each land portion formed by the main grooves is made uniform, and thus wear resistance performance can be improved.

A pneumatic tire including main grooves that are formed in a wave shape having periodic amplitudes, as in the pneumatic tire disclosed in Japan Unexamined Patent Publication No. 2017-24657 A, has both wet steering stability from drainage properties and the like and dry steering stability from wear resistance and the like.

However, a pneumatic tire having both higher wet steering stability and dry steering stability has been demanded.

### SUMMARY

The present disclosure provides a pneumatic tire that provides wet steering stability and dry steering stability in a compatible manner.

The present disclosure provides the following features.

### Aspect 1

A pneumatic tire in which a mounting direction with respect to a vehicle is designated, the pneumatic tire including
a plurality of circumferential main grooves on a tread surface of a tread portion,
in a tire plan view,
a groove center line of the circumferential main grooves being periodically displaced in a tire width direction while extending in a tire circumferential direction, and
a vehicle mounting inner side chamfered portion being formed at an edge portion on a vehicle mounting inner side of the circumferential main groove, a chamfer width of the vehicle mounting inner side chamfered portion being constant.

### Aspect 2

The pneumatic tire according to Aspect 1, in which a vehicle mounting outer side chamfered portion, the chamfer width of which is constant, is formed at an edge portion on a vehicle mounting outer side of at least the circumferential main groove disposed on a vehicle mounting innermost side, of the plurality of circumferential main grooves.

### Aspect 3

The pneumatic tire according to Aspect 2, in which the following relationship (1) is satisfied, where W_{AI} is a chamfer width of the vehicle mounting inner side chamfered portion and W_{AO} is a chamfer width of the vehicle mounting outer side chamfered portion:

W_{AO}<W_{AI} (1).

### Aspect 4

The pneumatic tire according to any one of Aspects 1 to 3, in which the following relationship (2) is satisfied, where S_{SI} is a total groove area on the vehicle mounting inner side of the circumferential main groove with respect to a tire equatorial plane and S_{SO} is a total groove area on a vehicle mounting outer side of the circumferential main groove with respect to the tire equatorial plane:

S_{SO}<S_{SI} (2).

### Aspect 5

The pneumatic tire according to any one of Aspects 1 to 4, in which an average groove width of the circumferential main groove on the vehicle mounting inner side is larger than an average groove width of the circumferential main groove on a vehicle mounting outer side in relation to two of the circumferential main grooves adjacent to each other.

### Aspect 6

The pneumatic tire according to any one of Aspects 1 to 5, in which an average groove width of the circumferential main groove on the vehicle mounting inner side is larger than an average groove width of the circumferential main groove on a vehicle mounting outer side in all combinations of two of the circumferential main grooves adjacent to each other.

### Aspect 7

The pneumatic tire according to any one of Aspects 1 to 6, in which, in a tire meridian cross-sectional view, the following relationship (3) is satisfied, where d_{G} is a maximum value of a length in a tire radial direction from a tire surface profile, when the circumferential main groove is not present, to a groove bottom of the circumferential main groove and d_{CI} is a maximum value of a length in the tire radial direction from the tire surface profile to an innermost position in the tire radial direction of the vehicle mounting inner side chamfered portion:

0.05<d_{CI}/d_{G}<0.40 (3).

### Aspect 8

The pneumatic tire according to any one of Aspects 1 to 7, in which, in a tire meridian cross-sectional view, in relation to at least the circumferential main groove disposed on a vehicle mounting innermost side, of the plurality of circumferential main grooves, the following relationship (4) is satisfied, where θ_{G1} is an inclination angle of a vehicle mounting inner side groove wall of the circumferential main groove with respect to a tire radial direction and θ_{GO} is an inclination angle of a vehicle mounting outer side groove wall of the circumferential main groove with respect to the tire radial direction:

θ_{GI}<θ_{GO} (4).

### Aspect 9

The pneumatic tire according to any one of Aspects 1 to 8, further comprising first inclined grooves, second inclined grooves, third inclined grooves, and fourth inclined grooves, in which
the first inclined grooves extend toward respective vehicle mounting sides from the circumferential main groove, as a starting point, disposed on a vehicle mounting innermost side, of the plurality of circumferential main grooves, and a terminating end portion in a vehicle mounting outer side direction of the first inclined grooves terminates in a land portion adjacent on a vehicle mounting outer side to the circumferential main groove disposed on the vehicle mounting innermost side, of the plurality of circumferential main grooves, and a terminating end portion in a vehicle mounting inner side direction of the first inclined grooves terminates in a land portion adjacent on the vehicle mounting inner side to the circumferential main groove disposed on the vehicle mounting innermost side, of the plurality of circumferential main grooves,
the second inclined grooves extend toward the vehicle mounting outer side from the circumferential main groove, as a starting point, disposed on a vehicle mounting outermost side, of the plurality of circumferential main grooves, and a terminating end portion in the vehicle mounting outer side direction of the second inclined groove terminates in a land portion adjacent on the vehicle mounting outer side to the circumferential main groove disposed on the vehicle mounting outermost side, of the plurality of circumferential main grooves, and a terminating end portion in the vehicle mounting inner side direction of the second inclined groove terminates in communication with the circumferential main groove disposed on the vehicle mounting outermost side, of the plurality of circumferential main grooves,
the third inclined grooves are disposed such that both ends of the third inclined grooves terminate in the land portion adjacent on the vehicle mounting inner side to the circumferential main groove disposed on the vehicle mounting innermost side, of the plurality of circumferential main groove, and
the fourth inclined grooves are disposed such that both ends of the fourth inclined grooves terminate in the land portion adjacent on the vehicle mounting outer side to the circumferential main groove disposed on the vehicle mounting outermost side, of the plurality of circumferential main grooves.

### Aspect 10

The pneumatic tire according to Aspect 9, further comprising fifth inclined grooves disposed such that both ends of the fifth inclined grooves terminate in the land portion adjacent on the vehicle mounting outer side to the circumferential main groove disposed on the vehicle mounting outermost side, of the plurality of circumferential main grooves, the fifth inclined grooves being shorter in groove length than the fourth inclined grooves.

### Aspect 11

The pneumatic tire according to Aspect 10, in which with respect to the tire width direction, the third inclined groove and the fourth inclined groove extend across ground contact edges, respectively, and the fifth inclined groove terminates at a tire equatorial plane side with respect to the ground contact edge.

### Aspect 12

The pneumatic tire according to Aspect 10 or 11, in which an orientation of an acute angle formed by each of the second inclined groove, the third inclined groove, and the fourth inclined groove with respect to the tire width direction is equal to an orientation of an acute angle formed by the first inclined groove with respect to the tire width direction, and an orientation of an acute angle formed by the fifth inclined groove with respect to the tire width direction is different from the orientation of the acute angle formed by the first inclined groove with respect to the tire width direction.

### Aspect 13

The pneumatic tire according to any one of Aspects 9 to 11, in which an orientation of an acute angle formed by each of the second inclined groove and the fourth inclined groove with respect to the tire width direction is equal to an orientation of an acute angle formed by the first inclined groove with respect to the tire width direction, and an orientation of an acute angle formed by the third inclined groove with respect to the tire width direction is different from the orientation of the acute angle formed by the first inclined groove with respect to the tire width direction.

### Aspect 14

The pneumatic tire according to any one of Aspects 9 to 13, in which with respect to the tire circumferential direction, a terminating end portion on the vehicle mounting outer side of the third inclined groove terminates between end portions on the vehicle mounting inner side of two of the first inclined grooves adjacent to each other, and/or a terminating end portion on the vehicle mounting inner side of the fourth inclined groove terminates between end portions on the vehicle mounting outer side of two of the second inclined grooves adjacent to each other.

### Aspect 15

The pneumatic tire according to any one of Aspects 9 to 14, in which the first inclined grooves extend toward the respective vehicle mounting sides to communicate with a portion projected toward the vehicle mounting inner side and a portion recessed toward the vehicle mounting outer side of the circumferential main groove disposed on the vehicle mounting innermost side, of the plurality of circumferential main grooves.

### Aspect 16

The pneumatic tire according to any one of Aspects 9 to 15, in which the terminating end portion on the vehicle mounting inner side of the second inclined groove is in communication with a portion projected toward the vehicle mounting outer side of the circumferential main groove disposed on the vehicle mounting outermost side, of the plurality of circumferential main grooves.

### Aspect 17

The pneumatic tire according to any one of Aspects 9 to 16, in which the following relationship (5) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{L} is a length in the tire width direction of the land portion adjacent on the vehicle mounting outer side to the circumferential main groove disposed on the vehicle mounting innermost side, of the plurality of circumferential main grooves:

0.20<L_{IG1}/L_{L}<0.60 (5).

### Aspect 18

The pneumatic tire according to any one of Aspects 9 to 17, in which the terminating end portion in the vehicle mounting outer side direction of the second inclined groove terminates between two of the fourth inclined grooves adjacent to each other in the tire circumferential direction, and
the following relationship (6) is satisfied, where L_{G4G4} is a length in the tire circumferential direction from one to an other of two of the fourth inclined grooves adjacent to each other and L_{G2G4} is a length in the tire circumferential direction from one of two of the fourth inclined grooves adjacent to each other to the terminating end portion of the second inclined groove:

0.40<L_{G2G4}/L_{G4G4}<0.60 (6).

### Aspect 19

The pneumatic tire according to any one of Aspects 9 to 18, in which the following relationships (7) to (10) are satisfied, where in a tire meridian cross-sectional view, d_{G} is a maximum value of a length in a tire radial direction from a tire surface profile, when the circumferential main groove and the inclined grooves are not present, to a groove bottom of the circumferential main groove and d_{IG1}, d_{IG2}, d_{IG3}, and d_{IG4} are respectively maximum values of lengths in the tire radial direction from the tire surface profile to groove bottoms of the first inclined groove, the second inclined groove, the third inclined groove, and the fourth inclined groove:

0.05<d_{IG1}/d_{G}<0.85 (7),

0.05<d_{IG2}/d_{G}<0.85 (8),

0.05<d_{IG3}/d_{G}<0.85 (9), and

0.05<d_{IG4}/d_{G}<0.85 (10).

### Aspect 20

The pneumatic tire according to any one of Aspects 9 to 19, in which the following relationship (11) is satisfied, where in a tire meridian cross-sectional view, dG1 is a maximum value of a length in a tire radial direction from a tire surface profile, when the circumferential main groove and the inclined grooves are not present, to a groove bottom of the circumferential main groove disposed on the vehicle mounting innermost side, of the plurality of circumferential main grooves, dIG1′ is a maximum value of a length in the tire radial direction from the tire surface profile to a groove bottom in a portion of the first inclined groove, which is located on the vehicle mounting outer side from the circumferential main groove, as a starting point, disposed on the vehicle mounting innermost side, of the plurality of circumferential main grooves, and dIG1″ is a maximum value of a length in the tire radial direction length from the tire surface profile to a groove bottom in a portion of the first inclined groove, which is located on the vehicle mounting inner side from the circumferential main groove, as a starting point, disposed on the vehicle mounting innermost side, of the plurality of circumferential main grooves:

d_{IG1′}<d_{IG1″}<d_{G1} (11).

### Aspect 21

The pneumatic tire according to any one of Aspects 9 to 20, in which the following relationship (12) is satisfied, where LIG1 is a length in the tire width direction of a portion of the first inclined groove, which extends toward the vehicle mounting outer side from the circumferential main groove disposed on the vehicle mounting innermost side, of the plurality of circumferential main grooves, and LIG2 is a length in the tire width direction of a portion of the first inclined groove, which extends toward the vehicle mounting inner side from the circumferential main groove disposed on the vehicle mounting innermost side, of the plurality of circumferential main grooves:

L_{IG1}<L_{IG2} (12).

### Aspect 22

A pneumatic tire in which a mounting direction with respect to a vehicle is designated, the pneumatic tire including:
a plurality of circumferential main grooves, first inclined grooves, and second inclined grooves on a tread surface of a tread portion,
in a tire plan view, a groove center line of the circumferential main grooves being periodically displaced in a tire width direction while extending in a tire circumferential direction,
the first inclined grooves extending toward respective vehicle mounting sides from the circumferential main groove, as a starting point, disposed on a vehicle mounting innermost side, of the plurality of circumferential main grooves, and
the second inclined grooves extending toward a vehicle mounting outer side from the circumferential main groove, as a starting point, disposed on a vehicle mounting outermost side, of the plurality of circumferential main grooves.

### Aspect 23

The pneumatic tire according to Aspect 22, in which a terminating end portion in a vehicle mounting outer side direction of the first inclined grooves terminates in a land portion adjacent on the vehicle mounting outer side to the circumferential main groove disposed on the vehicle mounting innermost side, of the plurality of circumferential main grooves, and a terminating end portion in a vehicle mounting inner side direction of the first inclined grooves terminates in a land portion adjacent on a vehicle mounting inner side to the circumferential main groove disposed on the vehicle mounting innermost side, of the plurality of circumferential main grooves.

### Aspect 24

The pneumatic tire according to Aspect 22 or 23, in which a terminating end portion in a vehicle mounting outer side direction of the second inclined groove terminates in a land portion adjacent on the vehicle mounting outer side to the circumferential main groove disposed on the vehicle mounting outermost side, of the plurality of circumferential main grooves, and a terminating end portion in a vehicle mounting inner side direction of the second inclined groove terminates in communication with the circumferential main groove disposed on the vehicle mounting outermost side, of the plurality of circumferential main grooves.

### Aspect 25

The pneumatic tire according to any one of Aspects 22 to 24, in which the following relationship (13) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{IG2} is a length in the tire width direction of a portion of the first inclined groove, which extends toward a vehicle mounting inner side from the circumferential main groove disposed on the vehicle mounting innermost side, of the plurality of circumferential main grooves:

L_{IG1}<L_{IG2} (13).

### Aspect 26

The pneumatic tire according to any one of Aspects 22 to 25, in which the first inclined grooves extend toward the respective vehicle mounting sides to communicate with a portion projected toward a vehicle mounting inner side and a portion recessed toward the vehicle mounting outer side of the circumferential main groove disposed on the vehicle mounting innermost side, of the plurality of circumferential main grooves.

### Aspect 27

The pneumatic tire according to any one of Aspects 22 to 26, in which the following relationship (14) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{L} is a length in the tire width direction of a land portion adjacent on the vehicle mounting outer side to the circumferential main groove disposed on the vehicle mounting innermost side, of the plurality of circumferential main grooves:

0.20<L_{IG1}/L_{L}<0.60 (14).

### Aspect 28

The pneumatic tire according to any one of Aspects 22 to 27, in which the following relationship (15) is satisfied, where in a tire meridian cross-sectional view, d_{G1} is a maximum value of a length in a tire radial direction from a tire surface profile, when the circumferential main groove and the inclined grooves are not present, to a groove bottom of the circumferential main groove disposed on the vehicle mounting innermost side, of the plurality of circumferential main grooves, d_{IG1′} is a maximum value of a length in the tire radial direction from the tire surface profile to a groove bottom in a portion of the first inclined groove, which is located on the vehicle mounting outer side from the circumferential main groove, as a starting point, disposed on the vehicle mounting innermost side, of the plurality of circumferential main grooves, and d_{IG1″} is a maximum value of a length in the tire radial direction length from the tire surface profile to a groove bottom in a portion of the first inclined groove, which is located on a vehicle mounting inner side from the circumferential main groove, as a starting point, disposed on the vehicle mounting innermost side, of the plurality of circumferential main grooves:

d_{IG1′}<d_{IG1″}<d_{G1} (15).

### Aspect 29

The pneumatic tire according to any one of Aspects 22 to 28, in which a terminating end portion on a vehicle mounting inner side of the second inclined groove is in communication with a portion projected toward the vehicle mounting outer side of the circumferential main groove disposed on the vehicle mounting outermost side, of the plurality of circumferential main grooves.

### Aspect 30

The pneumatic tire according to any one of Aspects 22 to 29, further comprising third inclined grooves and fourth inclined grooves, in which
the third inclined grooves are disposed such that both ends of the third inclined grooves terminate in a land portion adjacent on a vehicle mounting inner side to the circumferential main groove disposed on the vehicle mounting innermost side, of the plurality of circumferential main groove, and
the fourth inclined grooves are disposed such that both ends of the fourth inclined grooves terminate in a land portion adjacent on the vehicle mounting outer side to the circumferential main groove disposed on the vehicle mounting outermost side, of the plurality of circumferential main grooves.

### Aspect 31

The pneumatic tire according to Aspect 30, further comprising fifth inclined grooves disposed such that both ends of the fifth inclined grooves terminate in the land portion adjacent on the vehicle mounting outer side to the circumferential main groove disposed on the vehicle mounting outermost side, of the plurality of circumferential main grooves, the fifth inclined grooves being shorter in groove length than the fourth inclined grooves.

### Aspect 32

The pneumatic tire according to Aspect 31, in which with respect to the tire width direction, the third inclined groove and the fourth inclined groove extend across ground contact edges, respectively, and the fifth inclined groove terminates at a tire equatorial plane side with respect to the ground contact edge.

### Aspect 33

The pneumatic tire according to Aspect 31 or 32, in which an orientation of an acute angle formed by each of the second inclined groove, the third inclined groove, and the fourth inclined groove with respect to the tire width direction is equal to an orientation of an acute angle formed by the first inclined groove with respect to the tire width direction, and an orientation of an acute angle formed by the fifth inclined groove with respect to the tire width direction is different from the orientation of the acute angle formed by the first inclined groove with respect to the tire width direction.

### Aspect 34

The pneumatic tire according to any one of Aspects 30 to 32, in which an orientation of an acute angle formed by each of the second inclined groove and the fourth inclined groove with respect to the tire width direction is equal to an orientation of an acute angle formed by the first inclined groove with respect to the tire width direction, and an orientation of an acute angle formed by the third inclined groove with respect to the tire width direction is different from the orientation of the acute angle formed by the first inclined groove with respect to the tire width direction.

### Aspect 35

The pneumatic tire according to any one of Aspects 30 to 34, in which with respect to the tire circumferential direction, a terminating end portion on the vehicle mounting outer side of the third inclined groove terminates between end portions on the vehicle mounting inner side of two of the first inclined grooves adjacent to each other, and/or a terminating end portion on the vehicle mounting inner side of the fourth inclined groove terminates between end portions on the vehicle mounting outer side of two of the second inclined grooves adjacent to each other.

### Aspect 36

The pneumatic tire according to any one of Aspects 30 to 35, in which
a terminating end portion in a vehicle mounting outer side direction of the second inclined groove terminates between two of the fourth inclined grooves adjacent to each other in the tire circumferential direction, and
the following relationship (16) is satisfied, where L_{G4G4} is a length in the tire circumferential direction from one to an other of two of the fourth inclined grooves adjacent to each other and L_{G2G4} is a length in the tire circumferential direction from one of two of the fourth inclined grooves adjacent to each other to the terminating end portion of the second inclined groove:

0.40<L_{G2G4}/L_{G4G4}<0.60 (16).

### Aspect 37

The pneumatic tire according to any one of Aspects 30 to 36, in which the following relationships (17) to (20) are satisfied, where in a tire meridian cross-sectional view, d_{G} is a maximum value of a length in a tire radial direction from a tire surface profile, when the circumferential main groove and the inclined grooves are not present, to a groove bottom of the circumferential main groove and d_{IG1}, d_{IG2}, d_{IG3}, and d_{IG4} are respectively maximum values of lengths in the tire radial direction from the tire surface profile to groove bottoms of the first inclined groove, the second inclined groove, the third inclined groove, and the fourth inclined groove:

0.05<d_{IG1}/d_{G}<0.85 (17),

0.05<d_{IG2}/d_{G}<0.85 (18),

0.05<d_{IG3}/d_{G}<0.85 (19), and

0.05<d_{IG4}/d_{G}<0.85 (20).

### Aspect 38

The pneumatic tire according to any one of Aspects 22 to 37, in which the following relationship (21) is satisfied, where S_{SI} is a total groove area on a vehicle mounting inner side of the circumferential main groove with respect to a tire equatorial plane and S_{SO} is a total groove area on the vehicle mounting outer side of the circumferential main groove with respect to the tire equatorial plane:

S_{SO}<S_{SI} (21).

### Aspect 39

The pneumatic tire according to any one of Aspects 22 to 38, in which an average groove width of the circumferential main groove on a vehicle mounting inner side is larger than an average groove width of the circumferential main groove on the vehicle mounting outer side in relation to any one pair of two of the circumferential main grooves adjacent to each other.

### Aspect 40

The pneumatic tire according to any one of Aspects 22 to 39, in which an average groove width of the circumferential main groove on a vehicle mounting inner side is larger than an average groove width of the circumferential main groove on the vehicle mounting outer side in all combinations of two of the circumferential main grooves adjacent to each other.

### Aspect 41

The pneumatic tire according to any one of Aspects 22 to 40, in which in a tire meridian cross-sectional view, in relation to at least the circumferential main groove disposed on the vehicle mounting innermost side, of the plurality of circumferential main grooves, the following relationship (22) is satisfied, where Ow is an inclination angle of a vehicle mounting inner side groove wall of the circumferential main groove with respect to a tire radial direction and θ_{GO} is an inclination angle of a vehicle mounting outer side groove wall of the circumferential main groove with respect to the tire radial direction:

θ_{GI}<θ_{GO} (22).

According to the present disclosure, a pneumatic tire that provides wet steering stability and dry steering stability in a compatible manner can be provided.

### BRIEF DESCRIPTION OF DRAWINGS

FIG. 1 is a plan view of a tread surface 100 of a tread portion in an example of a pneumatic tire according to Basic Embodiment of the present disclosure.

FIG. 2 is a plan view of a tread surface 200 of the tread portion in another example of the pneumatic tire according to Basic Embodiment of the present disclosure.

FIG. 3 is an enlarged view of a portion indicated by X in FIG. 1.

FIG. 4 is a cross-sectional view taken along the line A₁₁-A₁₂ of a first circumferential main groove 110 in FIG. 1.

FIG. 5 is a cross-sectional view taken along the line A₂₁-A₂₂ of a first circumferential main groove 210 in FIG. 2.

FIG. 6 is a cross-sectional view taken along the line B₂₁-B₂₂ of a second circumferential main groove 220 in FIG. 2.

FIG. 7 is a cross-sectional view taken along the line C₂₁-C₂₂ of a third circumferential main groove 230 in FIG. 2.

FIG. 8 is a cross-sectional view taken along the line D₂₁-D₂₂ of a fourth inclined groove 270 in FIG. 2.

### DETAILED DESCRIPTION

Hereinafter, embodiments of a pneumatic tire according to the present technology will be described in detail with reference to the drawings. Note that the embodiments and the drawings do not limit the present technology. Constituents of the embodiments include constituents that can be substituted or easily conceived by one skilled in the art or substantially identical constituents. In addition, various modes included in the embodiments can be combined as desired within the scope of obviousness by one skilled in the art.

Hereinafter, “tire radial direction” refers to a direction orthogonal to a tire rotation axis (not illustrated).

In the present disclosure, “tire circumferential direction” refers to a circumferential direction about the tire rotation axis as a center axis. In the present disclosure, “tire width direction” is a direction parallel with the tire rotation axis. Note that “tire equatorial plane” refers to a plane that is orthogonal to the tire rotation axis and that passes through the center of a tire width of the tire.

In the present disclosure, “vehicle mounting inner side” refers to the side closer to the vehicle with reference to a certain position on the pneumatic tire in a state where the pneumatic tire of the present disclosure is mounted on the vehicle. “Vehicle mounting outer side” refers to the side farther from the vehicle with reference to a certain position on the pneumatic tire in a state where the pneumatic tire of the present disclosure is mounted on the vehicle.

Additionally, in the descriptions below, “regular rim” refers to an “applicable rim” defined by JATMA (The Japan Automobile Tyre Manufacturers Association, Inc.), a “Design Rim” defined by TRA (The Tire and Rim Association, Inc.), or a “Measuring Rim” defined by ETRTO (The European Tyre and Rim Technical Organisation). Additionally, a regular internal pressure refers to a “maximum air pressure” specified by JATMA, a maximum value in “TIRE LOAD LIMITS AT VARIOUS COLD INFLATION PRESSURES” specified by TRA, or “INFLATION PRESSURES” specified by ETRTO. Moreover, “specified load” refers to the “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

### Basic Embodiment 1

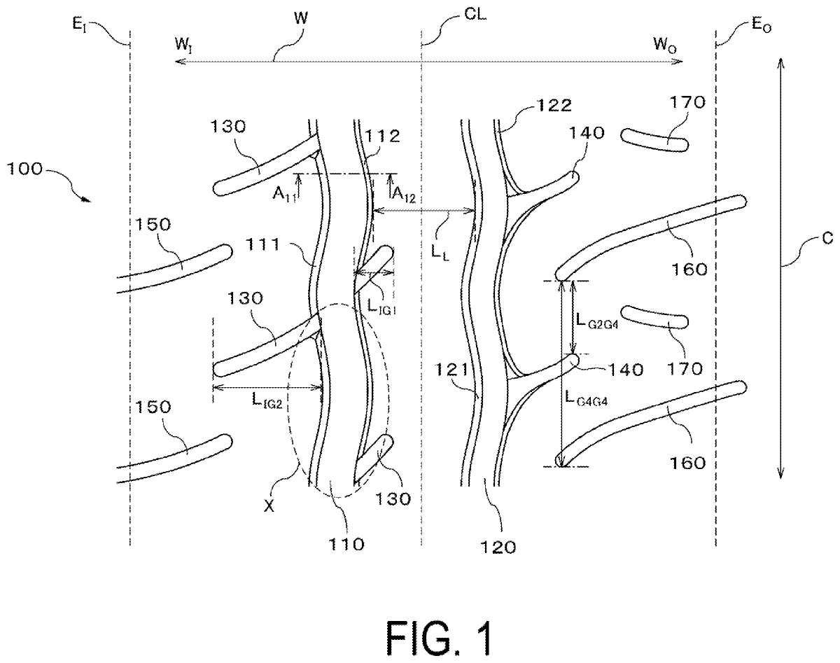

FIG. 1 is a plan view of a tread surface 100 of a tread portion in an example of a pneumatic tire according to Basic Embodiment of the present disclosure. In FIG. 1, “W” indicates the tire width direction and “C” indicates the tire circumferential direction. Furthermore, “W_{I}” indicates the vehicle mounting inner side and “W_{O}” indicates the vehicle mounting outer side.

As illustrated in FIG. 1, the pneumatic tire according to Basic Embodiment of the present disclosure has a mounting direction designated with respect to the vehicle. The tread surface 100 of the tread portion is provided with a plurality of circumferential main grooves 110, 120. Note that in FIG. 1, the first circumferential main groove 110 and the second circumferential main groove 120 are provided in this order from the vehicle mounting inner side W_{I}. The groove widths of the circumferential main grooves 110, 120 may be constant.

In a tire plan view, the groove center lines of the circumferential main grooves 110, 120 are periodically displaced in the tire width direction W as they extend in the tire circumferential direction C.

Vehicle mounting inner side chamfered portions 111, 121 having a constant chamfer width are formed at edge portions on the vehicle mounting inner side of the circumferential main grooves 110, 120.

Here, that the groove width is constant means that a ratio of the minimum value of the groove width to the maximum value of the groove width is 0.90 or more. The ratio of the minimum value of the groove width to the maximum value of the groove width may be 0.90 or more, 0.92 or more, 0.95 or more, or 0.99 or more. Note that the ratio of the minimum value of the groove width to the maximum value of the groove width is 1.00 or less. Here, the “groove width” of the circumferential main groove is a length in the tire width direction of the circumferential main groove. Note that the average groove width of the circumferential main groove is an average value of groove widths of the circumferential main groove entirely in the circumferential direction of the pneumatic tire, and may be simply calculated, for example, as an arithmetic average of groove widths at any different hundred points in the circumferential direction of the circumferential main groove.

Further, the “groove center line” means a line connecting, in the tire circumferential direction, center points in the width direction of the groove. Furthermore, that “the groove center line is periodically displaced in the tire width direction as it extends in the tire circumferential direction C” means that the groove center line is periodically displaced to the vehicle mounting inner side W_{I} and the vehicle mounting outer side W_{O} as it extends in the tire circumferential direction C. This periodic displacement can be in, for example, a shape in which recesses and protrusions are alternately repeated with respect to the tire width direction W, and more specifically, a wave shape, a zigzag shape, or the like which has amplitudes with respect to the tire width direction W. Here, the wave shape may be, for example, a rectangular wave, a triangular wave, a sine wave, or the like, but is not limited thereto. Note that the periods of the periodic displacements of each of the circumferential main grooves are preferably the same. In particular, when the periodic displacement is in a wave shape, the wavelength and/or the amplitude of each circumferential main groove is preferably equal.

Further, that the chamfer width is constant means that a ratio of the minimum value of the chamfer width to the maximum value of the chamfer width is 0.90 or more. The ratio of the minimum value of the chamfer width to the maximum value of the chamfer width may be 0.90 or more, 0.92 or more, or more, or 0.99 or more. Note that the ratio of the minimum value of the chamfer width to the maximum value of the chamfer width is 1.00 or less. Here, the “chamfer width” is a length in the tire width direction of the chamfered portion.

Additionally, FIG. 1 is not intended to limit the pneumatic tire according to Basic Embodiment of the present disclosure. In particular, in FIG. 1, two circumferential main grooves are formed in the tread surface. However, in Basic Embodiment of the present disclosure, the number of circumferential main grooves is plural and is not limited to two, and may be three, four or more.

Reasonably, in consideration of the length in the tire width direction of the tread portion of the tire, the number of circumferential main grooves is preferably two or more and five or less. The number of circumferential main grooves may be two or more, three or more, or four or more, and may be five or less, four or less, or three or less.

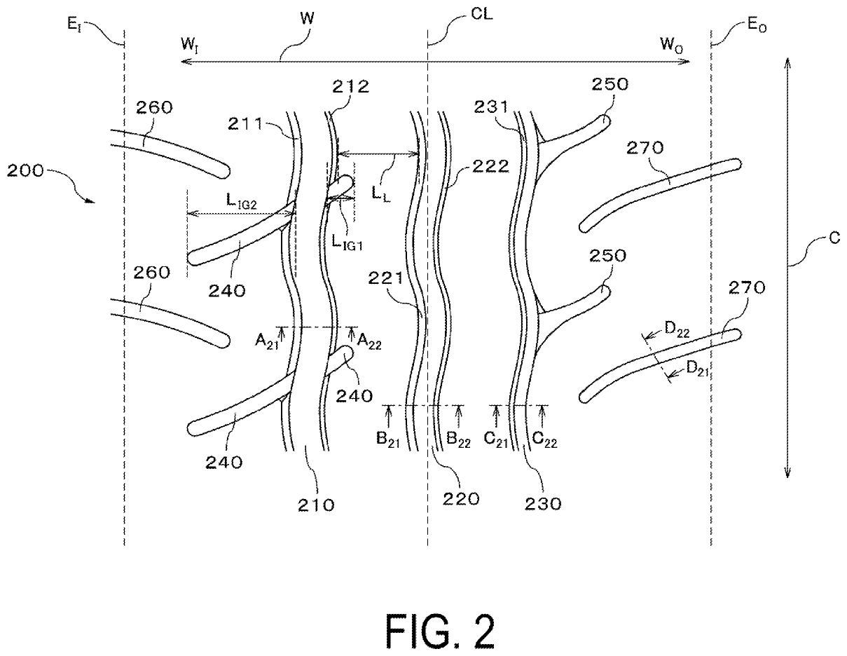

Thus, in addition to the example illustrated in FIG. 1, the example as illustrated in FIG. 2 can be given as the pneumatic tire according to Basic Embodiment of the present disclosure.

FIG. 2 is a plan view of a tread surface 200 of the tread portion in another example of the pneumatic tire according to Basic Embodiment of the present disclosure.

The mounting direction with respect to the vehicle is designated for the pneumatic tire illustrated in FIG. 2. A first circumferential main groove 210, a second circumferential main groove 220, and a third circumferential main groove 230 are provided in this order from the vehicle mounting inner side W_{I} in the tread surface 200 of the tread portion. Here, each of the three circumferential main grooves 210, 220, 230 may have a constant groove width. Additionally, in these circumferential main grooves 210, 220, 230, the groove center lines are periodically displaced in the tire width direction W as they extend in the tire circumferential direction C. More specifically, the groove center lines are each formed in a wave shape that has amplitudes with respect to the tire width direction W. Moreover, vehicle mounting inner side chamfered portions 211, 221, 231 each having a constant chamfer width are formed at edge portions on the vehicle mounting inner side of the circumferential main grooves 210, 220, 230.

Although not limited by the principle, the principle by which wet steering stability and dry steering stability can be achieved in a compatible manner in the pneumatic tire according to Basic Embodiment of the present disclosure is as follows.

The pneumatic tire according to Basic Embodiment of the present disclosure includes a plurality of circumferential main grooves in the tread surface of the tread portion. Additionally, in a tire plan view, the groove center lines of the plurality of circumferential main grooves are periodically displaced in the tire width direction as they extend in the tire circumferential direction.

In the pneumatic tire according to Basic Embodiment of the present disclosure, with such a shape of the circumferential main groove, the groove area can be increased with respect to a linear circumferential main groove having an equal groove width, and thus higher drainage properties can be obtained.

Further, due to such a shape of the circumferential main groove, so-called edge portions of a land portion defined and formed by the circumferential main grooves include not only a tire circumferential component but also a tire width direction component. As a result, the land portion defined and formed by the circumferential main grooves of the present embodiment can exhibit excellent rigidity not only against the force from the tire width direction but also against the force from the tire circumferential direction, and can realize dry steering stability excellent, particularly, in circuit running in which a severe load situation is expected.

In addition, in the pneumatic tire according to Basic Embodiment of the present disclosure, a vehicle mounting inner side chamfered portion having a constant chamfer width is formed at the edge portion on the vehicle mounting inner side of the circumferential main groove. Accordingly, by setting a gentle inclination angle with respect to the tire radial direction, in particular, to a side wall on the vehicle mounting inner side, on which chipping of a block is likely to occur due to wear, of side walls of the circumferential main groove, rigidity of the land portion including this side wall can be enhanced. In addition, by providing the chamfered portion, the groove area is further increased, and thus drainage properties can be enhanced. As a result, excellent wet steering stability, in particular, in circuit running in which a severe load situation is expected can be realized.

As described above, the pneumatic tire according to Basic Embodiment of the present disclosure can achieve wet steering stability and dry steering stability in a compatible manner due to the aforementioned improvement in rigidity of the land portion and the aforementioned improvement in drainage properties. Note that as described above, the pneumatic tire of the present embodiment is a tire suitable, in particular, for circuit running in which a severe load situation is expected.

### Additional Embodiment 1-1

As illustrated in FIGS. 1 and 2, in relation to Basic Embodiment 1, in the pneumatic tire according to Additional Embodiment 1-1 of the present disclosure, the vehicle mounting outer side chamfered portions 112, 212 having a constant chamfer width are formed at edge portions on the vehicle mounting outer side of at least circumferential main grooves disposed on the vehicle mounting innermost side, of the plurality of circumferential main grooves, that is, at the edge portions of the first circumferential main grooves 110, 210 in the respective drawings.

Note that in FIG. 1, a vehicle mounting outer side chamfered portion 122 having a constant chamfer width is also formed at an edge portion on the vehicle mounting outer side of the second circumferential main groove 120.

Further, in FIG. 2, vehicle mounting outer side chamfered portions 212, 222 having a constant chamfer width are formed at edge portions on the vehicle mounting outer side of the first circumferential main groove 210 and the second circumferential main groove 220 of the three circumferential main grooves 210, 220, 230. Furthermore, a chamfered portion is not formed at an edge portion on the vehicle mounting outer side of the third circumferential main groove 230.

In general, dry steering stability and wet steering stability are efficiently improved by preferentially enhancing drainage properties on the vehicle mounting inner side and preferentially enhancing rigidity on the vehicle mounting outer side. This is because ground contact pressure tends to be relatively high on the vehicle mounting outer side and relatively low on the vehicle mounting inner side.

In the pneumatic tire according to Additional Embodiment 1-1 of the present disclosure, in at least the circumferential main groove disposed on the vehicle mounting innermost side, of the plurality of circumferential main grooves, the chamfered portion having a constant chamfer width is also formed at the edge portion on the vehicle mounting outer side of the circumferential main groove, in addition to at the edge portion on the vehicle mounting inner side of the circumferential main groove.

Thus, in the pneumatic tire according to Additional Embodiment 1-1 of the present disclosure, the circumferential main groove with the chamfered portions formed on both vehicle mounting sides, of the plurality of circumferential main grooves, is preferentially set as the circumferential main groove disposed on the vehicle mounting innermost side. Consequently, in the case of viewing the tread surface as a whole, drainage properties can be efficiently improved while a decrease in rigidity is suppressed.

As a result, the pneumatic tire according to Additional Embodiment 1-1 of the present disclosure can provide more improved wet steering stability.

### Additional Embodiment 1-2

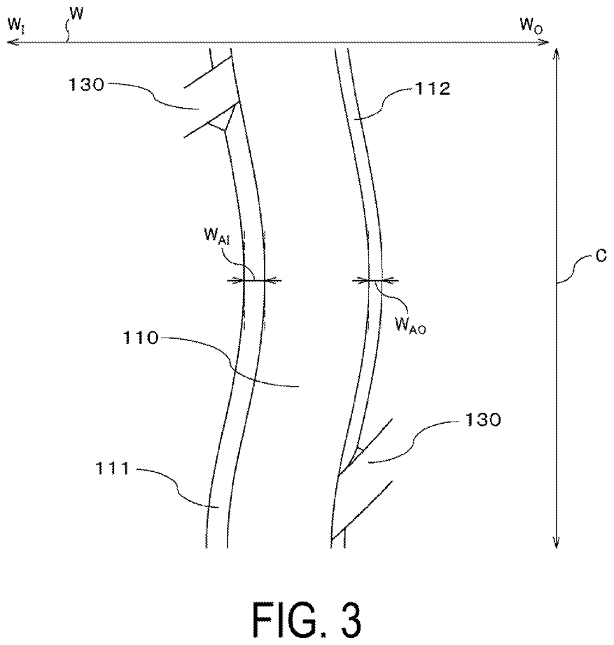

FIG. 3 is an enlarged view of a portion indicated by X in FIG. 1.

As illustrated in FIG. 3, in relation to Additional Embodiment 1-1, the pneumatic tire according to Additional Embodiment 1-2 of the present disclosure satisfies the following relationship (1), where W_{AI} is a chamfer width of the vehicle mounting inner side chamfered portion 111 and W_{AO} is a chamfer width of the vehicle mounting outer side chamfered portion 112.

W_{AO}<W_{AI} (1).

For example, when a vehicle turns, of both side walls of the circumferential main groove, a relatively large stress is applied to the land portion including the side wall on the vehicle mounting outer side compared with the land portion including the side wall on the vehicle mounting inner side. Accordingly, it is desirable to preferentially enhance rigidity of the land portion on the vehicle mounting outer side of the land portions located on both sides of the circumferential main groove over rigidity of the land portion on the vehicle mounting inner side. In the pneumatic tire according to Additional Embodiment 1-2 of the present disclosure, by setting the chamfer width of the vehicle mounting outer side chamfered portion to be smaller than the chamfer width of the vehicle mounting inner side chamfered portion, the rigidity of the land portion on the vehicle mounting outer side of the circumferential main groove is preferably enhanced.

As a result, the pneumatic tire according to Additional Embodiment 1-2 of the present disclosure can efficiently provide enhanced rigidity of the land portion and provide more improved wet steering stability and dry steering stability while achieving the effects of Additional Embodiment 1-1.

Note that a ratio W_{AI}/W_{AO} of the chamfer width W_{AI} of the vehicle mounting inner side chamfered portion to the chamfer width W_{AO} of the vehicle mounting outer side chamfered portion is preferably greater than 1.3 and smaller than 3.0. W_{AI}/W_{AO} may be more than 1.3, 1.5 or more, 1.7 or more, or 1.9 or more, and may be less than 3.0, 2.8 or less, 2.6 or less, or 2.4 or less.

### Additional Embodiment 1-3

In relation to any one of Basic Embodiment 1 and Additional Embodiments 1-1 and 1-2, the pneumatic tire according to Additional Embodiment 1-3 of the present disclosure satisfies the following relationship (2), where S_{SI} is a total groove area on the vehicle mounting inner side of the circumferential main groove with respect to a tire equatorial plane CL and S_{SO} is a total groove area on the vehicle mounting outer side of the circumferential main groove with respect to the tire equatorial plane.

S_{SO}<S_{SI} (2)

Here, in a plan view of the tread surface of the pneumatic tire, the total groove area means the sum of the groove areas, including the chamfered portions, in a predetermined region. Accordingly, for example, the total groove area on the vehicle mounting inner side of the circumferential main groove with respect to the tire equatorial plane CL is the sum of the areas of the circumferential main groove disposed on the vehicle mounting inner side with respect to the tire equatorial plane CL, the circumferential main groove located on the vehicle mounting inner side with respect to the tire equatorial plane CL, and the chamfered portions formed on these circumferential main grooves.

In FIG. 1, the first circumferential main groove 110 and the second circumferential main groove 120 are disposed with the tire equatorial plane CL interposed therebetween. Here, the groove width of the first circumferential main groove 110 is larger than the groove width of the second circumferential main groove 120.

Accordingly, in FIG. 1, the total groove area S_{SI} on the vehicle mounting inner side of the circumferential main groove with respect to the tire equatorial plane CL is larger than the total groove area S_{SO} on the vehicle mounting outer side of the circumferential main groove with respect to the tire equatorial plane.

Further, in FIG. 2, the first circumferential main groove 210 and the third circumferential main groove 230 are disposed with the tire equatorial plane CL interposed therebetween. Furthermore, the second circumferential main groove 220 is disposed so as to be overlapped with the equatorial plane CL. Here, the total groove area S_{SI} on the vehicle mounting inner side of the circumferential main groove with respect to the tire equatorial plane CL is the sum of the groove area of the first circumferential main groove 210 and the groove area of a portion on the vehicle mounting inner side from the tire equatorial plane CL of the second circumferential main groove 220. Also, the total groove area S_{SO} on the vehicle mounting outer side of the circumferential main groove with respect to the tire equatorial plane CL is the sum of the groove area of the third circumferential main groove 230 and the groove area of a portion on the vehicle mounting outer side from the tire equatorial plane CL of the second circumferential main groove 220. Here, the groove width of the first circumferential main groove 210 is larger than the groove width of the third circumferential main groove 230. Additionally, the second circumferential main groove 220 is disposed such that the groove area of a portion on the vehicle mounting inner side from the tire equatorial plane CL is equal to the groove area of a portion on the vehicle mounting outer side from the tire equatorial plane CL.

Accordingly, in FIG. 2, the total groove area S_{SI} on the vehicle mounting inner side of the circumferential main groove with respect to the tire equatorial plane CL is larger than the total groove area S_{SO} on the vehicle mounting outer side of the circumferential main groove with respect to the tire equatorial plane CL.

By preferentially enhancing drainage properties on the vehicle mounting inner side and preferentially enhancing rigidity on the vehicle mounting outer side as described above, dry steering stability and wet steering stability are efficiently improved.

In the pneumatic tire according to Additional Embodiment 1-3 of the present disclosure, the total groove area S_{SI} on the vehicle mounting inner side of the circumferential main groove with respect to the tire equatorial plane CL is increased to efficiently enhance drainage properties, and meanwhile, the total groove area S_{SO} on the vehicle mounting outer side of the circumferential main groove with respect to the tire equatorial plane is decreased to efficiently enhance rigidity of the land portion.

As a result, the pneumatic tire according to Additional Embodiment 1-3 of the present disclosure can provide more improved wet steering stability and dry steering stability.

Note that a ratio S_{SI}/S_{SO} of the total groove area S_{SI} on the vehicle mounting inner side of the circumferential main groove with respect to the tire equatorial plane CL to the total groove area S_{SO} on the vehicle mounting outer side of the circumferential main groove with respect to the tire equatorial plane is larger than 1.1 and smaller than 1.5. S_{SI}/S_{SO} may be more than 1.1, 1.2 or more, 1.3 or more, or 1.4 or more, and may be less than 1.5, 1.4 or less, 1.3 or less, or 1.2 or less.

### Additional Embodiment 1-4

As illustrated in FIGS. 1 and 2, in the pneumatic tire according to Additional Embodiment 1-4 of the present disclosure, an average groove width of the circumferential main groove on the vehicle mounting inner side is larger than an average groove width of the circumferential main groove on the vehicle mounting outer side in relation to any one pair of two of the circumferential main grooves adjacent to each other in any one of Basic Embodiment 1 and

### Additional Embodiments 1-1 to 1-3

More specifically, in FIG. 1, the groove width of the first circumferential main groove 110 is larger than the groove width of the second circumferential main groove 120. Additionally, in FIG. 2, the sizes of the groove widths of the first to third circumferential main grooves 210, 220, 230 are largest in the order of the first circumferential main groove 210, the second circumferential main groove 220, and the third circumferential main groove 230.

By preferentially enhancing drainage properties on the vehicle mounting inner side and preferentially enhancing rigidity on the vehicle mounting outer side as described above, dry steering stability and wet steering stability are efficiently improved.

In relation to the two adjacent circumferential main grooves, in the pneumatic tire according to Additional Embodiment 1-4 of the present disclosure, the average groove width of the circumferential main grooves on the vehicle mounting inner side is increased to efficiently improve drainage properties, and meanwhile, the average groove width of the circumferential main grooves on the vehicle mounting direction outer side is decreased to efficiently improve rigidity of the land portion defined and formed around the circumferential main groove.

As a result, the pneumatic tire according to Additional Embodiment 1-4 of the present disclosure can provide more improved wet steering stability and dry steering stability.

### Additional Embodiment 1-5

In relation to any one of Basic Embodiment 1 and Additional Embodiments 1-1 to 1-4, in the pneumatic tire according to Additional Embodiment 1-5 of the present disclosure, an average groove width of the circumferential main groove on the vehicle mounting inner side is larger than an average groove width of the circumferential main groove on the vehicle mounting outer side in all combinations of two of the circumferential main grooves adjacent to each other.

In other words, the pneumatic tire according to Additional Embodiment 1-5 of the present disclosure is configured such that the average groove width of the plurality of circumferential main grooves decreases from the vehicle mounting inner side toward the vehicle mounting outer side.

By preferentially enhancing drainage properties on the vehicle mounting inner side and preferentially enhancing rigidity on the vehicle mounting outer side as described above, dry steering stability and wet steering stability are efficiently improved.

In the pneumatic tire according to Additional Embodiment 1-5 of the present disclosure, the average groove width of the circumferential main grooves disposed on the vehicle mounting inner side is increased to efficiently improve drainage properties, and meanwhile, the average groove width of the circumferential main grooves disposed on the vehicle mounting outer side is decreased to efficiently improve rigidity of the land portion defined and formed around the circumferential main groove.

As a result, the pneumatic tire according to Additional Embodiment 1-5 of the present disclosure can provide more improved wet steering stability and dry steering stability.

### Additional Embodiment 1-6

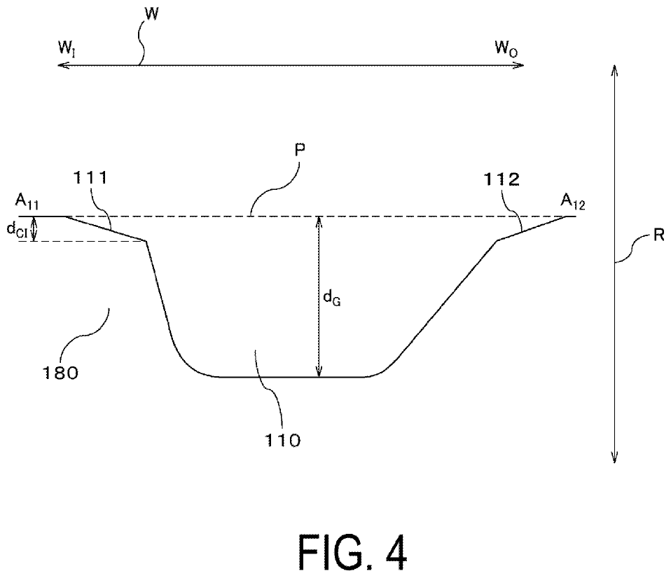

FIG. 4 is a cross-sectional view taken along the line A i-Au of the first circumferential main groove 110 in FIG. 1. In FIG. 4, “W” indicates the tire width direction and “R” indicates the tire radial direction. Additionally, in the tire width direction, “W_{I}” indicates the vehicle mounting inner side and “W_{O}” indicates the vehicle mounting outer side.

As illustrated in FIG. 4, in relation to any one of Basic Embodiment 1 and Additional Embodiments 1-1 to 1-5, the pneumatic tire according to Additional Embodiment 1-6 of the present disclosure satisfies the following relationship (3), where in a tire meridian cross-sectional view, d_{G} is a maximum value of a length in the tire radial direction R from a tire surface profile P, when the first circumferential main groove 110 is not present (a line segment indicated by the dotted line in FIG. 4, where a line smoothly connects line segments extended from surface profiles of the land portions on both sides of the first circumferential main groove 110), to a groove bottom of the first circumferential main groove 110, and d_{CI} is a maximum value of a length in the tire radial direction R from the tire surface profile P to an innermost position in the tire radial direction of the vehicle mounting inner side chamfered portion 111.

0.05<d_{CI}/d_{G}<0.40 (3)

In the pneumatic tire according to Additional Embodiment 1-6 of the present disclosure, d_{CI}/d_{G} is smaller than 0.30. Accordingly, the land portion located on the vehicle mounting inner side of the circumferential main groove can further secure the volume, and thus, the land portion can realize more excellent rigidity. On the other hand, d_{CI}/d_{G} is greater than 0.05. Accordingly, the chamfered portion is not set too small, and drainage properties are reliably improved.

As a result, the pneumatic tire according to Additional Embodiment 1-6 of the present disclosure can provide more improved wet steering stability and dry steering stability.

Note that d_{CI}/d_{G} may be more than 0.05, 0.08 or more, 0.10 or more, or more, 0.20 or more, 0.25 or more, 0.28 or more, or 0.30 or more, and may be less than 0.40, 0.35 or less, 0.30 or less, 0.27 or less, 0.26 or less, 0.25 or less, 0.23 or less, 0.20 or less, or 0.18 or less. d_{CI}/d_{G} is particularly preferably greater than 0.05 and less than 0.25.

Although not illustrated in the drawings, in an example of the pneumatic tire according to Basic Embodiment of the present disclosure illustrated in FIG. 1, the second circumferential main groove also satisfies the above relationship (3).

### Additional Embodiment 1-7

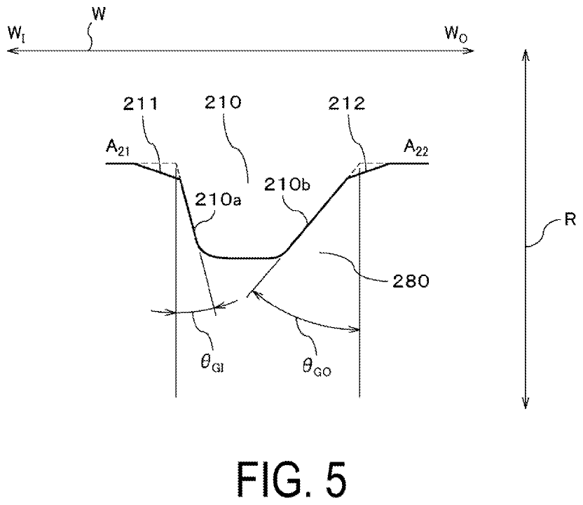

FIG. 5 is a cross-sectional view taken along the line A₂₁-A₂₂ of the first circumferential main groove 210 in FIG. 2.

As illustrated in FIG. 5, in relation to any one of Basic Embodiment 1 and Additional Embodiments 1-1 to 1-6, the pneumatic tire according to Additional Embodiment 1-7 of the present disclosure satisfies the following relationship (4) with respect to at least the circumferential main groove (in FIG. 5, the first circumferential main groove 210) disposed on the vehicle mounting innermost side, of the plurality of circumferential main grooves, in a tire meridian cross-sectional view, where θ_{GI} is an inclination angle with respect to the tire radial direction R of a vehicle mounting inner side groove wall 210a of the first circumferential main groove 210 and θ_{GO} is an inclination angle with respect to the tire radial direction of a vehicle mounting outer side groove wall 210b of the first circumferential main groove 210.

θ_{GI}<θ_{GO} (4)

In the pneumatic tire according to Additional Embodiment 1-7 of the present disclosure, the inclination angle θ_{GI} with respect to the tire radial direction of the vehicle mounting inner side groove wall 210a of the first circumferential main groove 210 is smaller than the inclination angle θ GO with respect to the tire radial direction of the vehicle mounting outer side groove wall 210b of the first circumferential main groove 210.

Here, when profile lines from land portion surfaces located on both sides of the first circumferential main groove 210 to the groove bottom are compared on both vehicle mounting sides of the groove 210, an angle variation when transitioning from the surface profile of the chamfered portion 211 to the groove profile is relatively small on the vehicle mounting inner side W_{I}, and an angle variation when transitioning from the surface profile of the chamfered portion 212 to the groove profile is relatively large on the vehicle mounting outer side W_{O}. In other words, assuming that stresses almost equal and in opposite directions in the tire width direction are applied to the land portions located on both sides of the groove 210, due to the shapes of both land portions, it is clear that the land portion located on the vehicle mounting outer side with respect to the groove 210 is less likely to be worn and has higher rigidity. In other words, this configuration agrees with the aforementioned view that it is preferable to preferentially increase the rigidity on the vehicle mounting outer side.

Additionally, when the groove center line of the first circumferential main groove 210 is set as a reference, the groove volume on the vehicle mounting inner side is larger than the groove volume on the vehicle mounting outer side. This configuration also agrees with the aforementioned view that it is preferable to preferentially increase drainage properties on the vehicle mounting inner side.

As a result, the pneumatic tire according to Additional Embodiment 1-7 of the present disclosure can provide more improved wet steering stability and dry steering stability.

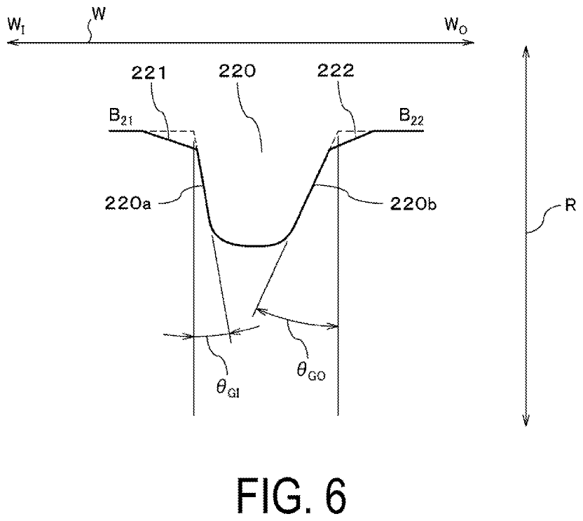

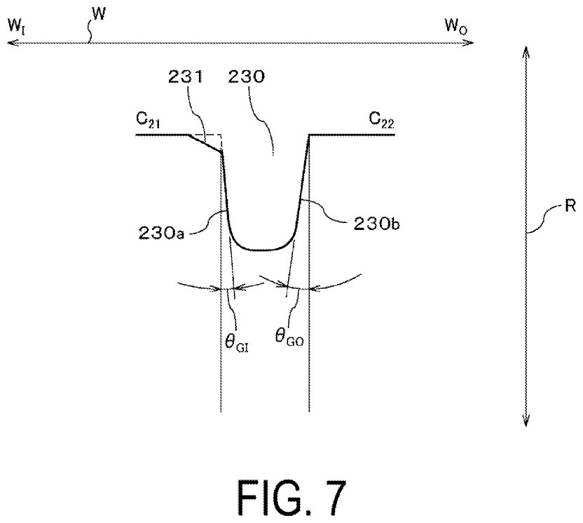

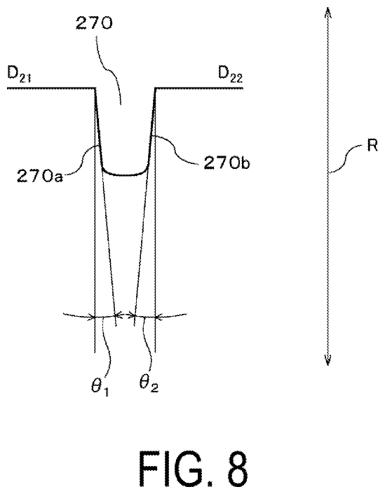

FIG. 6 is a cross-sectional view taken along the line B₂₁-B₂₂ of the second circumferential main groove 220 in FIG. 2. Further, FIG. 7 is a cross-sectional view taken along the line C₂₁-C₂₂ of the third circumferential main groove 230 in FIG. 2. Furthermore, FIG. 8 is a cross-sectional view taken along the line D₂₁-D₂₂ of a fourth inclined groove 270 in FIG. 2.

As illustrated in FIGS. 6 and 7, in another example of the pneumatic tire according to Additional Embodiment 1-7 of the present disclosure, the second circumferential main groove 220 and the third circumferential main groove 230 may also satisfy θ_{GI}<θ_{GO}. On the other hand, as illustrated in FIG. 8, with respect to the fourth inclined groove 270, inclination angles θ₁ and θ₂ of groove walls may be equal.

Note that as illustrated in FIGS. 5 to 7, each of θ_{GI} and θ_{GO} is preferably largest in the order of the first circumferential main groove 210, the second circumferential main groove 220, and the third circumferential main groove 230. This is because drainage properties are particularly required to be improved more on the vehicle mounting inner side than on the vehicle mounting outer side of the tire.

A ratio θ_{GO}/θ_{GI} of the inclination angle θ_{GO} with respect to the tire radial direction of the vehicle mounting outer side groove wall of the circumferential main groove to the inclination angle θ_{GI} with respect to the tire radial direction of the vehicle mounting inner side groove wall of the circumferential main groove is preferably greater than 2.0 and smaller than 5.0.

θ_{GO}/θ_{GI} may be more than 2.0, 2.5 or more, 3.0 or more, or 3.5 or more, and may be less than 5.0, 4.5 or less, 4.0 or less, or 3.5 or less.

θ_{GI} may be more than 0° and 30° or less. θ_{GI} may be more than 0°, 1° or more, 5° or more, 10° or more, or 15° or more, and may be 30° or less, 25° or less, 20° or less, 15° or less, or 10° or less.

### Additional Embodiment 1-8

As illustrated in FIGS. 1 and 2, in relation to any one of Basic Embodiment 1 and Additional Embodiments 1-1 to 1-7, the pneumatic tire according to Additional Embodiment 1-8 of the present disclosure includes first inclined grooves 130 (reference numeral 230 in FIG. 2), second inclined grooves 140 (reference numeral 240 in FIG. 2), third inclined grooves 150 (reference numeral 250 in FIG. 2), fourth inclined grooves 160 (reference numeral 260 in FIG. 2), and fifth inclined grooves 170 (reference numeral 270 in FIG. 2).

Referring to FIG. 1, being representative, the first inclined grooves 130 extend toward their respective vehicle mounting sides from the first circumferential main groove 110, as a starting point, that is the circumferential main groove disposed on the vehicle mounting innermost side, of the plurality of circumferential main grooves. A terminating end portion in the vehicle mounting outer side direction W_{O} of the first inclined groove 130 terminates in the land portion adjacent on the vehicle mounting outer side to the first circumferential main groove 110, and a terminating end portion in the vehicle mounting inner side direction W_{I} of the first inclined groove 130 terminates in the land portion adjacent on the vehicle mounting inner side to the first circumferential main groove 110.

The second inclined groove 140 extends toward the vehicle mounting outer side from the second circumferential main groove 120, as a starting point, disposed on the vehicle mounting outermost side, of the plurality of circumferential main grooves. A terminating end portion in the vehicle mounting outer side direction W_{O} of the second inclined groove 140 terminates in the land portion adjacent on the vehicle mounting outer side to the second circumferential main groove 120, and a terminating end portion in the vehicle mounting inner side direction W_{I} of the second inclined groove 140 terminates in communication with the second circumferential main groove 120.

The third inclined groove 150 is disposed such that both ends thereof terminate in the land portion adjacent on the vehicle mounting inner side to the first circumferential main groove 110.

The fourth inclined groove 160 is disposed such that both ends thereof terminate in the land portion adjacent on the vehicle mounting outer side to the second circumferential main groove 120.

As described above, the pneumatic tire according to Additional Embodiment 1-8 of the present disclosure includes two inclined grooves on each of the vehicle mounting inner side and the vehicle mounting outer side and thus has high drainage properties. In particular, since each of the first inclined groove and the second inclined groove is connected to the circumferential main groove, the water flowing into the circumferential main groove is easily discharged to the vehicle mounting inner side and the vehicle mounting outer side. The water discharged to the vehicle mounting inner side and the vehicle mounting outer side by the first inclined groove and the second inclined groove further flows respectively into the third inclined groove and the fourth inclined groove, and is likely to be discharged to the tire outer side along these inclined grooves. As a result, the pneumatic tire according to Additional Embodiment 1-8 of the present disclosure has higher drainage properties.

### Additional Embodiment 1-9

As illustrated in FIG. 1, in relation to Additional Embodiment 1-8, the pneumatic tire according to Additional Embodiment 1-9 of the present disclosure includes the fifth inclined grooves 170 each disposed such that both ends thereof terminate in the land portion adjacent on the vehicle mounting outer side to the second circumferential main groove 120 disposed on the vehicle mounting outermost side, of the plurality of circumferential main grooves (two grooves in FIG. 1), and the fifth inclined groove 170 is shorter in groove length than the fourth inclined groove 160.

As described above, the pneumatic tire according to Additional Embodiment 1-9 of the present disclosure includes the aforementioned fifth inclined grooves 170, and thus drainage properties are further improved as compared with Additional Embodiment 8. In addition, since the groove length of the fifth inclined groove 170 is shorter than that of the fourth inclined groove 160, a decrease in block rigidity of the land portion due to the arrangement of the fifth inclined groove 170 is small.

As a result, the pneumatic tire according to Additional Embodiment 1-9 of the present disclosure has higher drainage properties than Additional Embodiment 1-8 while suppressing a decrease in block rigidity.

### Additional Embodiment 1-10

As illustrated in FIG. 1, in relation to Additional Embodiment 1-9, in the pneumatic tire according to Additional Embodiment 1-10 of the present disclosure, with respect to the tire width direction W, the third inclined groove 150 and the fourth inclined groove 160 extend across ground contact edges E_{I} and E_{O}, respectively, and the fifth inclined groove 170 terminates at the tire equatorial plane CL side with respect to the ground contact edge E_{O}.

In the pneumatic tire according to Additional Embodiment 1-10 of the present disclosure, the third inclined groove 150 and the fourth inclined groove 160 extend across the ground contact edges E_{I} and E_{O}, respectively, and thus water is discharged more easily from the inner side toward the outer side of the tire. Thus, the pneumatic has higher drainage properties than the pneumatic tire according to Additional Embodiment 1-9 of the present disclosure. In addition, since the fifth inclined groove 170 terminates at the tire equatorial plane CL side with respect to the ground contact edge E_{O}, a decrease in block rigidity of the land portion due to the arrangement of the fifth inclined groove 170 can be further suppressed.

As a result, the pneumatic tire according to Additional Embodiment 1-10 of the present disclosure has higher drainage properties than Additional Embodiment 1-9 while suppressing a decrease in block rigidity.

### Additional Embodiment 1-11

As illustrated in FIG. 1, in relation to Additional Embodiment 1-9 or 1-in the pneumatic tire according to Additional Embodiment 1-11 of the present disclosure, the orientation of an acute angle formed by each of the second inclined groove 140, the third inclined groove 150, and the fourth inclined groove 160 with respect to the tire width direction W is equal to the orientation of an acute angle formed by the first inclined groove 130 with respect to the tire width direction W. Additionally, the orientation of an acute angle formed by the fifth inclined groove 170 with respect to the tire width direction W is different from the orientation of the acute angle formed by the first inclined groove 130 with respect to the tire width direction W.

In the pneumatic tire according to Additional Embodiment 1-11 of the present disclosure, the orientation of the acute angle formed by the fifth inclined groove 170 with respect to the tire width direction W is different from the orientation of the acute angle formed by each of the first inclined groove 130, the second inclined groove 140, the third inclined groove 150, and the fourth inclined groove 160 with respect to the tire width direction W. Thus, in one rotation direction of the pneumatic tire, drainage properties can be enhanced particularly by the first inclined groove 130, the second inclined groove 140, the third inclined groove 150, and the fourth inclined groove 160, and in the meantime, in the other rotation direction of the pneumatic tire, drainage properties can be slightly enhanced by the fifth inclined groove having a small length.

In general, when a vehicle travels forward, the traveling speed of the vehicle is high, and thus particularly high drainage properties are required for a pneumatic tire. On the other hand, when the vehicle travels backward, the traveling speed of the vehicle is usually not high, and thus drainage properties required for the pneumatic tire are low compared with when the vehicle travels forward.

Although depending on the mounting orientation of the tire to the advancement direction of the vehicle, the pneumatic tire according to Additional Embodiment 1-11 of the present disclosure can provide improved drainage properties by the first inclined groove 130, the second inclined groove 140, the third inclined groove 150, and the fourth inclined groove 160, for example, when the vehicle travels forward, and in the meantime, can provide improved drainage properties by the fifth inclined groove 170 when the rotation direction of the tire is reversed, that is, for example, when the vehicle travels backward. Additionally, since the groove length of the fifth inclined groove 170 is shorter than that of the fourth inclined groove 160, drainage properties are low compared with the fourth inclined groove 160; however, a decrease in block rigidity of the land portion due to the arrangement of the fifth inclined groove 170 is small. As a result, drainage properties and block rigidity when the vehicle moves forward and backward can be provided in a compatible manner.

### Additional Embodiment 1-12

As illustrated in FIG. 2, in relation to any one of Additional Embodiments 1-8 to 1-10, in the pneumatic tire according to Additional Embodiment 1-12 of the present disclosure, the orientation of an acute angle formed by each of the second inclined groove 250 and the fourth inclined groove 270 with respect to the tire width direction W is equal to the orientation of an acute angle formed by the first inclined groove 240 with respect to the tire width direction W, and the orientation of an acute angle formed by the third inclined groove 260 with respect to the tire width direction W is different from the orientation of the acute angle formed by the first inclined groove 240 with respect to the tire width direction W.

Although depending on the mounting orientation of the tire with respect to the advancement direction of the vehicle, the pneumatic tire according to Additional Embodiment 1-12 of the present disclosure can provide improved drainage properties by the first inclined groove 240, the second inclined groove 250, and the fourth inclined groove 270, for example, when the vehicle travels forward, and in the meantime, can provided improved drainage properties by the third inclined groove 260 when the rotation direction of the tire is reversed, that is, for example, when the vehicle travels backward. Since the third inclined groove 260 is disposed on the vehicle mounting inner side, drainage properties on the vehicle mounting inner side, in particular, when the vehicle travels backward, can be particularly improved.

In a state where the tire is mounted on the vehicle, when the tire equatorial direction is inclined toward the vehicle inner side from the direction perpendicular to the ground surface, the tire ground contact area is slightly larger on the vehicle mounting inner side than on the vehicle direction outer side. As a result, in such a case, by applying the pneumatic tire according to Additional Embodiment 1-12 of the present disclosure, wet steering stability, for example, at the time of traveling backward, can be particularly improved.

### Additional Embodiment 1-13

As illustrated in FIG. 1, in relation to any one of Additional Embodiments 1-8 to 1-12, in the pneumatic tire according to Additional Embodiment 1-13 of the present disclosure, with respect to the tire circumferential direction, a terminating end portion on the vehicle mounting outer side of the third inclined groove 150 terminates between end portions on the vehicle mounting inner side of two of the first inclined grooves 130 adjacent to each other, and/or a terminating end portion on the vehicle mounting inner side of the fourth inclined groove 160 terminates between end portions on the vehicle mounting outer side of two of the second inclined grooves 140 adjacent to each other.

In the pneumatic tire according to Additional Embodiment 1-13 of the present disclosure, with the configuration as described above, the water flowing from the first circumferential main groove 110 and the second circumferential main groove 120 into the first inclined groove 130 and the second inclined groove 140, respectively, is efficiently collected by the third inclined groove 150 and the fourth inclined groove 160, respectively, and is easily discharged to the tire outer side. From such a viewpoint, with respect to the tire width direction W, the terminating end portion on the vehicle mounting outer side of the third inclined groove 150 further preferably terminates between the terminating end portions on the vehicle mounting inner side of the two first inclined grooves 130 adjacent to each other. Similarly, with respect to the tire width direction W, the terminating end portion on the vehicle mounting inner side of the fourth inclined groove 160 further preferably terminates between the terminating end portions on the vehicle mounting outer side of the two second inclined grooves 140 adjacent to each other.

### Additional Embodiment 1-14

As illustrated in FIG. 1, in relation to any one of Additional Embodiments 1-8 to 1-13, in the pneumatic tire according to Additional Embodiment 1-14 of the present disclosure, the first inclined grooves 130 extend toward their respective vehicle mounting sides to communicate with a portion projected toward the vehicle mounting inner side and a portion recessed toward the vehicle mounting outer side of the first circumferential main groove 110 disposed on the vehicle mounting innermost side, of the plurality of circumferential main grooves.

In the pneumatic tire according to Additional Embodiment 1-14 of the present disclosure, the first inclined groove 130 extends from a portion projected toward the vehicle mounting inner side of first circumferential main groove 110. Thus, the groove length of a portion on the vehicle mounting inner side of the first inclined groove 130 with respect to the first circumferential main groove 110 can be decreased compared with a case where the first inclined groove extends from a portion recessed toward the vehicle mounting inner side of the first circumferential main groove. As a result, a decrease in block rigidity of the land portion in a portion on the vehicle mounting inner side with respect to the first circumferential main groove 110 can be suppressed while improving drainage properties by the first inclined groove 130 in a portion on the vehicle mounting inner side with respect to the first circumferential main groove 110. On the other hand, the first inclined groove 130 extends from a portion recessed toward the vehicle mounting outer side of the first circumferential main groove 110. Thus, a portion being a terminating end portion on the vehicle mounting outer side of the first inclined groove 130 with respect to the first circumferential main groove 110 can be located farther away from the tire equatorial plane CL while the length of the inclined groove is increased as compared with a case where the first inclined groove extends from a portion recessed toward the vehicle mounting outer side of the first circumferential main groove. As a result, drainage properties can be improved while suppressing a decrease in block rigidity of the land portion near the tire equatorial plane CL. Note that a portion projected toward the vehicle mounting inner side does not need to be the apex of a projection, but is particularly preferably the apex of a projection. Similarly, a portion recessed toward the vehicle mounting inner side does not need to be the bottom point of a recess, but is particularly preferably the bottom point of a recess.

### Additional Embodiment 1-15

As illustrated in FIG. 1, in relation to any one of Additional Embodiments 1-8 to 1-14, in the pneumatic tire according to Additional Embodiment 1-15 of the present disclosure, a terminating end portion on the vehicle mounting inner side of the second inclined groove 140 is in communication with a portion projected toward the vehicle mounting outer side of the second circumferential main groove 120 disposed on the vehicle mounting outermost side, of the plurality of circumferential main grooves.

In the pneumatic tire according to Additional Embodiment 1-15 of the present disclosure, with the aforementioned configuration, the groove length of a portion on the vehicle mounting outer side of the second inclined groove 140 with respect to the second circumferential main groove 120 can be decreased compared with a case where the second inclined groove extends from a portion recessed toward the vehicle mounting inner side of the second circumferential main groove. Additionally, since the second inclined groove 140 extends from a portion projected toward the vehicle mounting outer side of the second circumferential main groove 120, the water flowing through the second circumferential main groove 120 easily flows into the second inclined groove 140. As a result, a decrease in block rigidity of the land portion in a portion on the vehicle mounting outer side with respect to the second circumferential main groove 120 can be suppressed while improving drainage properties by the second inclined groove 140 in a portion on the vehicle mounting outer side with respect to the second circumferential main groove 120. Note that a portion projected toward the vehicle mounting outer side does not need to be the apex of a projection, but is particularly preferably the apex of a projection.

### Additional Embodiment 1-16

As illustrated in FIG. 1, in relation to any one of Additional Embodiments 1-8 to 1-15, the pneumatic tire according to Additional Embodiment 1-16 of the present disclosure satisfies the following relationship (5), where L_{IG1} is a length in the tire width direction W of a portion of the first inclined groove 130, which extends toward the vehicle mounting outer side from the first circumferential main groove 110 disposed on the vehicle mounting innermost side, of the plurality of circumferential main grooves, and L_{L} is a length in the tire width direction W of the land portion adjacent on the vehicle mounting outer side to the first circumferential main groove 110 disposed on the vehicle mounting innermost side, of the plurality of circumferential main grooves:

0.20<L_{IG1}/L_{L}<0.60 (5).

When L_{IG1}/L_{L} is larger than 0.20, drainage properties of the land portion adjacent on the vehicle mounting outer side to the first circumferential main groove 110, that is, the land portion near the tire equatorial plane CL, can be particularly improved. On the other hand, when L_{IG1}/L_{L} is smaller than 0.60, a decrease in block rigidity of the land portion near the tire equatorial plane CL can be particularly suppressed. In other words, the pneumatic tire according to the Additional Embodiment 1-16 of the present disclosure can particularly provide drainage properties and block rigidity near the tire equatorial plane CL in a compatible manner by satisfying the above relationship (5).

Here, L_{IG1}/L_{L} may be more than 0.20, 0.25 or more, or 0.30 or more, and may be less than 0.60, 0.55 or less, 0.50 or less, 0.45 or less, 0.40 or less, 0.35 or less, or 0.30 or less.

### Additional Embodiment 1-17

As illustrated in FIG. 1, in relation to any one of Additional Embodiments 1-8 to 1-16, in the pneumatic tire according to Additional Embodiment 1-17 of the present disclosure, the terminating end portion in the vehicle mounting outer side direction W_{O} of the second inclined groove 140 terminates between two of the fourth inclined grooves 160 adjacent to each other in the tire circumferential direction. Here, it is preferable that the following relationship (6) be satisfied, where L_{G4G4} is a length in the tire circumferential direction from one to the other of the two fourth inclined grooves 160 adjacent to each other and L_{G2G4} is a length in the tire circumferential direction from one of the two fourth inclined grooves 160 adjacent to each other to the terminating end portion of the second inclined groove 140:

0.40<L_{G2G4}/L_{G4G4}<0.60 (6).

When the above relationship (6) is satisfied, the terminating end portion in the vehicle mounting outer side direction W_{O} of the second inclined groove 140 terminates near the center between the two fourth inclined grooves 160 adjacent to each other in the tire circumferential direction. Accordingly, the delivery of water between the second inclined groove 140 and the fourth inclined groove 160 is more efficiently performed.

Here, L_{G2G4}/L_{G4G4} may be more than 0.40, 0.43 or more, or 0.45 or more, and may be less than 0.60, 0.58 or less, or 0.55 or less.

### Additional Embodiment 1-18

In relation to any one of Additional Embodiments 1-8 to 1-17, the pneumatic tire according to Additional Embodiment 1-18 of the present disclosure satisfies the following relationships (7) to (10), where in a tire meridian cross-sectional view, d_{G} is a maximum value of lengths in the tire radial direction from the tire surface profile, when the circumferential main grooves and the inclined grooves are not present, to the groove bottoms of the first and second circumferential main grooves 110 and 120 and d_{IG1}, d_{IG2}, d_{IG3}, and d_{IG4} are respectively maximum values of lengths in the tire radial direction from the tire surface profile to the groove bottoms of the first inclined groove 130, the second inclined groove 140, the third inclined groove 150, and the fourth inclined groove 160:

0.05<d_{IG1}/d_{G}<0.85 (7),

0.05<d_{IG2}/d_{G}<0.85 (8),

0.05<d_{IG3}/d_{G}<0.85 (9), and

0.05<d_{IG4}/d_{G}<0.85 (10).

In the pneumatic tire of the present disclosure according to Additional Embodiment 1-18, the maximum values (d_{IG1}, d_{IG2}, d_{IG3}, and d_{IG4}) of the lengths in the tire radial direction from the tire surface profile to the groove bottoms of the first inclined groove 130, the second inclined groove 140, the third inclined groove 150, and the fourth inclined groove 160 are smaller than the maximum value d_{G} of the lengths in the tire radial direction from the tire surface profile to the groove bottoms of the first and second circumferential main grooves 110 and 120. Thus, drainage properties can be improved while suppressing a decrease in block rigidity of the tire due to each of the inclined grooves 130, 140, 150, 160. Here, when 0.05<d_{IG1} (or d_{IG2}, d_{IG3}, d_{IG4})/d_{G}, the depths of the first inclined groove 130, the second inclined groove 140, the third inclined groove 150, and the fourth inclined groove 160 are sufficiently large, and thus drainage properties are particularly improved. On the other hand, when d_{IG1} (or d_{IG2}, d_{IG3}, d_{IG4})/d_{G}<0.85, the depths of the first inclined groove 130, the second inclined groove 140, the third inclined groove 150, and the fourth inclined groove 160 are not too large, and in particular, a decrease in block rigidity can be suppressed.

Here, d_{IG1} (or d_{IG2}, d_{IG3}, d_{IG4})/d_{G} may be more than 0.05, 0.1 or more, or more, or 0.3 or more, and may be less than 0.85, 0.80 or less, 0.70 or less, or 0.60 or less.

### Additional Embodiment 1-19

In relation to any one of Additional Embodiments 1-8 to 1-18, the pneumatic tire according to Additional Embodiment 1-19 of the present disclosure satisfies the following relationship (11), where in a tire meridian cross-sectional view, d_{G1} is a maximum value of a length in the tire radial direction from the tire surface profile, when the circumferential main grooves and the inclined grooves are not present, to the groove bottom of the first circumferential main groove 110 disposed on the vehicle mounting innermost side, of the plurality of circumferential main grooves, d_{IG1′} is a maximum value of a length in the tire radial direction from the tire surface profile to a groove bottom in a portion of the first inclined groove 130, which is located in the vehicle mounting outer side direction W_{O} from the first circumferential main groove 110, as a starting point, disposed on the vehicle mounting innermost side, of the plurality of circumferential main grooves, and d_{IG1″} is a maximum value of a length in the tire radial direction from the tire surface profile to a groove bottom in a portion of the first inclined groove 130, which is located in the vehicle mounting inner side direction W_{I} from the first circumferential main groove 110, as a starting point, disposed on the vehicle mounting innermost side, of the plurality of circumferential main grooves:

d_{IG1′}<d_{IG1″}<d_{G1} (11).

In the pneumatic tire according to Additional Embodiment 1-19 of the present disclosure, d_{IG1′}<d_{IG1″} is established, and thus the inclined groove is shallow in the land portion near the tire equatorial plane CL while improving drainage properties by the first inclined groove 130. Consequently, a decrease in block rigidity of the land portion near the tire equatorial plane CL can be particularly suppressed.

### Additional Embodiment 1-20

As illustrated in FIG. 1 (and FIG. 2), in relation to any one of Additional Embodiments 1-8 to 1-19, the pneumatic tire according to Additional Embodiment 1-20 of the present disclosure satisfies the following relationship (12), where L_{IG1} is the length in the tire width direction of a portion of the first inclined groove 130 (240 in FIG. 2), which extends toward the vehicle mounting outer side from the circumferential main groove 110 (210 in FIG. 2) disposed on the vehicle mounting innermost side, of the plurality of circumferential main grooves, and L_{IG2} is a length in the tire width direction of a portion of the first inclined groove 130 (240 in FIG. 2), which extends toward the vehicle mounting inner side from the circumferential main groove 110 (210 in FIG. 2) disposed on the vehicle mounting innermost side, of the plurality of circumferential main grooves.

L_{IG1}<L_{IG2} (12)

Referring to FIG. 1, in the pneumatic tire according to Additional Embodiment 1-20 of the present disclosure, the first inclined grooves 130 satisfy the relationship L_{IG1}<L_{IG2}, and thus drainage properties from the circumferential main groove 110 toward both sides in the tire width direction of the circumferential main groove via the first inclined grooves can be superior in the vehicle mounting outer side direction W_{O}, that is, in the direction toward the outer side in the tire width direction. As a result, when the tire is viewed as a whole, drainage properties from the circumferential main groove 110 toward the outer side in the tire width direction can be particularly improved, and on the other hand, the rigidity on the inner side in the tire width direction can be enhanced.

Here, a ratio L_{IG1}/L_{IG2} is particularly preferably 0.20 or more and 0.40 or less. L_{IG1}/L_{IG2} may be 0.20 or more, 0.25 or more, or 0.30 or more, and may be or less, 0.35 or less, or 0.30 or less.

### Basic Embodiment 2

The pneumatic tire according to Basic Embodiment 2 of the present disclosure is a pneumatic tire in which the mounting direction with respect to the vehicle is designated as illustrated in FIG. 1 (and FIG. 2) and which is provided with the plurality of circumferential main grooves 110 and 120 (210, 220, and 230 in FIG. 2), the first inclined grooves 130 (240 in FIG. 2), and the second inclined grooves 140 (250 in FIG. 2) on the tread surface of the tread portion.

Further, in a tire plan view, the groove center lines of the circumferential main grooves 110 and 120 (210, 220, and 230 in FIG. 2) are periodically displaced in the tire width direction as they extend in the tire circumferential direction. Furthermore, the first inclined grooves 130 (240 in FIG. 2) extend toward their respective vehicle mounting sides from the circumferential main groove 110 (210 in FIG. 2), as a starting point, disposed on the vehicle mounting innermost side, of the plurality of circumferential main grooves, and the second inclined grooves 140 (250 in FIG. 2) extend toward the vehicle mounting outer side from the circumferential main groove 120 (230 in FIG. 2), as a starting point, disposed on the vehicle mounting outermost side, of the plurality of circumferential main grooves.

Referring to FIG. 1, in the pneumatic tire according to Basic Embodiment 2 of the present disclosure, the first inclined grooves 130 extend toward their respective vehicle mounting sides from the circumferential main groove 110 as a starting point, and thus the inclined grooves are present in the land portions adjacent on both sides in the tire width direction to the circumferential main groove 110. As a result, high drainage properties are provided on the vehicle mounting inner side. On the other hand, the second inclined grooves 140 extend toward the vehicle mounting outer side from the circumferential main groove 120 as a starting point, and thus the inclined grooves are present in the land portion adjacent on the vehicle mounting outer side to the circumferential main groove 120. Accordingly, the rigidity of the land portion adjacent on the inner side in the tire width direction to the circumferential main groove 120 is high. As a result, the pneumatic tire according to Basic Embodiment 2 of the present disclosure has high drainage properties on the inner side in the tire width direction and high rigidity on the outer side in the tire width direction, and thus the rigidity of the tire can be improved while ensuring high drainage properties. The same applies to FIG. 2.

In the pneumatic tire according to Basic Embodiment 2 of the present disclosure, chamfering of the circumferential main groove is not an essential configuration different from the pneumatic tire according to Basic Embodiment 1 described above and Additional Embodiments thereof of the present disclosure. Obviously, wet steering stability and dry steering stability of the pneumatic tire according to Basic Embodiment 2 of the present disclosure is further improved with the presence of chamfering as in the pneumatic tire according to Basic Embodiment 1 described above and Additional Embodiments thereof of the present disclosure.

### Additional Embodiment 2-1

As illustrated in FIG. 1 (and FIG. 2), in relation to Basic Embodiment 2, in the pneumatic tire according to Additional Embodiment 2-1 of the present disclosure, the terminating end portion in the vehicle mounting outer side direction W_{O} of the first inclined groove 130 (240 in FIG. 2) terminates in the land portion adjacent on the vehicle mounting outer side to the circumferential main groove 110 (210 in FIG. 2) disposed on the vehicle mounting innermost side, of the plurality of circumferential main grooves, and the terminating end portion in the vehicle mounting inner side direction W_{I} of the first inclined groove 130 (240 in FIG. 2) terminates in the land portion adjacent on the vehicle mounting inner side to the circumferential main groove 110 (210 in FIG. 2) disposed on the vehicle mounting innermost side, of the plurality of circumferential main grooves.

Referring to FIG. 1, in the pneumatic tire according to Additional Embodiment 2-1 of the present disclosure, the first inclined grooves 130 terminate in the land portions adjacent on both sides in the tire direction to the circumferential main groove 110, and thus the rigidity of the land portions can be improved while maintaining drainage properties. The same applies to FIG. 2.

### Additional Embodiment 2-2

As illustrated in FIG. 1 (and FIG. 2), in relation to Basic Embodiment 2 and Additional Embodiment 2-1, in the pneumatic tire according to Additional Embodiment 2-2 of the present disclosure, the terminating end portion in the vehicle mounting outer side direction of the second inclined groove 140 (250 in FIG. 2) terminates in the land portion adjacent on the vehicle mounting outer side to the circumferential main groove 120 (230 in FIG. 2) disposed on the vehicle mounting outermost side, of the plurality of circumferential main grooves, and the terminating end portion in the vehicle mounting inner side direction of the second inclined groove 140 (250 in FIG. 2) terminates in communication with the circumferential main groove 120 (230 in FIG. 2) disposed on the vehicle mounting outermost side, of the plurality of circumferential main grooves. Note that “terminates in communication with” means that the end portion of the second inclined groove 140 (250 in FIG. 2) joins the circumferential main groove 120 (230 in FIG. 2) and terminates, and does not extend to the land portion on the opposite side of the circumferential main groove 120 (230 in FIG. 2).

Referring to FIG. 1, in the pneumatic tire according to Additional Embodiment 2-2 of the present disclosure, the second inclined groove 140 terminates at one end portion in the land portion adjacent on the vehicle mounting outer side to the circumferential main groove 120 and terminates at the other end portion in communication with the circumferential main groove 120, and thus the rigidity of the land portion can be improved while maintaining drainage properties. The same applies to FIG. 2.

### Additional Embodiment 2-3

As illustrated in FIG. 1 (and FIG. 2), in relation to any one of Basic Embodiment 2 and Additional Embodiments 2-1 and 2-2, the pneumatic tire according to Additional Embodiment 2-3 of the present disclosure satisfies the following relationship (13), where L_{IG1} is the length in the tire width direction of a portion of the first inclined groove 130 (240 in FIG. 2), which extends toward the vehicle mounting outer side from the circumferential main groove 110 (210 in FIG. 2) disposed on the vehicle mounting innermost side, of the plurality of circumferential main grooves, and L_{IG2} is the length in the tire width direction of a portion of the first inclined groove 130 (240 in FIG. 2), which extends toward the vehicle mounting inner side from the circumferential main groove 110 (210 in FIG. 2) disposed on the vehicle mounting innermost side, of the plurality of circumferential main grooves.

L_{IG1}<L_{IG2} (13)

Referring to FIG. 1, in the pneumatic tire according to Additional Embodiment 2-3 of the present disclosure, the first inclined grooves 130 satisfy the relationship L_{IG1}<L_{IG2}, and thus drainage properties from the circumferential main groove 110 toward both sides in the tire width direction of the circumferential main groove via the first inclined grooves can be superior in the vehicle mounting outer side direction W_{O}, that is, in the direction toward the outer side in the tire width direction. As a result, when the tire is viewed as a whole, drainage properties from the circumferential main groove 110 toward the outer side in the tire width direction can be particularly improved, and on the other hand, the rigidity on the inner side in the tire width direction can be enhanced.

Here, the ratio L_{IG1}/L_{Ig2} is particularly preferably 0.20 or more and 0.40 or less. L_{IG1}/L_{IG2} may be 0.20 or more, 0.25 or more, or 0.30 or more, and may be 0.40 or less, 0.35 or less, or 0.30 or less.

### Additional Embodiment 2-4

As illustrated in FIG. 1 (and FIG. 2), in relation to any one of Basic Embodiment 2 and Additional Embodiments 2-1 to 2-3, in the pneumatic tire according to Additional Embodiment 2-4 of the present disclosure, the first inclined grooves 130 (240 in FIG. 2) extend toward their respective vehicle mounting sides to communicate with a portion projected toward the vehicle mounting inner side and a portion recessed toward the vehicle mounting outer side of the first circumferential main groove 110 (210 in FIG. 2) disposed on the vehicle mounting innermost side, of the plurality of circumferential main grooves.

Referring to FIG. 1, in the pneumatic tire according to Additional Embodiment 2-4 of the present disclosure, the first inclined groove 130 extends from a portion projected toward the vehicle mounting inner side of the first circumferential main groove 110. Thus, the groove length of a portion on the vehicle mounting inner side of the first inclined groove 130 with respect to the first circumferential main groove 110 can be decreased compared with a case where the first inclined groove extends from a portion recessed toward the vehicle mounting inner side of the first circumferential main groove. As a result, a decrease in block rigidity of the land portion in a portion on the vehicle mounting inner side with respect to the first circumferential main groove 120 can be suppressed while improving drainage properties by the first inclined groove 130 in a portion on the vehicle mounting inner side with respect to the first circumferential main groove 120. On the other hand, the first inclined groove 130 extends from a portion recessed toward the vehicle mounting outer side of the first circumferential main groove 120. Thus, a portion being a terminating end portion on the vehicle mounting outer side of the first inclined groove 120 with respect to the first circumferential main groove 110 can be located farther away from the tire equatorial plane CL while the length of the inclined groove is increased as compared with a case where the first inclined groove extends from a portion recessed toward the vehicle mounting outer side of the first circumferential main groove. As a result, drainage properties can be improved while suppressing a decrease in block rigidity of the land portion near the tire equatorial plane CL. The same applies to FIG. 2. Note that a portion projected toward the vehicle mounting inner side does not need to be the apex of a projection, but is particularly preferably the apex of a projection. Similarly, a portion recessed toward the vehicle mounting inner side does not need to be the bottom point of a recess, but is particularly preferably the bottom point of a recess.

### Additional Embodiment 2-5

As illustrated in FIG. 1 (and FIG. 2), in relation to any one of Basic Embodiment 2 and Additional Embodiments 2-1 to 2-4, the pneumatic tire according to Additional Embodiment 2-5 of the present disclosure satisfies the following relationship (14), where L_{IG1} is the length in the tire width direction W of a portion of the first inclined groove 130 (240 in FIG. 2), which extends toward the vehicle mounting outer side from the first circumferential main groove 110 (210 in FIG. 2) disposed on the vehicle mounting innermost side, of the plurality of circumferential main grooves, and L_{L} is the length in the tire width direction W of the land portion adjacent on the vehicle mounting outer side to the first circumferential main groove 110 (210 in FIG. 2) disposed on the vehicle mounting innermost side, of the plurality of circumferential main grooves:

0.20<L_{IG1}/L_{L}<0.60 (14).

Referring to FIG. 1, when L_{IG1}/L_{L} is larger than 0.20, drainage properties of the land portion adjacent on the vehicle mounting outer side to the first circumferential main groove 110, that is, the land portion near the tire equatorial plane CL, can be particularly improved. On the other hand, when L_{IG1}/L_{L} is smaller than 0.60, a decrease in block rigidity of the land portion near the tire equatorial plane CL can be particularly suppressed. In other words, the pneumatic tire according to Additional Embodiment 2-5 of the present disclosure can particularly provide drainage properties and block rigidity near the tire equatorial plane CL in a compatible manner by satisfying the above relationship (13). The same applies to FIG. 2.

Here, L_{IG1}/L_{L} may be more than 0.20, 0.25 or more, or 0.30 or more, and may be less than 0.60, 0.55 or less, 0.50 or less, 0.45 or less, 0.40 or less, 0.35 or less, or 0.30 or less.

### Additional Embodiment 2-6

As illustrated in FIG. 1 (and FIG. 2), in relation to any one of Basic Embodiment 2 and Additional Embodiments 2-1 to 2-5, the pneumatic tire according to Additional Embodiment 2-6 of the present disclosure satisfies the following relationship (15), where in a tire meridian cross-sectional view, d_{G1} is the maximum value of the length in the tire radial direction from the tire surface profile, when the circumferential main grooves 110, 120 (210, 220, and 230 in FIG. 2) and the inclined grooves 130, 140, 150, 160, and 170 (240, 250, 260, and 270 in FIG. 2) are not present, to the groove bottom of the first circumferential main groove 110 (210 in FIG. 2) disposed on the vehicle mounting innermost side, of the plurality of circumferential main grooves, d_{IG1′} is the maximum value of the length in the tire radial direction from the tire surface profile to a groove bottom in a portion of the first inclined groove 130 (240 in FIG. 2), which is located in the vehicle mounting outer side direction W_{O} from the first circumferential main groove 110 (210 in FIG. 2), as a starting point, disposed on the vehicle mounting innermost side, of the plurality of circumferential main grooves, and d_{IG1″} is the maximum value of the length in the tire radial direction from the tire surface profile to a groove bottom in a portion of the first inclined groove 130 (240 in FIG. 2), which is located in the vehicle mounting inner side direction W_{I} from the first circumferential main groove 110 (210 in FIG. 2), as a starting point, disposed on the vehicle mounting innermost side, of the plurality of circumferential main grooves:

d_{IG1′}<d_{IG1″}<d_{G1} (15).

Referring to FIG. 1, in the pneumatic tire according to Additional Embodiment 2-6 of the present disclosure, d_{IG1′}<d_{IG1″} is established, and thus the inclined groove is shallow in the land portion near the tire equatorial plane CL while improving drainage properties by the first inclined groove 130. Consequently, a decrease in block rigidity of the land portion near the tire equatorial plane CL can be particularly suppressed. The same applies to FIG. 2.

### Additional Embodiment 2-7

As illustrated in FIG. 1 (and FIG. 2), in relation to any one of Basic Embodiment 2 and Additional Embodiments 2-1 to 2-6, in the pneumatic tire according to Additional Embodiment 2-7 of the present disclosure, the terminating end portion on the vehicle mounting inner side of the second inclined groove 140 (250 in FIG. 2) is in communication with a portion projected toward the vehicle mounting outer side of the second circumferential main groove 120 (220 in FIG. 2) disposed on the vehicle mounting outermost side, of the plurality of circumferential main grooves.

Referring to FIG. 1, in the pneumatic tire according to Additional Embodiment 2-7 of the present disclosure, with the aforementioned configuration, the groove length of a portion on the vehicle mounting outer side of the second inclined groove 140 with respect to the second circumferential main groove 120 can be decreased compared with a case where the second inclined groove extends from a portion recessed toward the vehicle mounting inner side of the second circumferential main groove. Additionally, since the second inclined groove 140 extends from a portion projected toward the vehicle mounting outer side of the second circumferential main groove 120, the water flowing through the second circumferential main groove 120 easily flows into the second inclined groove 140. As a result, a decrease in block rigidity of the land portion in a portion on the vehicle mounting outer side with respect to the second circumferential main groove 120 can be suppressed while improving drainage properties by the second inclined groove 140 in a portion on the vehicle mounting outer side with respect to the second circumferential main groove 120. The same applies to FIG. 2. Note that a portion projected toward the vehicle mounting inner side does not need to be the apex of a projection, but is particularly preferably the apex of a projection.

### Additional Embodiment 2-8

As illustrated in FIG. 1 (and FIG. 2), in relation to any one of Basic Embodiment 2 and Additional Embodiments 2-1 to 2-7, the pneumatic tire according to Additional Embodiment 2-8 of the present disclosure includes the first inclined grooves 130 (reference numeral 240 in FIG. 2), the second inclined grooves 140 (reference numeral 250 in FIG. 2), the third inclined grooves 150 (reference numeral 260 in FIG. 2), the fourth inclined grooves 160 (reference numeral 270 in FIG. 2), and the fifth inclined grooves 170 (no fifth inclined grooves in FIG. 2).

Referring to FIG. 1, the first inclined grooves 130 extend toward their respective vehicle mounting sides from the first circumferential main groove 110, as a starting point, that is the circumferential main groove disposed on the vehicle mounting innermost side, of the plurality of circumferential main grooves. The terminating end portion in the vehicle mounting outer side direction W_{O} of the first inclined groove 130 terminates in the land portion adjacent on the vehicle mounting outer side to the first circumferential main groove 110, and the terminating end portion in the vehicle mounting inner side direction W_{I} of the first inclined groove 130 terminates in the land portion adjacent on the vehicle mounting inner side to the first circumferential main groove 110.

The second inclined groove 140 extends toward the vehicle mounting outer side from the second circumferential main groove 120, as a starting point, disposed on the vehicle mounting outermost side, of the plurality of circumferential main grooves. The terminating end portion in the vehicle mounting outer side direction W_{O} of the second inclined groove 140 terminates in the land portion adjacent on the vehicle mounting outer side to the second circumferential main groove 120, and the terminating end portion in the vehicle mounting inner side direction W_{I} of the second inclined groove 140 terminates in communication with the second circumferential main groove 120.

The third inclined groove 150 is disposed such that both ends thereof terminate in the land portion adjacent on the vehicle mounting inner side to the first circumferential main groove 110.

The fourth inclined groove 160 is disposed such that both ends thereof terminate in the land portion adjacent on the vehicle mounting outer side to the second circumferential main groove 120.

As described above, the pneumatic tire according to Additional Embodiment 2-8 of the present disclosure includes two inclined grooves on each of the vehicle mounting inner side and the vehicle mounting outer side and thus has high drainage properties. In particular, since each of the first inclined groove and the second inclined groove is connected to the circumferential main groove, the water flowing into the circumferential main groove is easily discharged to the vehicle mounting inner side and the vehicle mounting outer side. The water discharged to the vehicle mounting inner side and the vehicle mounting outer side by the first inclined groove and the second inclined groove further flows respectively into the third inclined groove and the fourth inclined groove, and is likely to be discharged to the tire outer side along these inclined grooves. As a result, the pneumatic tire according to Additional Embodiment 2-8 of the present disclosure has higher drainage properties.

### Additional Embodiment 2-9

As illustrated in FIG. 1, in relation to Additional Embodiment 2-8, the pneumatic tire according to Additional Embodiment 2-9 of the present disclosure includes the fifth inclined grooves 170 each disposed such that both ends thereof terminate in the land portion adjacent on the vehicle mounting outer side to the second circumferential main groove 120 disposed on the vehicle mounting outermost side, of the plurality of circumferential main grooves (two grooves in FIG. 1), and the fifth inclined groove 170 is shorter in groove length than the fourth inclined groove 160.

As described above, the pneumatic tire according to Additional Embodiment 2-9 of the present disclosure includes the aforementioned fifth inclined groove 170, and thus drainage properties are further improved as compared with Additional Embodiment 2-8. In addition, since the groove length of the fifth inclined groove 170 is shorter than that of the fourth inclined groove 160, a decrease in block rigidity of the land portion due to the arrangement of the fifth inclined groove 170 is small.

As a result, the pneumatic tire according to Additional Embodiment 2-9 of the present disclosure has higher drainage properties than Additional Embodiment 2-8 while suppressing a decrease in block rigidity.

### Additional Embodiment 2-10

As illustrated in FIG. 1, in relation to Additional Embodiment 2-9, in the pneumatic tire according to Additional Embodiment 2-10 of the present disclosure, with respect to the tire width direction W, the third inclined groove 150 and the fourth inclined groove 160 extend across the ground contact edges E_{I} and E_{O}, respectively, and the fifth inclined groove 170 terminates at the tire equatorial plane CL side with respect to the ground contact edge E_{O}.

In the pneumatic tire according to Additional Embodiment 2-10 of the present disclosure, the third inclined groove 150 and the fourth inclined groove 160 extend across the ground contact edges E_{I} and E_{O}, respectively, and thus water is discharged more easily from the inner side toward the outer side of the tire. Thus, the pneumatic has higher drainage properties than the pneumatic tire according to Additional Embodiment 2-9 of the present disclosure. In addition, since the fifth inclined groove 170 terminates at the tire equatorial plane CL side with respect to the ground contact edge EO, a decrease in block rigidity of the land portion due to the arrangement of the fifth inclined groove 170 can be further suppressed.

As a result, the pneumatic tire according to Additional Embodiment 2-10 of the present disclosure has higher drainage properties than Additional Embodiment 2-9 while suppressing a decrease in block rigidity.

### Additional Embodiment 2-11

As illustrated in FIG. 1, in relation to Additional Embodiment 2-9 or 2-10, in the pneumatic tire according to Additional Embodiment 2-11 of the present disclosure, the orientation of an acute angle formed by each of the second inclined groove 140, the third inclined groove 150, and the fourth inclined groove 160 with respect to the tire width direction W is equal to the orientation of an acute angle formed by the first inclined groove 130 with respect to the tire width direction W. Additionally, the orientation of an acute angle formed by the fifth inclined groove 170 with respect to the tire width direction W is different from the orientation of the acute angle formed by the first inclined groove 130 with respect to the tire width direction W.

In the pneumatic tire according to Additional Embodiment 2-11 of the present disclosure, the orientation of the acute angle formed by the fifth inclined groove 170 with respect to the tire width direction W is different from the orientation of the acute angle formed by each of the first inclined groove 130, the second inclined groove 140, the third inclined groove 150, and the fourth inclined groove 160 with respect to the tire width direction W. Thus, in one rotation direction of the pneumatic tire, drainage properties can b e enhanced particularly by the first inclined groove 130, the second inclined groove 140, the third inclined groove 150, and the fourth inclined groove 160, and in the meantime, in the other rotation direction of the pneumatic tire, drainage properties can be slightly enhanced by the fifth inclined groove having a small length.

In general, when a vehicle travels forward, the traveling speed of the vehicle is high, and thus particularly high drainage properties are required for a pneumatic tire. On the other hand, when the vehicle travels backward, the traveling speed of the vehicle is usually not high, and thus drainage properties required for the pneumatic tire are low compared with when the vehicle travels forward.

Although depending on the mounting orientation of the tire to the advancement direction of the vehicle, the pneumatic tire according to Additional Embodiment 2-11 of the present disclosure can provide improved drainage properties by the first inclined groove 130, the second inclined groove 140, the third inclined groove 150, and the fourth inclined groove 160, for example, when the vehicle travels forward, and in the meantime, can provide improved drainage properties by the fifth inclined groove 170 when the rotation direction of the tire is reversed, that is, for example, when the vehicle travels backward. Additionally, since the groove length of the fifth inclined groove 170 is shorter than that of the fourth inclined groove 160, drainage properties are low compared with the fourth inclined groove 160; however, a decrease in block rigidity of the land portion due to the arrangement of the fifth inclined groove 170 is small. As a result, drainage properties and block rigidity when the vehicle moves forward and backward can be provided in a compatible manner.

### Additional Embodiment 2-12

As illustrated in FIG. 2, in relation to any one of Additional Embodiments 2-8 to 2-10, in the pneumatic tire according to Additional Embodiment 2-12 of the present disclosure, the orientation of an acute angle formed by each of the second inclined groove 140 and the fourth inclined groove 160 with respect to the tire width direction W is equal to the orientation of an acute angle formed by the first inclined groove 130 with respect to the tire width direction W, and the orientation of an acute angle formed by the third inclined groove 150 with respect to the tire width direction W is different from the orientation of the acute angle formed by the first inclined groove 130 with respect to the tire width direction W.

Although depending on the mounting orientation of the tire with respect to the advancement direction of the vehicle, the pneumatic tire according to Additional Embodiment 2-12 of the present disclosure can provide improved drainage properties by the first inclined groove 130, the second inclined groove 140, and the fourth inclined groove 160, for example, when the vehicle travels forward, and in the meantime, can provided improved drainage properties by the third inclined groove 150 when the rotation direction of the tire is reversed, that is, for example, when the vehicle travels backward. Since the third inclined groove 150 is disposed on the vehicle mounting inner side, drainage properties on the vehicle mounting inner side, in particular, when the vehicle travels backward, can be particularly improved.

In a state where the tire is mounted on the vehicle, when the tire equatorial direction is inclined toward the vehicle inner side from the direction perpendicular to the ground surface, the tire ground contact area is slightly larger on the vehicle mounting inner side than on the vehicle direction outer side. As a result, in such a case, by applying the pneumatic tire according to Additional Embodiment 2-12 of the present disclosure, wet steering stability, for example, at the time of traveling backward, can be particularly improved.

### Additional Embodiment 2-13

As illustrated in FIG. 1 (and FIG. 2), in relation to any one of Additional Embodiments 2-8 to 2-12, in the pneumatic tire according to Additional Embodiment 2-13 of the present disclosure, with respect to the tire circumferential direction, the terminating end portion on the vehicle mounting outer side of the third inclined groove 150 (260 in FIG. 2) terminates between the end portions on the vehicle mounting inner side of two of the first inclined grooves 130 (240 in FIG. 2) adjacent to each other, and/or the a terminating end portion on the vehicle mounting inner side of the fourth inclined groove 160 (270 in FIG. 2) terminates between the end portions on the vehicle mounting outer side of two of the second inclined grooves 140 (250 in FIG. 2) adjacent to each other.

Referring to FIG. 1, in the pneumatic tire according to Additional Embodiment 2-13 of the present disclosure, with the configuration as described above, the water flowing from the first circumferential main groove 110 and the second circumferential main groove 120 into the first inclined groove 130 and the second inclined groove 120, respectively, is efficiently collected by the third inclined groove 150 and the fourth inclined groove 160, respectively, and is easily discharged to the tire outer side. From such a viewpoint, with respect to the tire width direction W, the terminating end portion on the vehicle mounting outer side of the third inclined groove 150 further preferably terminates between the terminating end portions on the vehicle mounting inner side of the two first inclined grooves 130 adjacent to each other. Similarly, with respect to the tire width direction W, the terminating end portion on the vehicle mounting inner side of the fourth inclined groove 160 further preferably terminates between the terminating end portions on the vehicle mounting outer side of the two second inclined grooves 140 adjacent to each other.

### Additional Embodiment 2-14

As illustrated in FIG. 1, in relation to any one of Additional Embodiments 2-8 to 2-13, in the pneumatic tire according to Additional Embodiment 2-14 of the present disclosure, the terminating end portion in the vehicle mounting outer side direction W_{O} of the second inclined groove 140 terminates between the two fourth inclined grooves 160 adjacent to each other in the tire circumferential direction. Here, it is preferable that the following relationship (16) be satisfied, where L_{G4G4} is the length in the tire circumferential direction from one to the other of the two fourth inclined grooves 160 adjacent to each other and L_{G2G4} is the length in the tire circumferential direction from one of the two fourth inclined grooves 160 adjacent to each other to the terminating end portion of the second inclined groove 140:

0.40<L_{G2G4}/L_{G4G4}<0.60 (16).

When the above relationship (15) is satisfied, the terminating end portion in the vehicle mounting outer side direction W_{O} of the second inclined groove 140 terminates near the center between the two fourth inclined grooves 160 adjacent to each other in the tire circumferential direction. Accordingly, the delivery of water between the second inclined groove 140 and the fourth inclined groove 160 is more efficiently performed. Note that although not illustrated in FIG. 2, L_{G4G4} and L_{G2G4} are the same therein.

Here, L_{G2G4}/L_{G4G4} may be more than 0.40, 0.43 or more, or 0.45 or more, and may be less than 0.60, 0.58 or less, or 0.55 or less.

### Additional Embodiment 2-15

In relation to any one of Additional Embodiments 2-8 to 2-14, the pneumatic tire according to Additional Embodiment 2-15 of the present disclosure satisfies the following relationships (17) to (20), where in a tire meridian cross-sectional view, d_{G} is the maximum value of lengths in the tire radial direction from the tire surface profile, when the circumferential main grooves and the inclined grooves are not present, to the groove bottoms of the first and second circumferential main grooves 110 and 120 and d_{IG1}, d_{IG2}, d_{IG3}, and d_{IG4} are respectively the maximum values of lengths in the tire radial direction from the tire surface profile to the groove bottoms of the first inclined groove 130, the second inclined groove 140, the third inclined groove 150, and the fourth inclined groove 160:

0.05<d_{IG1}/d_{G}<0.85 (17),

0.05<d_{IG2}/d_{G}<0.85 (18),

0.05<d_{IG3}/d_{G}<0.85 (19), and

0.05<d_{IG4}/d_{G}<0.85 (20).

In the pneumatic tire of the present disclosure according to Additional Embodiment 2-15, the maximum values (d_{IG1}, d_{IG2}, d_{IG3}, and d_{IG4}) of the lengths in the tire radial direction from the tire surface profile to the groove bottoms of the first inclined groove 130, the second inclined groove 140, the third inclined groove 150, and the fourth inclined groove 160 are smaller than the maximum value d_{G} of lengths in the tire radial direction from the tire surface profile to the groove bottoms of the first and second circumferential main grooves 110 and 120. Thus, drainage properties can be improved while suppressing a decrease in block rigidity of the tire due to each of the inclined grooves 130, 140, 150, 160. Here, when 0.05<d_{IG1} (or d_{IG2}, d_{IG3}, d_{IG4})/d_{G}, the depths of the first inclined groove 130, the second inclined groove 140, the third inclined groove 150, and the fourth inclined groove 160 are sufficiently large, and thus drainage properties are particularly improved. On the other hand, when d_{IG1} (or d_{IG2}, d_{IG3}, d_{IG4})/d_{G}<0.85, the depths of the first inclined groove 130, the second inclined groove 140, the third inclined groove 150, and the fourth inclined groove 160 are not too large, and in particular, a decrease in block rigidity can be suppressed.

Here, d_{IG1} (or d_{IG2}, d_{IG3}, d_{IG4})/d_{G} may be more than 0.05, 0.1 or more, 0.2 or more, or 0.3 or more, and may be less than 0.85, 0.80 or less, 0.70 or less, or 0.60 or less.

### Additional Embodiment 2-16

In relation to any one of Basic Embodiment 2 and Additional Embodiments 2-1 and 2-15, the pneumatic tire according to Additional Embodiment 2-16 of the present disclosure satisfies the following relationship (21), where S_{SI} is the total groove area on the vehicle mounting inner side of the circumferential main groove with respect to the tire equatorial plane CL and S_{SO} is the total groove area on the vehicle mounting outer side of the circumferential main groove with respect to the tire equatorial plane.

S_{SO}<S_{SI} (21)

Here, in a plan view of the tread surface of the pneumatic tire, the total groove area means the sum of the groove areas, including the chamfered portions, in a predetermined region. Accordingly, for example, the total groove area on the vehicle mounting inner side of the circumferential main groove with respect to the tire equatorial plane CL is the sum of the areas of the circumferential main groove disposed on the vehicle mounting inner side with respect to the tire equatorial plane CL, the circumferential main groove located on the vehicle mounting inner side with respect to the tire equatorial plane CL, and the chamfered portions formed on these circumferential main grooves.

In FIG. 1, the first circumferential main groove 110 and the second circumferential main groove 120 are disposed with the tire equatorial plane CL interposed therebetween. Here, the groove width of the first circumferential main groove 110 is larger than the groove width of the second circumferential main groove 120.

Accordingly, in FIG. 1, the total groove area S_{SI} on the vehicle mounting inner side of the circumferential main groove with respect to the tire equatorial plane CL is larger than the total groove area S_{SO} on the vehicle mounting outer side of the circumferential main groove with respect to the tire equatorial plane.

Further, in FIG. 2, the first circumferential main groove 210 and the third circumferential main groove 230 are disposed with the tire equatorial plane CL interposed therebetween. Furthermore, the second circumferential main groove 220 is disposed so as to be overlapped with the equatorial plane CL. Here, the total groove area S_{SI} on the vehicle mounting inner side of the circumferential main groove with respect to the tire equatorial plane CL is the sum of the groove area of the first circumferential main groove 210 and the groove area of a portion on the vehicle mounting inner side from the tire equatorial plane CL of the second circumferential main groove 220. Also, the total groove area S_{SO} on the vehicle mounting outer side of the circumferential main groove with respect to the tire equatorial plane CL is the sum of the groove area of the third circumferential main groove 230 and the groove area of a portion on the vehicle mounting outer side from the tire equatorial plane CL of the second circumferential main groove 220. Here, the groove width of the first circumferential main groove 210 is larger than the groove width of the third circumferential main groove 230. Additionally, the second circumferential main groove 220 is disposed such that the groove area of a portion on the vehicle mounting inner side from the tire equatorial plane CL is equal to the groove area of a portion on the vehicle mounting outer side from the tire equatorial plane CL.

Accordingly, in FIG. 2, the total groove area S_{SI} on the vehicle mounting inner side of the circumferential main groove with respect to the tire equatorial plane CL is larger than the total groove area S_{SO} on the vehicle mounting outer side of the circumferential main groove with respect to the tire equatorial plane CL.

By preferentially enhancing drainage properties on the vehicle mounting inner side and preferentially enhancing rigidity on the vehicle mounting outer side as described above, dry steering stability and wet steering stability are efficiently improved.

In the pneumatic tire according to Additional Embodiment 2-16 of the present disclosure, the total groove area S_{SI} on the vehicle mounting inner side of the circumferential main groove with respect to the tire equatorial plane CL is increased to efficiently enhance drainage properties, and meanwhile, the total groove area S_{SO} on the vehicle mounting outer side of the circumferential main groove with respect to the tire equatorial plane is decreased to efficiently enhance rigidity of the land portion.

As a result, the pneumatic tire according to Additional Embodiment 2-16 of the present disclosure can provide more improved wet steering stability and dry steering stability.

Note that a ratio S_{SI}/S_{SO} of the total groove area S_{SI} on the vehicle mounting inner side of the circumferential main groove with respect to the tire equatorial plane CL to the total groove area S_{SO} on the vehicle mounting outer side of the circumferential main groove with respect to the tire equatorial plane is larger than 1.1 and smaller than 1.5. S_{SI}/S_{SO} may be more than 1.1, 1.2 or more, 1.3 or more, or 1.4 or more, and may be less than 1.5, 1.4 or less, 1.3 or less, or 1.2 or less.

### Additional Embodiment 2-17

As illustrated in FIGS. 1 and 2, in the pneumatic tire according to Additional Embodiment 2-17 of the present disclosure, an average groove width of the circumferential main grooves on the vehicle mounting inner side is larger than an average groove width of the circumferential main grooves on the vehicle mounting outer side in relation to any one pair of two of the circumferential main grooves adjacent to each other in any one of Basic Embodiment 2 and Additional Embodiments 2-1 to 2-16.

More specifically, in FIG. 1, the groove width of the first circumferential main groove 110 is larger than the groove width of the second circumferential main groove 120. Additionally, in FIG. 2, the sizes of the groove widths of the first to third circumferential main grooves 210, 220, 230 are largest in the order of the first circumferential main groove 210, the second circumferential main groove 220, and the third circumferential main groove 230.

By preferentially enhancing drainage properties on the vehicle mounting inner side and preferentially enhancing rigidity on the vehicle mounting outer side as described above, dry steering stability and wet steering stability are efficiently improved.

In relation to the two adjacent circumferential main grooves, in the pneumatic tire according to Additional Embodiment 2-17 of the present disclosure, the average groove width of the circumferential main groove on the vehicle mounting inner side is increased to efficiently improve drainage properties, and meanwhile, the average groove width of the circumferential main groove on the vehicle mounting direction outer side is decreased to efficiently improve rigidity of the land portion defined and formed around the circumferential main groove.

As a result, the pneumatic tire according to Additional Embodiment 2-17 of the present disclosure can provide more improved wet steering stability and dry steering stability.

### Additional Embodiment 2-18

In the pneumatic tire according to Additional Embodiment 2-18 of the present disclosure, an average groove width of the circumferential main grooves on the vehicle mounting inner side is larger than an average groove width of the circumferential main grooves on the vehicle mounting outer side in all pairs of two of the circumferential main grooves adjacent to each other in relation to any one of Basic Embodiment 2 and Additional Embodiments 2-1 to 2-17.

In other words, the pneumatic tire according to Additional Embodiment 2-18 of the present disclosure is configured such that the average groove width of the plurality of circumferential main grooves decreases from the vehicle mounting inner side toward the vehicle mounting outer side.

By preferentially enhancing drainage properties on the vehicle mounting inner side and preferentially enhancing rigidity on the vehicle mounting outer side as described above, dry steering stability and wet steering stability are efficiently improved.

In the pneumatic tire according to Additional Embodiment 2-18 of the present disclosure, the average groove width of the circumferential main groove disposed on the vehicle mounting inner side is increased to efficiently improve drainage properties, and meanwhile, the average groove width of the circumferential main groove disposed on the vehicle mounting outer side is decreased to efficiently improve rigidity of the land portion defined and formed around the circumferential main groove.

As a result, the pneumatic tire according to Additional Embodiment 2-18 of the present disclosure can provide more improved wet steering stability and dry steering stability.

### Additional Embodiment 2-19

FIG. 5 is a cross-sectional view taken along the line A₂₁-A₂₂ of the first circumferential main groove 210 in FIG. 2.

As illustrated in FIG. 5, in relation to any one of Basic Embodiment 2 and Additional Embodiments 2-1 to 2-18, the pneumatic tire according to Additional Embodiment 2-19 of the present disclosure satisfies the following relationship (22) with respect to at least the circumferential main groove (in FIG. 5, the first circumferential main groove 210) disposed on the vehicle mounting innermost side, of the plurality of circumferential main grooves, in a tire meridian cross-sectional view, where θ_{GI} is an inclination angle with respect to the tire radial direction R of the vehicle mounting inner side groove wall 210a of the first circumferential main groove 210 and θ_{GO} is an inclination angle with respect to the tire radial direction of the vehicle mounting outer side groove wall 210b of the first circumferential main groove 210.

θ_{GI}<θ_{GO} (22)

In the pneumatic tire according to Additional Embodiment 2-19 of the present disclosure, the inclination angle θ_{GI} with respect to the tire radial direction of the vehicle mounting inner side groove wall 210a of the first circumferential main groove 210 is smaller than the inclination angle θ_{GO} with respect to the tire radial direction of the vehicle mounting outer side groove wall 210b of the first circumferential main groove 210.

Here, when profile lines from land portion surfaces located on both sides of the first circumferential main groove 210 to the groove bottom are compared on both vehicle mounting sides of the groove 210, an angle variation when transitioning from the surface profile of the chamfered portion 211 to the groove profile is relatively small on the vehicle mounting inner side W_{I}, and an angle variation when transitioning from the surface profile of the chamfered portion 212 to the groove profile is relatively large on the vehicle mounting outer side W_{O}. In other words, assuming that stresses almost equal and in opposite directions in the tire width direction are applied to the land portions located on both sides of the groove 210, due to the shapes of both land portions, it is clear that the land portion located on the vehicle mounting outer side with respect to the groove 210 is less likely to be worn and has higher rigidity. In other words, this configuration agrees with the aforementioned view that it is preferable to preferentially increase the rigidity on the vehicle mounting outer side.

Additionally, when the groove center line of the first circumferential main groove 210 is set as a reference, the groove volume on the vehicle mounting inner side is larger than the groove volume on the vehicle mounting outer side. This configuration also agrees with the aforementioned view that it is preferable to preferentially increase drainage properties on the vehicle mounting inner side.

As a result, the pneumatic tire according to Additional Embodiment 2-19 of the present disclosure can provide more improved wet steering stability and dry steering stability.

FIG. 6 is a cross-sectional view taken along the line B₂₁-B₂₂ of the second circumferential main groove 220 in FIG. 2. Further, FIG. 7 is a cross-sectional view taken along the line C₂₁-C₂₂ of the third circumferential main groove 230 in FIG. 2. Furthermore, FIG. 8 is a cross-sectional view taken along the line D₂₁-D₂₂ of the fourth inclined groove 270 in FIG. 2.

As illustrated in FIGS. 6 and 7, in the pneumatic tire according to Additional Embodiment 2-19 of the present disclosure, the second circumferential main groove 220 and the third circumferential main groove 230 may also satisfy θ_{GI}<θ_{GO}. On the other hand, as illustrated in FIG. 8, with respect to the fourth inclined groove 270, the inclination angles θ₁ and θ₂ of the groove walls may be equal.

Note that as illustrated in FIGS. 5 to 7, each of θ_{GI} and θ_{GO} is preferably largest in the order of the first circumferential main groove 210, the second circumferential main groove 220, and the third circumferential main groove 230. This is because drainage properties are particularly required to be improved more on the vehicle mounting inner side than on the vehicle mounting outer side of the tire.

The ratio θ_{GO}/θ_{GI} of the inclination angle θ_{GO} with respect to the tire radial direction of the vehicle mounting outer side groove wall of the circumferential main groove to the inclination angle θ_{GI} with respect to the tire radial direction of the vehicle mounting inner side groove wall of the circumferential main groove is preferably greater than 2.0 and smaller than 5.0.

θ_{GO}/θ_{GI} may be more than 2.0, 2.5 or more, 3.0 or more, or 3.5 or more, and may be less than 5.0, 4.5 or less, 4.0 or less, or 3.5 or less.

θ_{GI} may be more than 0° and 30° or less. θ_{GI} may be more than 0°, 1° or more, 5° or more, 10° or more, or 15° or more, and may be 30° or less, 25° or less, 20° or less, 15° or less, or 10° or less.

### EXAMPLES

### Pneumatic Tires of Inventive Examples 1 to 6 and Conventional Example 1

Pneumatic tires of Inventive Examples 1 to 6 and Conventional Example 1 were produced according to the “conditions” indicated in Table 1 below. Note that the tire size of the pneumatic tire in each Example was 255/35R19 (defined by JATMA).

In Table 1, “wave shape” for “shape of circumferential main groove” means that the groove center line of the circumferential main groove has a wave shape that amplifies in the tire width direction as it extends in the tire circumferential direction.

In Table 1, “vehicle mounting inner side chamfered portion” is a chamfer disposed at an edge portion on the vehicle mounting inner side of the circumferential main groove. In a certain example, “Yes” for “vehicle mounting inner side chamfered portion” means that the “vehicle mounting inner side chamfered portion” is present in all of the circumferential main grooves in the example. Also, in a certain example, “No” for “vehicle mounting inner side chamfered portion” means that the “vehicle mounting inner side chamfered portion” is not present in any of the circumferential main grooves in the example.

In Table 1, “vehicle mounting outer side chamfered portion” is a chamfer disposed at an edge portion on the vehicle mounting outer side of the circumferential main groove. In a certain example, “Yes” for “vehicle mounting outer side chamfered portion” means that the “vehicle mounting outer side chamfered portion” is present in all of the circumferential main grooves in the example. Also, in a certain example, “No” for “vehicle mounting outer side chamfered portion” means that the “vehicle mounting outer side chamfered portion” is not present in any of the circumferential main grooves in the example.

In Table 1, “W_{AI}” is the chamfer width of the vehicle mounting inner side chamfered portion and “W_{AO}” is the chamfer width of the vehicle mounting outer side chamfered portion. Further, “S_{SI}” is a total groove area on the vehicle mounting inner side of the circumferential main groove with respect to the tire equatorial plane, and “S_{SO}” is a total groove area on the vehicle mounting outer side of the circumferential main groove with respect to the tire equatorial plane. Furthermore, “d_{CI}” is the maximum value of the length in the tire radial direction from the tire surface profile to the innermost position in the tire radial direction of the vehicle mounting inner side chamfered portion, and “d_{G}” is the maximum value of the length in the tire radial direction from the tire surface profile, when the circumferential main groove is not present, to the groove bottom of the circumferential main groove. Additionally, “θ_{GI}” is an inclination angle of the vehicle mounting inner side groove wall of the circumferential main groove with respect to the tire radial direction, and “θ_{GO}” is an inclination angle of the vehicle mounting outer side groove wall of the circumferential main groove with respect to the tire radial direction.

### Pneumatic Tires of Inventive Examples 7 to 12 and Conventional Example 2

Pneumatic tires of Inventive Examples 7 to 12 and Conventional Example 2 were produced according to the “conditions” indicated in Table 2 below. Note that the tire size of the pneumatic tire in each Example was 255/35R19 (defined by JATMA).

In Table 2, “Yes” for “vehicle mounting outer side chamfered portion” means that the “vehicle mounting outer side chamfered portion” is, of the three circumferential main grooves, present only in the circumferential main grooves other than the circumferential main groove on the vehicle mounting outermost side, that is, only in the two circumferential main grooves on the vehicle mounting inner side. Also, in a certain example, “No” for “vehicle mounting outer side chamfered portion” means that the “vehicle mounting outer side chamfered portion” is not present in any of the circumferential main grooves in the example.

The definition of the conditions is otherwise the same as in Table 1.

### Evaluation on Dry Steering Stability

The tires of each Example were mounted on JATMA standard rim wheels having a rim size of 19×9.0J, adjusted to an internal pressure of 240 kPa, and mounted onto a front-wheel drive vehicle as a test vehicle having an engine displacement of 2.0 L.

Then, the test vehicle was driven at a speed of from 10 km/h to 180 km/h on a flat-circuit test course having a dry road surface, and a test driver performed sensory evaluation on steering characteristics when changing lanes and when cornering and on stability when traveling straight. The dry steering stability is displayed as an index value with Conventional Example used as a reference at 100. A larger index value indicates better dry steering stability. The results are indicated in Tables 1 and 2.

### Evaluation on Wet Steering Stability

The tires of each Example were mounted on JATMA standard rim wheels having a rim size of 19×9.0J, adjusted to an internal pressure of 240 kPa, and mounted onto a front-wheel drive vehicle as a test vehicle having an engine displacement of 2.0 L.

Then, the test vehicle was driven and decelerated from a speed of 180 km/h to be stopped on a flat-circuit test course having a dry road surface, and the reciprocal of the travel distance was calculated. The wet steering stability is displayed as an index value with Conventional Example used as a reference at 100. A larger index value indicates better wet steering stability. The results are indicated in Tables 1 and 2.

TABLE 1

| | | Conventional | Inventive | Inventive | |
|---|---|---|---|---|---|
| | | Example 1 | Example 1 | Example 2 | |
| Conditions | Number of circumferential | 2 | 2 | 2 | |
| | main grooves | | | | |
| | Groove width of | Constant | Constant | Constant | |
| | circumferential main groove | | | | |
| | Shape of circumferential | Wave shape | Wave | Wave | |
| | main groove | | shape | shape | |
| | Vehicle mounting inner side | No | Yes | Yes | |
| | chamfered portion | | | | |
| | Vehicle mounting outer side | No | No | Yes | |
| | chamfered portion | | | | |
| | W_{AI}/W_{AO} | — | — | 1.0 | |
| | S_{SI}/S_{SO} | 1.0 | 1.0 | 1.0 | |
| | d_{CI}/d_{G} | — | 0.40 | 0.40 | |
| | θ_{GO}/θ_{GI} | — | 1.0 | 1.0 | |
| Results | Dry steering stability | 100 | 100 | 100 | |
| | Wet steering stability | 100 | 101 | 102 | |
| | | Inventive | Inventive | Inventive | Inventive |
| | | Example 3 | Example 4 | Example 5 | Example 6 |
| Conditions | Number of circumferential | 2 | 2 | 2 | 2 |
| | main grooves | | | | |
| | Groove width of | Constant | Constant | Constant | Constant |
| | circumferential main groove | | | | |
| | Shape of circumferential | Wave | Wave | Wave | Wave |
| | main groove | shape | shape | shape | shape |
| | Vehicle mounting inner side | Yes | Yes | Yes | Yes |
| | chamfered portion | | | | |
| | Vehicle mounting outer side | Yes | Yes | Yes | Yes |
| | chamfered portion | | | | |
| | W_{AI}/W_{AO} | 1.5 | 1.5 | 1.5 | 1.5 |
| | S_{SI}/S_{SO} | 1.0 | 1.3 | 1.3 | 1.3 |
| | d_{CI}/d_{G} | 0.40 | 0.40 | 0.15 | 0.15 |
| | θ_{GO}/θ_{GI} | 1.0 | 1.0 | 1.0 | 3.5 |
| Results | Dry steering stability | 101 | 103 | 104 | 105 |
| | Wet steering stability | 103 | 104 | 104 | 104 |

TABLE 2

| | | Conventional | Inventive | Inventive | |
|---|---|---|---|---|---|
| | | Example 2 | Example 7 | Example 8 | |
| Conditions | Number of | 3 | 3 | 3 | |
| | circumferential main | | | | |
| | grooves | | | | |
| | Groove width of | Constant | Constant | Constant | |
| | circumferential main | | | | |
| | groove | | | | |
| | Shape of circumferential | Wave shape | Wave | Wave | |
| | main groove | | shape | shape | |
| | Vehicle mounting inner | No | Yes | Yes | |
| | side chamfered portion | | | | |
| | Vehicle mounting outer | No | No | Yes | |
| | side chamfered portion | | | | |
| | W_{AI}/W_{AO} | — | — | 1.0 | |
| | S_{SI}/S_{SO} | 1.0 | 1.0 | 1.0 | |
| | d_{CI}/d_{G} | — | 0.40 | 0.40 | |
| | θ_{GO}/θ_{GI} | — | 1.0 | 1.0 | |
| Results | Dry steering stability | 100 | 100 | 100 | |
| | Wet steering stability | 100 | 101 | 102 | |
| | | Inventive | Inventive | Inventive | Inventive |
| | | Example 9 | Example 10 | Example 11 | Example 12 |
| Conditions | Number of | 3 | 3 | 3 | 3 |
| | circumferential main | | | | |
| | grooves | | | | |
| | Groove width of | Constant | Constant | Constant | Constant |
| | circumferential main | | | | |
| | groove | | | | |
| | Shape of circumferential | Wave | Wave shape | Wave shape | Wave shape |
| | main groove | shape | | | |
| | Vehicle mounting inner | Yes | Yes | Yes | Yes |
| | side chamfered portion | | | | |
| | Vehicle mounting outer | Yes | Yes | Yes | Yes |
| | side chamfered portion | | | | |
| | W_{AI}/W_{AO} | 1.5 | 1.5 | 1.5 | 1.5 |
| | S_{SI}/S_{SO} | 1.0 | 1.3 | 1.3 | 1.3 |
| | d_{CI}/d_{G} | 0.40 | 0.40 | 0.15 | 0.15 |
| | θ_{GO}/θ_{GI} | 1.0 | 1.0 | 1.0 | 3.5 |
| Results | Dry steering stability | 101 | 103 | 104 | 105 |
| | Wet steering stability | 103 | 104 | 104 | 104 |

As can be seen from Tables 1 and 2, any of the pneumatic tires of Inventive Examples 1 to 12, complying with the technical scope of the present technology, provides improved dry steering stability and wet steering stability in a well-balanced manner compared with the pneumatic tires of Conventional Examples 1 and 2, not complying with the technical scope of the present technology.

### Pneumatic Tires of Inventive Examples 1-1, 1-2, 7-1, and 7-2

Regarding Inventive Example 1, the tire in which the average groove width of the first circumferential main groove 110 was equal to the average groove width of the second circumferential main groove 120 was produced as Inventive Example 1-1, and the tire in which the average groove width of the first circumferential main groove 110 was larger than the average groove width of the second circumferential main groove 120 was produced as Inventive Example 1-2. Note that the tire size of the pneumatic tire in each Example was 255/35R19 (defined by JATMA).

Also, regarding Inventive Example 7, the tire in which the average groove widths of the first circumferential main groove 210, the second circumferential main groove 220, and the third circumferential main groove 230 were equal was produced as Inventive Example 7-1, and the tire in which the average groove width is larger in the order of the third circumferential main groove 230, the second circumferential main groove 220, and the first circumferential main groove 210 was produced as Inventive Example 7-2. Note that the tire size of the pneumatic tire in each Example was 255/35R19 (defined by JATMA).

The aforementioned “evaluation of dry steering stability” and the aforementioned “evaluation of wet steering stability” were conducted on the pneumatic tires of Inventive Examples 1-1, 1-2, 7-1, and 7-2. Note that in these Inventive Examples, wet steering stability was evaluated when the vehicle was traveling forward and when the vehicle was traveling backward.

When the evaluations of dry steering stability and wet steering stability in Inventive Example 1-1 were 100, the evaluations of dry steering stability and wet steering stability in Inventive Example 1-2 were 99 and 101. Also, when the evaluations of dry steering stability and wet steering stability in Inventive Example 7-1 were 100, the evaluations of dry steering stability and wet steering stability in Inventive Example 7-2 were 99 and 101.

### Pneumatic Tires of Inventive Examples 13 to 29

The pneumatic tires of Inventive Examples 13 to 21 were produced based on the groove shape illustrated in FIG. 1 and in accordance with the “conditions” indicated in Table 3 below. Also, the pneumatic tires of Inventive Examples 22 to 30 were produced based on the groove shape illustrated in FIG. 2 and in accordance with the “conditions” indicated in Table 4 below. Note that the tire size of the pneumatic tire in each Example was 255/35R19 (defined by JATMA). Additionally, each of the pneumatic tires of Inventive Examples 13 to 21 includes the conditions indicated in Table 3 in addition to the configuration of Inventive Example 1. Moreover, each of the pneumatic tires of Inventive Examples 22 to 30 includes the conditions indicated in Table 4 in addition to the configuration of Inventive Example 7.

Referring to FIG. 1, in Table 3, “L_{IG1}” is a length in the tire width direction W of a portion of the first inclined groove 130, which extends toward the vehicle mounting outer side from the first circumferential main groove 110 and “L_{L}” is a length in the tire width direction W of the land portion adjacent on the vehicle mounting outer side to the first circumferential main groove 110. Further, “L_{G4G4}” is a length in the tire circumferential direction from one to the other of the two fourth inclined grooves 160 adjacent to each other in the tire circumferential direction and “L_{G2G4}” is a length in the tire circumferential direction from one of the two adjacent fourth inclined grooves to the terminating end portion of the second inclined groove. Furthermore, “d_{G}” is, in a tire meridian cross-sectional view, the maximum value of lengths in the tire radial direction from the tire surface profile, when the circumferential main grooves 110, 120 and the inclined grooves 130 to 170 are not present (hereinafter simply referred to as “tire surface profile”), to the groove bottoms of the circumferential main grooves 110, 120, and “d_{IG2}”, “d_{IG1}”, “d_{IG3}” and “d_{IG4}” are respectively the maximum values of lengths in the tire radial direction from the tire surface profile to the groove bottoms of the first inclined groove 130, the second inclined groove 140, the third inclined groove 150, and the fourth inclined groove 160. Finally, “d_{G1}” is the maximum value of a length in the tire radial direction from the tire surface profile to the groove bottom of the first circumferential main groove 110, “d_{IG1′}” is the maximum value of a length in the tire radial direction from the tire surface profile to a groove bottom in a portion of the first inclined groove 130, which is located on the vehicle mounting outer side from the first circumferential main groove 110 as a starting point, and “d_{IG1″}” is the maximum value of a length in the tire radial direction from the tire surface profile to a groove bottom in a portion of the first inclined groove 130, which is located on the vehicle mounting inner side from the first circumferential main groove 110 as a starting point.

Regarding the shape of the first inclined groove 130, the “starting point” is a starting point at which the first inclined groove 130 starts from the first circumferential groove 110, and the “inner side starting point” is a starting point on the inner side in the tire width direction with respect to the first circumferential groove 110, that is, a starting point on the tire equatorial line CL side as viewed from the first circumferential groove 110. On the other hand, the “outer side starting point” is a starting point on the outer side in the tire width direction with respect to the first circumferential groove 110, that is, a starting point on the side opposite to the tire equatorial line CL side as viewed from the first circumferential groove 110. Similarly, regarding the shape of the second inclined groove 140, the “starting point” is a starting point at which the second inclined groove 140 starts from the second circumferential groove 120, and the “outer side starting point” is a starting point on the outer side in the tire width direction with respect to the second circumferential groove 120, that is, a starting point on the side opposite to the tire equatorial line CL side as viewed from the second circumferential groove 120. In addition, that the starting point is “recessed” means that the starting point of the inclined groove is located in a recessed portion of the circumferential main groove, and conversely, that the starting point is “projected” means that the starting point of the inclined groove is located in a projected portion of the circumferential main groove. Table 4 is similarly understood with reference to FIG. 2.

Note that the first inclined groove 130 (240 in FIG. 2) is a groove extending toward a respective vehicle mounting side from the circumferential main groove 110 (210 in FIG. 2), as a starting point, disposed on the vehicle mounting innermost side, of the plurality of circumferential main grooves. In addition, the second inclined groove 140 (250 in FIG. 2) is a groove extending toward the vehicle mounting outer side from the circumferential main groove 120 (230 in FIG. 2), as a starting point, disposed on the vehicle mounting outermost side, of the plurality of circumferential main grooves. The third inclined groove 150 (260 in FIG. 2) is a groove disposed such that both ends thereof terminate in the land portion adjacent on the vehicle mounting inner side to the first circumferential main groove 110 (210 in FIG. 2). Further, the fourth inclined groove 160 (270 in FIG. 2) is a groove disposed such that both ends thereof terminate in the land portion adjacent on the vehicle mounting outer side to the second circumferential main groove 120 (250 in FIG. 2). Furthermore, the fifth inclined groove 170 is disposed such that both ends thereof terminate in the land portion adjacent on the vehicle mounting outer side to the second circumferential main groove 120 disposed on the vehicle mounting outermost side, of the plurality of circumferential main grooves (two grooves in FIG. 1), and the fifth inclined groove 170 has a groove length shorter than that of the fourth inclined groove 160.

The aforementioned “evaluation of dry steering stability” and the aforementioned “evaluation of wet steering stability” were conducted on the pneumatic tires of Inventive Examples 13 to 29. Note that in these Inventive Examples, wet steering stability was evaluated when the vehicle was traveling forward and when the vehicle was traveling backward.

The results are indicated in Tables 3 and 4.

TABLE 3

| | | | Inventive | Inventive | Inventive |
|---|---|---|---|---|---|
| Example | | | Example 13 | Example 14 | Example 15 |
| Conditions | Presence of | First inclined | Yes | Yes | Yes |
| | inclined | groove | | | |
| | groove | Second | Yes | Yes | Yes |
| | | inclined | | | |
| | | groove | | | |
| | | Third | Yes | Yes | Yes |
| | | inclined | | | |
| | | groove | | | |
| | | Fourth | Yes | Yes | Yes |
| | | inclined | | | |
| | | groove | | | |
| | | Fifth inclined | Yes | Yes | Yes |
| | | groove | | | |
| | Orientation | First inclined | Oriented to | Oriented to | Oriented to |
| | of acute | groove | vehicle | vehicle | vehicle |
| | angle | | mounting | mounting | mounting |
| | formed by | | inner side | inner side | inner side |
| | inclined | Second | Oriented to | Oriented to | Oriented to |
| | groove and | inclined | vehicle | vehicle | vehicle |
| | tire width | groove | mounting | mounting | mounting |
| | direction | | inner side | inner side | inner side |
| | | Third | Oriented to | Oriented to | Oriented to |
| | | inclined | vehicle | vehicle | vehicle |
| | | groove | mounting | mounting | mounting |
| | | | inner side | inner side | inner side |
| | | Fourth | Oriented to | Oriented to | Oriented to |
| | | inclined | vehicle | vehicle | vehicle |
| | | groove | mounting | mounting | mounting |
| | | | inner side | inner side | inner side |
| | | Fifth inclined | Oriented to | Oriented to | Oriented to |
| | | groove | vehicle | vehicle | vehicle |
| | | | mounting | mounting | mounting |
| | | | inner side | outer side | outer side |
| | Length of | Third | Straddling | Straddling | Straddling |
| | inclined | inclined | | | |
| | groove | groove | | | |
| | (whether | Fourth | Straddling | Straddling | Straddling |
| | inclined | inclined | | | |
| | groove | groove | | | |
| | straddles | Fifth inclined | Straddling | Straddling | Not |
| | ground | groove | | | straddling |
| | contact | | | | |
| | edge) | | | | |
| | Shape of | Inner side | Projected | Projected | Projected |
| | first inclined | starting point | | | |
| | groove | Outer side | Recessed | Recessed | Recessed |
| | | starting point | | | |
| | Shape of | Outer side | Recessed | Recessed | Recessed |
| | second | starting point | | | |
| | inclined | | | | |
| | groove | | | | |
| | L_{IG1}/L_{L} | | 0.2 or less | 0.2 or less | 0.2 or less |
| | L_{G2G4}/_{LG4G4} | | 0.4 or less | 0.4 or less | 0.4 or less |
| | d_{IG1 to 4}/d_{G} | | 0.05 or less | 0.05 or less | 0.05 or less |
| | Magnitude relationship | | d_{IG1′} = d_{IG1″} < | d_{IG1′} = d_{IG1″} < | d_{IG1′} = d_{IG1″} < |
| | between d_{IG1′}, d_{IG1″}, and d_{G1} | | d_{G1} | d_{G1} | d_{G1} |
| Results | Dry steering stability | | 100 | 100 | 101 |
| | Wet steering stability | | 100 | 101 | 101 |
| | | | Inventive | Inventive | Inventive |
| Example | | | Example 16 | Example 17 | Example 18 |
| Conditions | Presence of | First inclined | Yes | Yes | Yes |
| | inclined | groove | | | |
| | groove | Second | Yes | Yes | Yes |
| | | inclined | | | |
| | | groove | | | |
| | | Third | Yes | Yes | Yes |
| | | inclined | | | |
| | | groove | | | |
| | | Fourth | Yes | Yes | Yes |
| | | inclined | | | |
| | | groove | | | |
| | | Fifth inclined | Yes | Yes | Yes |
| | | groove | | | |
| | Orientation of | First inclined | Oriented to | Oriented to | Oriented to |
| | acute angle | groove | vehicle | vehicle | vehicle |
| | formed by | | mounting | mounting | mounting |
| | inclined | | inner side | inner side | inner side |
| | groove and | Second | Oriented to | Oriented to | Oriented to |
| | tire width | inclined | vehicle | vehicle | vehicle |
| | direction | groove | mounting | mounting | mounting |
| | | | inner side | inner side | inner side |
| | | Third | Oriented to | Oriented to | Oriented to |
| | | inclined | vehicle | vehicle | vehicle |
| | | groove | mounting | mounting | mounting |
| | | | inner side | inner side | inner side |
| | | Fourth | Oriented to | Oriented to | Oriented to |
| | | inclined | vehicle | vehicle | vehicle |
| | | groove | mounting | mounting | mounting |
| | | | inner side | inner side | inner side |
| | | Fifth inclined | Oriented to | Oriented to | Oriented to |
| | | groove | vehicle | vehicle | vehicle |
| | | | mounting | mounting | mounting |
| | | | outer side | outer side | outer side |
| | Length of | Third | Straddling | Straddling | Straddling |
| | inclined | inclined | | | |
| | groove | groove | | | |
| | (whether | Fourth | Straddling | Straddling | Straddling |
| | inclined | inclined | | | |
| | groove | groove | | | |
| | straddles | Fifth inclined | Not | Not | Not |
| | ground contact | groove | straddling | straddling | straddling |
| | edge) | | | | |
| | Shape of first | Inner side | Recessed | Recessed | Recessed |
| | inclined | starting point | | | |
| | groove | Outer side | Projected | Projected | Projected |
| | | starting point | | | |
| | Shape of | Outer side | Recessed | Projected | Projected |
| | second | starting point | | | |
| | inclined | | | | |
| | groove | | | | |
| | L_{IG1}/L_{L} | | 0.2 or less | 0.2 or less | 0.2 to 0.6 |
| | L_{G2G4}/_{LG4G4} | | 0.4 or less | 0.4 or less | 0.4 or less |
| | d_{IG1 to 4}/d_{G} | | 0.05 or less | 0.05 or less | 0.05 or less |
| | Magnitude relationship | | d_{IG1′} = d_{IG1″} < | d_{IG1′} = d_{IG1″} < | d_{IG1′} = d_{IG1″} < |
| | between d_{IG1′}, d_{IG1″}, and d_{G1} | | d_{G1} | d_{G1} | d_{G1} |
| Results | Dry steering stability | | 101 | 102 | 103 |
| | Wet steering stability | | 102 | 103 | 104 |
| | | | Inventive | Inventive | Inventive |
| Example | | | Example 19 | Example 20 | Example 21 |
| Conditions | Presence of | First inclined | Yes | Yes | Yes |
| | inclined | groove | | | |
| | groove | Second | Yes | Yes | Yes |
| | | inclined | | | |
| | | groove | | | |
| | | Third | Yes | Yes | Yes |
| | | inclined | | | |
| | | groove | | | |
| | | Fourth | Yes | Yes | Yes |
| | | inclined | | | |
| | | groove | | | |
| | | Fifth inclined | Yes | Yes | Yes |
| | | groove | | | |
| | Orientation of | First inclined | Oriented to | Oriented to | Oriented to |
| | acute angle | groove | vehicle | vehicle | vehicle |
| | formed by | | mounting | mounting | mounting |
| | inclined | | inner side | inner side | inner side |
| | groove and | Second | Oriented to | Oriented to | Oriented to |
| | tire width | inclined | vehicle | vehicle | vehicle |
| | direction | groove | mounting | mounting | mounting |
| | | | inner side | inner side | inner side |
| | | Third | Oriented to | Oriented to | Oriented to |
| | | inclined | vehicle | vehicle | vehicle |
| | | groove | mounting | mounting | mounting |
| | | | inner side | inner side | inner side |
| | | Fourth | Oriented to | Oriented to | Oriented to |
| | | inclined | vehicle | vehicle | vehicle |
| | | groove | mounting | mounting | mounting |
| | | | inner side | inner side | inner side |
| | | Fifth inclined | Oriented to | Oriented to | Oriented to |
| | | groove | vehicle | vehicle | vehicle |
| | | | mounting | mounting | mounting |
| | | | outer side | outer side | outer side |
| | Length of | Third | Straddling | Straddling | Straddling |
| | inclined | inclined | | | |
| | groove | groove | | | |
| | (whether | Fourth | Straddling | Straddling | Straddling |
| | inclined | inclined | | | |
| | groove | groove | | | |
| | straddles | Fifth inclined | Not | Not | Not |
| | ground contact | groove | straddling | straddling | straddling |
| | edge) | | | | |
| | Shape offirst | Inner side | Recessed | Recessed | Recessed |
| | inclined | starting point | | | |
| | groove | Outer side | Projected | Projected | Projected |
| | | starting point | | | |
| | Shape of | Outer side | Projected | Projected | Projected |
| | second | starting point | | | |
| | inclined | | | | |
| | groove | | | | |

| | | | | |
|---|---|---|---|---|
| | L_{IG1}/L_{L} | 0.2 to 0.6 | 0.2 to 0.6 | 0.2 to 0.6 |
| | L_{G2G4}/_{LG4G4} | 0.4 to 0.6 | 0.4 to 0.6 | 0.4 to 0.6 |
| | d_{IG1 to 4}/d_{G} | 0.05 or less | 0.05 to 0.85 | 0.05 to 0.85 |
| | Magnitude relationship | d_{IG1′} = d_{IG1″} < | d_{IG1′} = d_{IG1″} < | d_{IG1′} = d_{IG1″} < |
| | between d_{IG1′}, d_{IG1″}, and d_{G1} | d_{G1} | d_{G1} | d_{G1} |
| Results | Dry steering stability | 104 | 105 | 106 |
| | Wet steering stability | 105 | 105 | 105 |

TABLE 4

| | | | Inventive | Inventive | Inventive |
|---|---|---|---|---|---|
| Example | | | Example 22 | Example 23 | Example 24 |
| Conditions | Presence of | First inclined | Yes | Yes | Yes |
| | inclined groove | groove | | | |
| | | Second inclined | Yes | Yes | Yes |
| | | groove | | | |
| | | Third inclined | Yes | Yes | Yes |
| | | groove | | | |
| | | Fourth inclined | Yes | Yes | Yes |
| | | groove | | | |
| | Orientation of | First inclined | Oriented to | Oriented to | Oriented to |
| | acute angle | groove | vehicle | vehicle | vehicle |
| | formed by | | mounting | mounting | mounting |
| | inclined groove | | inner side | inner side | inner side |
| | and tire width | Second inclined | Oriented to | Oriented to | Oriented to |
| | direction | groove | vehicle | vehicle | vehicle |
| | | | mounting | mounting | mounting |
| | | | inner side | inner side | inner side |
| | | Third inclined | Oriented to | Oriented to | Oriented to |
| | | groove | vehicle | vehicle | vehicle |
| | | | mounting | mounting | mounting |
| | | | inner side | inner side | inner side |
| | | Fourth inclined | Oriented to | Oriented to | Oriented to |
| | | groove | vehicle | vehicle | vehicle |
| | | | mounting | mounting | mounting |
| | | | inner side | outer side | outer side |
| | Length of | Third inclined | Straddling | Straddling | Straddling |
| | inclined groove | groove | | | |
| | (whether | Fourth inclined | Straddling | Straddling | Straddling |
| | inclined groove | groove | | | |
| | straddles ground | | | | |
| | contact edge) | | | | |
| | Shape of first | Inner side | Projected | Projected | Recessed |
| | inclined groove | starting point | | | |
| | | Outer side | Recessed | Recessed | Projected |
| | | starting point | | | |
| | Shape of second | Outer side | Recessed | Recessed | Recessed |
| | inclined groove | starting point | | | |
| | L_{IG1}/L_{L} | | 0.2 or less | 0.2 or less | 0.2 or less |
| | L_{G2G4}/_{LG4G4} | | 0.4 or less | 0.4 or less | 0.4 or less |
| | d_{IG1 to 4}/d_{G} | | 0.05 or less | 0.05 or less | 0.05 or less |
| | Magnitude relationship | | d_{IG1′} = d_{IG1″} < | d_{IG1′} = d_{IG1″} < | d_{IG1′} = d_{IG1″} < |
| | between d_{IG1′}, d_{IG1″}, and d_{G1} | | d_{G1} | d_{G1} | d_{G1} |
| Results | Dry steering stability | | 100 | 100 | 101 |
| | Wet steering stability | | 100 | 101 | 101 |
| | | | Inventive | Inventive | Inventive |
| | | | Example | Example | Example |
| Example | | | 25 | 26 | 27 |
| Conditions | Presence of inclined | First inclined | Yes | Yes | Yes |
| | groove | groove | | | |
| | | Second | Yes | Yes | Yes |
| | | inclined groove | | | |
| | | Third inclined | Yes | Yes | Yes |
| | | groove | | | |
| | | Fourth inclined | Yes | Yes | Yes |
| | | groove | | | |
| | Orientation of acute | First inclined | Oriented | to vehicle | Oriented |
| | angle formed by | groove | to vehicle | Oriented | to vehicle |
| | inclined groove and | | mounting | mounting | mounting |
| | tire width direction | | inner side | inner side | inner side |
| | | Second | Oriented | Oriented | Oriented |
| | | inclined groove | to vehicle | to vehicle | to vehicle |
| | | | mounting | mounting | mounting |
| | | | inner side | inner side | inner side |
| | | Third inclined | Oriented | Oriented | Oriented |
| | | groove | to vehicle | to vehicle | to vehicle |
| | | | mounting | mounting | mounting |
| | | | inner side | inner side | inner side |
| | | Fourth inclined | Oriented | Oriented | outer side |
| | | groove | mounting | mounting | Oriented |
| | | | outer side | outer side | mounting |
| | | | to vehicle | to vehicle | to vehicle |
| | Length of inclined | Third inclined | Straddling | Straddling | Straddling |
| | groove (whether | groove | | | |
| | inclined groove | Fourth inclined | Straddling | Straddling | Straddling |
| | straddles ground | groove | | | |
| | contact edge) | | | | |
| | Shape of first inclined | Inner side | Recessed | Recessed | Recessed |
| | groove | starting point | | | |
| | | Outer side | Projected | Projected | Projected |
| | | starting point | | | |
| | Shape of second | Outer side | Projected | Projected | Projected |
| | inclined groove | starting point | | | |

| | | | | |
|---|---|---|---|---|
| | L_{IG1}/L_{L} | 0.2 or less | 0.2 to 0.6 | 0.2 to 0.6 |
| | L_{G2G4}/_{LG4G4} | 0.4 or less | 0.4 or less | 0.4 to 0.6 |
| | d_{IG1 to 4}/d_{G} | 0.05 or | 0.05 or | 0.05 or |
| | | less | less | less |
| | Magnitude relationship | d_{IG1′} = | d_{IG1′} = | d_{IG1′} = |
| | between d_{IG1′}, d_{IG1″}, and d_{G1} | d_{IG1″} < d_{G1} | d_{IG1″} < d_{G1} | d_{IG1″} < d_{G1} |
| Results | Dry steering stability | 102 | 103 | 104 |
| | Wet steering stability | 102 | 103 | 104 |

| | | | Inventive | Inventive |
|---|---|---|---|---|
| Example | | | Example 28 | Example 29 |
| Conditions | Presence of | First inclined groove | Yes | Yes |
| | inclined groove | Second inclined groove | Yes | Yes |
| | | Third inclined groove | Yes | Yes |
| | | Fourth inclined groove | Yes | Yes |
| | Orientation of | First inclined groove | Oriented to | Oriented to |
| | acute angle formed | | vehicle | vehicle |
| | by inclined groove | | mounting | mounting |
| | and tire width | | inner side | inner side |
| | direction | Second inclined groove | Oriented to | Oriented to |
| | | | vehicle | vehicle |
| | | | mounting | mounting |
| | | | inner side | inner side |
| | | Third inclined groove | Oriented to | Oriented to |
| | | | vehicle | vehicle |
| | | | mounting | mounting |
| | | | inner side | inner side |
| | | Fourth inclined groove | Oriented to | Oriented to |
| | | | vehicle | vehicle |
| | | | mounting | mounting |
| | | | outer side | outer side |
| | Length of inclined | Third inclined groove | Straddling | Straddling |
| | groove (whether | Fourth inclined groove | Straddling | Straddling |
| | inclined groove | | | |
| | straddles ground | | | |
| | contact edge) | | | |
| | Shape of first | Inner side starting point | Recessed | Recessed |
| | inclined groove | Outer side starting point | Projected | Projected |
| | Shape of second | Outer side starting point | Projected | Projected |
| | inclined groove | | | |

| | | | |
|---|---|---|---|
| | L_{IG1}/L_{L} | 0.2 to 0.6 | 0.2 to 0.6 |
| | L_{G2G4}/_{LG4G4} | 0.4 to 0.6 | 0.4 to 0.6 |
| | d_{IG1 to 4}/d_{G} | 0.05 to 0.85 | 0.05 to 0.85 |
| | Magnitude relationship | d_{IG1′} = d_{IG1″} < | d_{IG1′} = d_{IG1″} < |
| | between d_{IG1′}, d_{IG1″}, and d_{G1} | d_{G1} | d_{G1} |
| Results | Dry steering stability | 105 | 106 |
| | Wet steering stability | 104 | 104 |

As can be seen from Tables 3 and 4, any of the pneumatic tires of Inventive Examples 13 to 29, complying with the technical scope of the present technology, provides improved dry steering stability and wet steering stability in a well-balanced manner. Note that in Tables 3 and 4, “to” representing a numerical range does not include endpoints. In other words, “0.2 to 0.6” means more than 0.2 and less than 0.6. Similarly, “0.4 to 0.6” means more than 0.4 and less than 0.6.

### Pneumatic Tires of Inventive Examples 30 and 31

Regarding the configuration related to the first inclined groove 130, the pneumatic tires of Inventive Examples 30 and 31 were produced based on the groove shape illustrated in FIG. 1, with the exception of L_{IG1}=L_{IG2} in Inventive Example 30 and L_{IG1}<L_{IG2} in Inventive Example 31. Note that the tire size of the pneumatic tire in each Example was 255/35R19 (defined by JATMA).

The aforementioned “evaluation of dry steering stability” and the aforementioned “evaluation of wet steering stability” were conducted on the pneumatic tires of Inventive Examples 30 and 31. Note that in these Inventive Examples, wet steering stability was evaluated when the vehicle was traveling forward and when the vehicle was traveling backward.

When the evaluations of dry steering stability and the wet steering stability in Inventive Example 30 were 100, the evaluations of dry steering stability and wet steering stability in Inventive Example 31 were 101 and 101.

### Pneumatic Tires of Inventive Examples 32 to 63

The pneumatic tires of Inventive Examples 32 to 48 were produced based on the groove shape illustrated in FIG. 1 without providing chamfers and in accordance with the “conditions” indicated in Table 5 below in a state where the conditions of the first and second circumferential main grooves 110, 120 and the presence and conditions of the first to fifth inclined grooves 130 to 170 were varied. Additionally, the pneumatic tires of Inventive Examples 49 to 63 were produced based on the groove shape illustrated in FIG. 2 without providing chamfers and in accordance with the “conditions” indicated in Table 6 below in a state where the conditions of the first and third circumferential main grooves 210, 230 and the presence and conditions of the first to fourth inclined grooves 240 to 270 are varied. Note that the tire size of the pneumatic tire in each Example was 255/35R19 (defined by JATMA).

Referring to FIG. 1, in Table 5, “L_{IG1}” is a length in the tire width direction W of a portion of the first inclined groove 130, which extends toward the vehicle mounting outer side from the first circumferential main groove 110, “L_{IG2}” is a length in the tire width direction W of a portion of the first inclined groove 130, which extends toward the vehicle mounting inner side from the first circumferential main groove 110, and “L_{L}” is a length in the tire width direction W of the land portion adjacent on the vehicle mounting outer side to the first circumferential main groove 110. Further, “L_{G4G4}” is a length in the tire circumferential direction from one to the other of the two fourth inclined grooves 160 adjacent to each other in the tire circumferential direction and “L_{G2G4}” is a length in the tire circumferential direction from one of the two adjacent fourth inclined grooves to the terminating end portion of the second inclined groove. Furthermore, “d_{G}” is, in a tire meridian cross-sectional view, the maximum value of lengths in the tire radial direction from the tire surface profile, when the circumferential main grooves 110, 120 and the inclined grooves 130 to 170 are not present (hereinafter simply referred to as “tire surface profile”), to the groove bottoms of the circumferential main grooves 110, 120, and “d_{IG1}”, “d_{IG2}”, “d_{IG3}” and “d_{IG4}” are respectively the maximum values of lengths in the tire radial direction from the tire surface profile to the groove bottoms of the first inclined groove 130, the second inclined groove 140, the third inclined groove 150, and the fourth inclined groove 160. Finally, “d_{G1}” is the maximum value of a length in the tire radial direction from the tire surface profile to the groove bottom of the first circumferential main groove 110, “d_{IG1′}” is the maximum value of a length in the tire radial direction from the tire surface profile to a groove bottom in a portion of the first inclined groove 130, which is located on the vehicle mounting outer side from the first circumferential main groove 110 as a starting point, and “d_{IG1′}” is the maximum value of a length in the tire radial direction from the tire surface profile to a groove bottom in a portion of the first inclined groove 130, which is located on the vehicle mounting inner side from the first circumferential main groove 110 as a starting point.

Regarding the shape of the first inclined groove 130, the “starting point” is a starting point at which the first inclined groove 130 starts from the first circumferential groove 110, and the “inner side starting point” is a starting point on the inner side in the tire width direction with respect to the first circumferential groove 110, that is, a starting point on the tire equatorial line CL side as viewed from the first circumferential groove 110. On the other hand, the “outer side starting point” is a starting point on the outer side in the tire width direction with respect to the first circumferential groove 110, that is, a starting point on the side opposite to the tire equatorial line CL side as viewed from the first circumferential groove 110. Similarly, regarding the shape of the second inclined groove 140, the “starting point” is a starting point at which the second inclined groove 140 starts from the second circumferential groove 120, and the “outer side starting point” is a starting point on the outer side in the tire width direction with respect to the second circumferential groove 120, that is, a starting point on the side opposite to the tire equatorial line CL side as viewed from the second circumferential groove 120. In addition, that the starting point is “recessed” means that the starting point of the inclined groove is located in a recessed portion of the circumferential main groove, and conversely, that the starting point is “projected” means that the starting point of the inclined groove is located in a projected portion of the circumferential main groove. Table 4 is similarly understood with reference to FIG. 2.

Note that the first inclined groove 130 (240 in FIG. 2) is a groove extending toward a respective vehicle mounting side from the circumferential main groove 110 (210 in FIG. 2), as a starting point, disposed on the vehicle mounting innermost side, of the plurality of circumferential main grooves. In addition, the second inclined groove 140 (250 in FIG. 2) is a groove extending toward the vehicle mounting outer side from the circumferential main groove 120 (230 in FIG. 2), as a starting point, disposed on the vehicle mounting outermost side, of the plurality of circumferential main grooves. The third inclined groove 150 (260 in FIG. 2) is a groove disposed such that both ends thereof terminate in the land portion adjacent on the vehicle mounting inner side to the first circumferential main groove 110 (210 in FIG. 2). Further, the fourth inclined groove 160 (270 in FIG. 2) is a groove disposed such that both ends thereof terminate in the land portion adjacent on the vehicle mounting outer side to the second circumferential main groove 120 (250 in FIG. 2). Furthermore, the fifth inclined groove 170 is disposed such that both ends thereof terminate in the land portion adjacent on the vehicle mounting outer side to the second circumferential main groove 120 disposed on the vehicle mounting outermost side, of the plurality of circumferential main grooves (two grooves in FIG. 1), and the fifth inclined groove 170 has a groove length shorter than that of the fourth inclined groove 160.

TABLE 5

| | | | | Inventive | Inventive |
|---|---|---|---|---|---|
| | | | Inventive | Example | Example |
| Example | | | Example 32 | 33 | 34 |
| Conditions | First | Presence | Yes | Yes | Yes |
| | inclined | Presence of terminating | No | Yes | Yes |
| | groove | end in land portion | | | |
| | | adjacent to | | | |
| | | circumferential main | | | |
| | | groove | | | |
| | | L_{IG1}/L_{IG2} | 1.0 | 1.0 | 1.0 |
| | | Inner side starting point | Projected | Projected | Projected |
| | | Outer side starting point | Recessed | Recessed | Recessed |
| | | L_{IG1}/L_{L} | 0.2 or less | 0.2 or less | 0.2 or less |
| | | Relationship between | d_{IG1′} = d_{IG1″} < | d_{IG1′} = d_{IG1″} < | d_{IG1′} = d_{IG1″} < |
| | | d_{IG1′}, d_{IG1″} and d_{G1} | d_{G1} | d_{G1} | d_{G1} |
| | | Orientation of acute | Oriented to | Oriented | Oriented |
| | | angle formed by | vehicle | to vehicle | to vehicle |
| | | inclined groove and tire | mounting | mounting | mounting |
| | | width direction | inner side | inner side | inner side |
| | Second | Presence | Yes | Yes | Yes |
| | inclined | Presence of terminating | No | No | Yes |
| | groove | end in land portion | | | |
| | | adjacent to | | | |
| | | circumferential main | | | |
| | | groove | | | |
| | | Outer side starting point | Recessed | Recessed | Recessed |
| | | Orientation of acute | Oriented to | Oriented | Oriented |
| | | angle formed by | vehicle | to vehicle | to vehicle |
| | | inclined groove and tire | mounting | mounting | mounting |
| | | width direction | inner side | inner side | inner side |
| | | L_{G2G4}/_{LG4G4} (terminating | — | — | — |
| | | between two fourth | | | |
| | | inclined grooves | | | |
| | | adjacent to each other in | | | |
| | | tire circumferential | | | |
| | | direction) | | | |
| | Third | Presence | No | No | No |
| | inclined | Whether straddling | — | — | — |
| | groove | ground contact edge | | | |
| | | Orientation of acute | — | — | — |
| | | angle formed by | | | |
| | | inclined groove and tire | | | |
| | | width direction | | | |
| | | Position of terminating | — | — | — |
| | | end portion on vehicle | | | |
| | | mounting outer side | | | |
| | | (whether terminating | | | |
| | | end portion reaches and | | | |
| | | terminates between end | | | |
| | | portions on vehicle | | | |
| | | mounting inner side of | | | |
| | | two adjacent first | | | |
| | | inclined grooves in tire | | | |
| | | circumferential | | | |
| | | direction) | | | |
| | Fourth | Presence | No | No | No |
| | inclined | Whether straddling | — | — | — |
| | groove | ground contact edge | | | |
| | | Orientation of acute | — | — | — |
| | | angle formed by | | | |
| | | inclined groove and tire | | | |
| | | width direction | | | |
| | | Position of terminating | — | — | — |
| | | end portion on vehicle | | | |
| | | mounting inner side | | | |
| | | (whether terminating | | | |
| | | end portion reaches and | | | |
| | | terminates between end | | | |
| | | portions on vehicle | | | |
| | | mounting outer side of | | | |
| | | two adjacent second | | | |
| | | inclined grooves in tire | | | |
| | | circumferential | | | |
| | | direction) | | | |
| | Fifth | Presence | No | No | No |
| | inclined | Whether straddling | — | — | — |
| | groove | ground contact edge | | | |
| | | Orientation of acute | Oriented to | Oriented | Oriented |
| | | angle formed by | vehicle | to vehicle | to vehicle |
| | | inclined groove and tire | mounting | mounting | mounting |
| | | width direction | inner side | inner side | inner side |
| | d_{IG1 to 4}/d_{G} | | — | — | — |
| | S_{SI}/S_{SO} | | 1.0 | 1.0 | 1.0 |
| | θ_{GI}/θ_{GO} | | 1.0 | 1.0 | 1.0 |
| Results | Dry steering stability | | 100 | 101 | 103 |
| | Wet steering stability | | 100 | 99 | 99 |
| | | | Inventive | Inventive | Inventive |
| | | | Example | Example | Example |
| Example | | | 35 | 36 | 37 |
| Conditions | First | Presence | Yes | Yes | Yes |
| | inclined | Presence of terminating | Yes | Yes | Yes |
| | groove | end in land portion | | | |
| | | adjacent to | | | |
| | | circumferential main | | | |
| | | groove | | | |
| | | L_{IG1}/L_{IG2} | 0.2 or | 0.2 or | 0.2 or |
| | | | more and | more and | more and |
| | | | 0.4 or less | 0.4 or less | 0.4 or less |
| | | Inner side starting point | Projected | Recessed | Recessed |
| | | Outer side starting point | Recessed | Projected | Projected |
| | | L_{IG1}/L_{L} | 0.2 or less | 0.2 or less | More than |
| | | | | | 0.2 and |
| | | | | | 0.6 or less |
| | | Relationship between | d_{IG1′} = d_{IG1″} < | d_{IG1′} = d_{IG1″} < | d_{IG1′} = d_{IG1″} < |
| | | d_{IG1′}, d_{IG1″} and d_{G1} | d_{G1} | d_{G1} | d_{G1} |
| | | Orientation of acute | Oriented | Oriented | Oriented |
| | | angle formed by inclined | to vehicle | to vehicle | to vehicle |
| | | groove and tire width | mounting | mounting | mounting |
| | | direction | inner side | inner side | inner side |
| | Second | Presence | Yes | Yes | Yes |
| | inclined | Presence of terminating | Yes | Yes | Yes |
| | groove | end in land portion | | | |
| | | adjacent to | | | |
| | | circumferential main | | | |
| | | groove | | | |
| | | Outer side starting point | Recessed | Recessed | Recessed |
| | | Orientation of acute | Oriented | Oriented | Oriented |
| | | angle formed by inclined | to vehicle | to vehicle | to vehicle |
| | | groove and tire width | mounting | mounting | mounting |
| | | direction | inner side | inner side | inner side |
| | | L_{G2G4}/_{LG4G4} (terminating | — | — | — |
| | | between two fourth | | | |
| | | inclined grooves | | | |
| | | adjacent to each other in | | | |
| | | tire circumferential | | | |
| | | direction) | | | |
| | Third | Presence | No | No | No |
| | inclined | Whether straddling | — | — | — |
| | groove | ground contact edge | | | |
| | | Orientation of acute | — | — | — |
| | | angle formed by inclined | | | |
| | | groove and tire width | | | |
| | | direction | | | |
| | | Position of terminating | — | — | — |
| | | end portion on vehicle | | | |
| | | mounting outer side | | | |
| | | (whether terminating end | | | |
| | | portion reaches and | | | |
| | | terminates between end | | | |
| | | portions on vehicle | | | |
| | | mounting inner side of | | | |
| | | two adjacent first | | | |
| | | inclined grooves in tire | | | |
| | | circumferential | | | |
| | | direction) | | | |
| | Fourth | Presence | No | No | No |
| | inclined | Whether straddling | — | — | — |
| | groove | ground contact edge | | | |
| | | Orientation of acute | — | — | — |
| | | angle formed by inclined | | | |
| | | groove and tire width | | | |
| | | direction | | | |
| | | Position of terminating | — | — | — |
| | | end portion on vehicle | | | |
| | | mounting inner side | | | |
| | | (whether terminating end | | | |
| | | portion reaches and | | | |
| | | terminates between end | | | |
| | | portions on vehicle | | | |
| | | mounting outer side of | | | |
| | | two adjacent second | | | |
| | | inclined grooves in tire | | | |
| | | circumferential | | | |
| | | direction) | | | |
| | Fifth | Presence | No | No | No |
| | inclined | Whether straddling | — | — | — |
| | groove | ground contact edge | | | |
| | | Orientation of acute | Oriented | Oriented | Oriented |
| | | angle formed by inclined | to vehicle | to vehicle | to vehicle |
| | | groove and tire width | mounting | mounting | mounting |
| | | direction | inner side | inner side | inner side |
| | d_{IG1 to 4}/d_{G} | | — | — | — |
| | S_{SI}/S_{SO} | | 1.0 | 1.0 | 1.0 |
| | θ_{GI}/θ_{GO} | | 1.0 | 1.0 | 1.0 |
| Results | Dry steering stability | | 105 | 106 | 104 |
| | Wet steering stability | | 99 | 100 | 100 |
| | | | Inventive | Inventive | Inventive |
| Example | | | Example 38 | Example 39 | Example 40 |
| Conditions | First | Presence | Yes | Yes | Yes |
| | inclined | Presence of | Yes | Yes | Yes |
| | groove | terminating | | | |
| | | end in land | | | |
| | | portion | | | |
| | | adjacent to | | | |
| | | circumferential | | | |
| | | main groove | | | |
| | | L_{IG1}/L_{IG2} | 0.2 or more | 0.2 or more | 0.2 or more and |
| | | | and 0.4 or less | and 0.4 or | 0.4 or less |
| | | | | less | |
| | | Inner side | Recessed | Recessed | Recessed |
| | | starting point | | | |
| | | Outer side | Projected | Projected | Projected |
| | | starting point | | | |
| | | L_{IG1}/L_{L} | More than 0.2 | More than | More than 0.2 |
| | | | and 0.6 or less | 0.2 and 0.6 | and 0.6 or less |
| | | | | or less | |
| | | Relationship | d_{IG1′} < d_{IG1″} < | d_{IG1′} < d_{IG1″} < | d_{IG1′} < d_{IG1″} < |
| | | between d_{IG1′}, | d_{G1} | d_{G1} | d_{G1} |
| | | d_{IG1″} and d_{G1} | | | |
| | | Orientation of | Oriented to | Oriented to | Oriented to |
| | | acute angle | vehicle | vehicle | vehicle |
| | | formed by | mounting inner | mounting | mounting inner |
| | | inclined | side | inner side | side |
| | | groove and tire | | | |
| | | width direction | | | |
| | Second | Presence | Yes | Yes | Yes |
| | inclined | Presence of | Yes | Yes | Yes |
| | groove | terminating | | | |
| | | end in land | | | |
| | | portion | | | |
| | | adjacent to | | | |
| | | circumferential | | | |
| | | main groove | | | |
| | | Outer side | Recessed | Projected | Projected |
| | | starting point | | | |
| | | Orientation of | Oriented to | Oriented to | Oriented to |
| | | acute angle | vehicle | vehicle | vehicle |
| | | formed by | mounting inner | mounting | mounting inner |
| | | inclined | side | inner side | side |
| | | groove and tire | | | |
| | | width direction | | | |
| | | L_{G2G4}/_{LG4G4} | — | — | L_{G2G4}/_{LG4G4} < 0.40 |
| | | (terminating | | | |
| | | between two | | | |
| | | fourth inclined | | | |
| | | grooves | | | |
| | | adjacent to | | | |
| | | each other in | | | |
| | | tire | | | |
| | | circumferential | | | |
| | | direction) | | | |
| | Third | Presence | No | No | Yes |
| | inclined | Whether | — | — | Straddling |
| | groove | straddling | | | |
| | | ground contact | | | |
| | | edge | | | |
| | | Orientation of | — | — | Oriented to |
| | | acute angle | | | vehicle |
| | | formed by | | | mounting inner |
| | | inclined | | | side |
| | | groove and tire | | | |
| | | width direction | | | |
| | | Position of | — | — | Terminating |
| | | terminating | | | without reaching |
| | | end portion on | | | |
| | | vehicle | | | |
| | | mounting outer | | | |
| | | side (whether | | | |
| | | terminating | | | |
| | | end portion | | | |
| | | reaches and | | | |
| | | terminates | | | |
| | | between end | | | |
| | | portions on | | | |
| | | vehicle | | | |
| | | mounting inner | | | |
| | | side oftwo | | | |
| | | adjacent first | | | |
| | | inclined | | | |
| | | grooves in tire | | | |
| | | circumferential | | | |
| | | direction) | | | |
| | Fourth | Presence | No | No | Yes |
| | inclined | Whether | — | — | Straddling |
| | groove | straddling | | | |
| | | ground contact | | | |
| | | edge | | | |
| | | Orientation of | — | — | Oriented to |
| | | acute angle | | | vehicle |
| | | formed by | | | mounting inner |
| | | inclined | | | side |
| | | groove and tire | | | |
| | | width direction | | | |
| | | Position of | — | — | Terminating |
| | | terminating | | | without reaching |
| | | end portion on | | | |
| | | vehicle | | | |
| | | mounting inner | | | |
| | | side (whether | | | |
| | | terminating | | | |
| | | end portion | | | |
| | | reaches and | | | |
| | | terminates | | | |
| | | between end | | | |
| | | portions on | | | |
| | | vehicle | | | |
| | | mounting outer | | | |
| | | side oftwo | | | |
| | | adjacent | | | |
| | | second | | | |
| | | inclined | | | |
| | | grooves in tire | | | |
| | | circumferential | | | |
| | | direction) | | | |
| | Fifth | Presence | No | No | No |
| | inclined | Whether | — | — | — |
| | groove | straddling | | | |
| | | ground contact | | | |
| | | edge | | | |
| | | Orientation of | Oriented to | Oriented to | Oriented to |
| | | acute angle | vehicle | vehicle | vehicle |
| | | formed by | mounting inner | mounting | mounting inner |
| | | inclined | side | inner side | side |
| | | groove and tire | | | |
| | | width direction | | | |
| | d_{IG1 to 4}/d_{G} | | — | — | 0.05 |
| | S_{SI}/S_{SO} | | 1.0 | 1.0 | 1.0 |
| | θ_{GI}/θ_{GO} | | 1.0 | 1.0 | 1.0 |
| Results | Dry steering stability | | 106 | 107 | 97 |
| | Wet steering stability | | 98 | 101 | 111 |
| | | | Inventive | Inventive | Inventive |
| Example | | | Example 41 | Example 42 | Example 43 |
| Conditions | First | Presence | Yes | Yes | Yes |
| | inclined | Presence of | Yes | Yes | Yes |
| | groove | terminating | | | |
| | | end in land | | | |
| | | portion | | | |
| | | adjacent to | | | |
| | | circumferential | | | |
| | | main groove | | | |
| | | L_{IG1}/L_{IG2} | 0.2 or more and | 0.2 or more and | 0.2 or more and |
| | | | 0.4 or less | 0.4 or less | 0.4 or less |
| | | Inner side | Recessed | Recessed | Recessed |
| | | starting point | | | |
| | | Outer side | Projected | Projected | Projected |
| | | starting point | | | |
| | | L_{IG1}/L_{L} | More than 0.2 | More than 0.2 | More than 0.2 |
| | | | and 0.6 or less | and 0.6 or less | and 0.6 or less |
| | | Relationship | d_{IG1′} < d_{IG1″} < d_{G1} | d_{IG1′} < d_{IG1″} < d_{G1} | d_{IG1′} < d_{IG1″} < d_{G1} |
| | | between d_{IG1′}, | | | |
| | | d_{IG1″} and d_{G1} | | | |
| | | Orientation of | Oriented to | Oriented to | Oriented to |
| | | acute angle | vehicle | vehicle | vehicle |
| | | formed by | mounting inner | mounting inner | mounting inner |
| | | inclined | side | side | side |
| | | groove and tire | | | |
| | | width direction | | | |
| | Second | Presence | Yes | Yes | Yes |
| | inclined | Presence of | Yes | Yes | Yes |
| | groove | terminating | | | |
| | | end in land | | | |
| | | portion | | | |
| | | adjacent to | | | |
| | | circumferential | | | |
| | | main groove | | | |
| | | Outer side | Projected | Projected | Projected |
| | | starting point | | | |
| | | Orientation of | Oriented to | Oriented to | Oriented to |
| | | acute angle | vehicle | vehicle | vehicle |
| | | formed by | mounting inner | mounting inner | mounting inner |
| | | inclined | side | side | side |
| | | groove and tire | | | |
| | | width direction | | | |
| | | L_{G2G4}/_{LG4G4} | L_{G2G4}/_{LG4G4} < | L_{G2G4}/_{LG4G4} < | L_{G2G4}/_{LG4G4} < |
| | | (terminating | 0.40 | 0.40 | 0.40 |
| | | between two | | | |
| | | fourth inclined | | | |
| | | grooves | | | |
| | | adjacent to | | | |
| | | each other in | | | |
| | | tire | | | |
| | | circumferential | | | |
| | | direction) | | | |
| | Third | Presence | Yes | Yes | Yes |
| | inclined | Whether | Straddling | Straddling | Straddling |
| | groove | straddling | | | |
| | | ground contact | | | |
| | | edge | | | |
| | | Orientation of | Oriented to | Oriented to | Oriented to |
| | | acute angle | vehicle | vehicle | vehicle |
| | | formed by | mounting inner | mounting inner | mounting inner |
| | | inclined | side | side | side |
| | | groove and tire | | | |
| | | width direction | | | |
| | | Position of | Terminating | Terminating | Terminating |
| | | terminating | without reaching | without reaching | without reaching |
| | | end portion on | | | |
| | | vehicle | | | |
| | | mounting outer | | | |
| | | side (whether | | | |
| | | terminating | | | |
| | | end portion | | | |
| | | reaches and | | | |
| | | terminates | | | |
| | | between end | | | |
| | | portions on | | | |
| | | vehicle | | | |
| | | mounting inner | | | |
| | | side oftwo | | | |
| | | adjacent first | | | |
| | | inclined | | | |
| | | grooves in tire | | | |
| | | circumferential | | | |
| | | direction) | | | |
| | Fourth | Presence | Yes | Yes | Yes |
| | inclined | Whether | Straddling | Straddling | Straddling |
| | groove | straddling | | | |
| | | ground contact | | | |
| | | edge | | | |
| | | Orientation of | Oriented to | Oriented to | Oriented to |
| | | acute angle | vehicle | vehicle | vehicle |
| | | formed by | mounting inner | mounting inner | mounting inner |
| | | inclined | side | side | side |
| | | groove and tire | | | |
| | | width direction | | | |
| | | Position of | Terminating | Terminating | Terminating |
| | | terminating | without reaching | without reaching | without reaching |
| | | end portion on | | | |
| | | vehicle | | | |
| | | mounting inner | | | |
| | | side (whether | | | |
| | | terminating | | | |
| | | end portion | | | |
| | | reaches and | | | |
| | | terminates | | | |
| | | between end | | | |
| | | portions on | | | |
| | | vehicle | | | |
| | | mounting outer | | | |
| | | side of two | | | |
| | | adjacent | | | |
| | | second | | | |
| | | inclined | | | |
| | | grooves in tire | | | |
| | | circumferential | | | |
| | | direction) | | | |
| | Fifth | Presence | Yes | Yes | Yes |
| | inclined | Whether | Straddling | Not straddling | Not straddling |
| | groove | straddling | | | |
| | | ground contact | | | |
| | | edge | | | |
| | | Orientation of | Oriented to | Oriented to | Oriented to |
| | | acute angle | vehicle | vehicle | vehicle |
| | | formed by | mounting inner | mounting inner | mounting outer |
| | | inclined | side | side | side |
| | | groove and tire | | | |
| | | width direction | | | |
| | d_{IG1 to 4}/d_{G} | | 0.05 | 0.05 | 0.05 |
| | S_{SI}/S_{SO} | | 1.0 | 1.0 | 1.0 |
| | θ_{GI}/θ_{GO} | | 1.0 | 1.0 | 1.0 |
| Results | Dry steering stability | | 97 | 98 | 98 |
| | Wet steering stability | | 112 | 111 | 112 |
| | | | Inventive | Inventive | Inventive |
| Example | | | Example 44 | Example 45 | Example 46 |
| Conditions | First | Presence | Yes | Yes | Yes |
| | inclined | Presence of | Yes | Yes | Yes |
| | groove | terminating end in | | | |
| | | land portion adjacent | | | |
| | | to circumferential | | | |
| | | main groove | | | |
| | | L_{IG1}/L_{IG2} | 0.2 or more and | 0.2 or more | 0.2 or more |
| | | | 0.4 or less | and 0.4 or | and 0.4 or |
| | | | | less | less |
| | | Inner side starting | Recessed | Recessed | Recessed |
| | | point | | | |
| | | Outer side starting | Projected | Projected | Projected |
| | | point | | | |
| | | L_{IG1}/L_{L} | More than 0.2 | More than | More than |
| | | | and 0.6 or less | 0.2 and 0.6 | 0.2 and 0.6 |
| | | | | or less | or less |
| | | Relationship between | d_{IG1′} < d_{IG1″} < d_{G1} | d_{IG1′} < d_{IG1″} < d_{G1} | d_{IG1′} < d_{IG1″} < d_{G1} |
| | | d_{IG1′}, d_{IG1″} and d_{G1} | | | |
| | | Orientation of acute | Oriented to | Oriented to | Oriented to |
| | | angle formed by | vehicle | vehicle | vehicle |
| | | inclined groove and | mounting inner | mounting | mounting |
| | | tire width direction | side | inner side | inner side |
| | Second | Presence | Yes | Yes | Yes |
| | inclined | Presence of | Yes | Yes | Yes |
| | groove | terminating end in | | | |
| | | land portion adjacent | | | |
| | | to circumferential | | | |
| | | main groove | | | |
| | | Outer side starting | Projected | Projected | Projected |
| | | point | | | |
| | | Orientation of acute | Oriented to | Oriented to | Oriented to |
| | | angle formed by | vehicle | vehicle | vehicle |
| | | inclined groove and | mounting inner | mounting | mounting |
| | | tire width direction | side | inner side | inner side |
| | | L_{G2G4}/_{LG4G4} | L_{G2G4}/_{LG4G4} < 0.40 | 0.40 < | 0.40 < |
| | | (terminating between | | L_{G2G4}/_{LG4G4} < | L_{G2G4}/_{LG4G4} < |
| | | two fourth inclined | | 0.60 | 0.60 |
| | | grooves adjacent to | | | |
| | | each other in tire | | | |
| | | circumferential | | | |
| | | direction) | | | |
| | Third | Presence | Yes | Yes | Yes |
| | inclined | Whether straddling | Straddling | Straddling | Straddling |
| | groove | ground contact edge | | | |
| | | Orientation of acute | Oriented to | Oriented to | Oriented to |
| | | angle formed by | vehicle | vehicle | vehicle |
| | | inclined groove and | mounting inner | mounting | mounting |
| | | tire width direction | side | inner side | inner side |
| | | Position of | Reaching and | Reaching | Reaching |
| | | terminating end | terminating | and | and |
| | | portion on vehicle | | terminating | terminating |
| | | mounting outer side | | | |
| | | (whether terminating | | | |
| | | end portion reaches | | | |
| | | and terminates | | | |
| | | between end portions | | | |
| | | on vehicle mounting | | | |
| | | inner side of two | | | |
| | | adjacent first inclined | | | |
| | | grooves in tire | | | |
| | | circumferential | | | |
| | | direction) | | | |
| | Fourth | Presence | Yes | Yes | Yes |
| | inclined | Whether straddling | Straddling | Straddling | Straddling |
| | groove | ground contact edge | | | |
| | | Orientation of acute | Oriented to | Oriented to | Oriented to |
| | | angle formed by | vehicle | vehicle | vehicle |
| | | inclined groove and | mounting inner | mounting | mounting |
| | | tire width direction | side | inner side | inner side |
| | | Position of | Reaching and | Reaching | Reaching |
| | | terminating end | terminating | and | and |
| | | portion on vehicle | | terminating | terminating |
| | | mounting inner side | | | |
| | | (whether terminating | | | |
| | | end portion reaches | | | |
| | | and terminates | | | |
| | | between end portions | | | |
| | | on vehicle mounting | | | |
| | | outer side of two | | | |
| | | adjacent second | | | |
| | | inclined grooves in | | | |
| | | tire circumferential | | | |
| | | direction) | | | |
| | Fifth | Presence | Yes | Yes | Yes |
| | inclined | Whether straddling | Not straddling | Not | Not |
| | groove | ground contact edge | | straddling | straddling |
| | | Orientation of acute | Oriented to | Oriented to | Oriented to |
| | | angle formed by | vehicle | vehicle | vehicle |
| | | inclined groove and | mounting outer | mounting | mounting |
| | | tire width direction | side | outer side | outer side |

| | | | | |
|---|---|---|---|---|
| | d_{IG1 to 4}/d_{G} | 0.05 | 0.05 | More than |
| | | | | 0.05 and |
| | | | | less |
| | | | | than 0.85 |
| | S_{SI}/S_{SO} | 1.0 | 1.0 | 1.0 |
| | θ_{GI}/θ_{GO} | 1.0 | 1.0 | 1.0 |
| Results | Dry steering stability | 97 | 98 | 99 |
| | Wet steering stability | 113 | 113 | 113 |

| | | | Inventive | Inventive |
|---|---|---|---|---|
| Example | | | Example 47 | Example 48 |
| Conditions | First | Presence | Yes | Yes |
| | inclined | Presence of terminating end in | Yes | Yes |
| | groove | land portion adjacent to | | |
| | | circumferential main groove | | |
| | | L_{IG1}/L_{IG2} | 0.2 or more | 0.2 or more |
| | | | and 0.4 or less | and 0.4 or less |
| | | Inner side starting point | Recessed | Recessed |
| | | Outer side starting point | Projected | Projected |
| | | L_{IG1}/L_{L} | More than 0.2 | More than 0.2 |
| | | | and 0.6 or less | and 0.6 or less |
| | | Relationship between | d_{IG1′} < d_{IG1″} < d_{G1} | d_{IG1′} < d_{IG1″} < d_{G1} |
| | | d_{IG1′}, d_{IG1″} and d_{G1} | | |
| | | Orientation of acute angle formed | Oriented to | Oriented to |
| | | by inclined groove and tire width | vehicle | vehicle |
| | | direction | mounting inner | mounting |
| | | | side | inner side |
| | Second | Presence | Yes | Yes |
| | inclined | Presence of terminating end in | Yes | Yes |
| | groove | land portion adjacent to | | |
| | | circumferential main groove | | |
| | | Outer side starting point | Projected | Projected |
| | | Orientation of acute angle formed | Oriented to | Oriented to |
| | | by inclined groove and tire width | vehicle | vehicle |
| | | direction | mounting inner | mounting |
| | | | side | inner side |
| | | L_{G2G4}/_{LG4G4} (terminating between | 0.40 < | 0.40 < |
| | | two fourth inclined grooves | L_{G2G4}/_{LG4G4} < | L_{G2G4}/_{LG4G4} < |
| | | adjacent to each other in tire | 0.60 | 0.60 |
| | | circumferential direction) | | |
| | | Presence | Yes | Yes |
| | Third | Whether straddling ground | Straddling | Straddling |
| | inclined | contact edge | | |
| | groove | Orientation of acute angle formed | Oriented to | Oriented to |
| | | by inclined groove and tire width | vehicle | vehicle |
| | | direction | mounting inner | mounting |
| | | | side | inner side |
| | | Position of terminating end | Reaching and | Reaching and |
| | | portion on vehicle mounting | terminating | terminating |
| | | outer side (whether terminating | | |
| | | end portion reaches and | | |
| | | terminates between end portions | | |
| | | on vehicle mounting inner side of | | |
| | | two adjacent first inclined | | |
| | | grooves in tire circumferential | | |
| | | direction) | | |
| | Fourth | Presence | Yes | Yes |
| | inclined | Whether straddling ground | Straddling | Straddling |
| | groove | contact edge | | |
| | | Orientation of acute angle formed | Oriented to | Oriented to |
| | | by inclined groove and tire width | vehicle | vehicle |
| | | direction | mounting inner | mounting |
| | | | side | inner side |
| | | Position of terminating end | Reaching and | Reaching and |
| | | portion on vehicle mounting | terminating | terminating |
| | | inner side (whether terminating | | |
| | | end portion reaches and | | |
| | | terminates between end portions | | |
| | | on vehicle mounting outer side of | | |
| | | two adjacent second inclined | | |
| | | grooves in tire circumferential | | |
| | | direction) | | |
| | Fifth | Presence | Yes | Yes |
| | inclined | Whether straddling ground | Not straddling | Not straddling |
| | groove | contact edge | | |
| | | Orientation of acute angle formed | Oriented to | Oriented to |
| | | by inclined groove and tire width | vehicle | vehicle |
| | | direction | mounting outer | mounting |
| | | | side | outer side |

| | | | |
|---|---|---|---|
| | d_{IG1 to 4}/d_{G} | More than 0.05 | More than |
| | | and less | 0.05 and less |
| | | than 0.85 | than 0.85 |
| | S_{SI}/S_{SO} | 1.3 | 1.3 |
| | θ_{GI}/θ_{GO} | 1.0 | 3.5 |
| Results | Dry steering stability | 100 | 101 |
| | Wet steering stability | 114 | 113 |

TABLE 6

| | | | Inventive | Inventive | Inventive |
|---|---|---|---|---|---|
| | | | Example | Example | Example |
| Example | | | 49 | 50 | 51 |
| Conditions | First | Presence | Yes | Yes | Yes |
| | inclined | Presence of terminating | No | Yes | Yes |
| | groove | end in land portion | | | |
| | | adjacent to circumferential | | | |
| | | main groove | | | |
| | | L_{IG1}/L_{IG2} | 1.0 | 1.0 | 1.0 |
| | | Inner side starting point | Projected | Projected | Projected |
| | | Outer side starting point | Recessed | Recessed | Recessed |
| | | L_{IG1}/L_{L} | 0.2 or less | 0.2 or less | 0.2 or less |
| | | Relationship between | d_{IG1′} = | d_{IG1′} = | d_{IG1′} = |
| | | d_{IG1′}, d_{IG1″} and d_{G1} | d_{IG1″} < d_{G1} | d_{IG1″} < d_{G1} | d_{IG1″} < d_{G1} |
| | | Orientation of acute angle | Oriented | Oriented | Oriented |
| | | formed by inclined groove | to vehicle | to vehicle | to vehicle |
| | | and tire width direction | mounting | mounting | mounting |
| | | | inner side | inner side | inner side |
| | Second | Presence | Yes | Yes | Yes |
| | inclined | Presence of terminating | No | No | Yes |
| | groove | end in land portion | | | |
| | | adjacent to circumferential | | | |
| | | main groove | | | |
| | | Outer side starting point | Recessed | Recessed | Recessed |
| | | Orientation of acute angle | Oriented | Oriented | Oriented |
| | | formed by inclined groove | to vehicle | to vehicle | to vehicle |
| | | and tire width direction | mounting | mounting | mounting |
| | | | inner side | inner side | inner side |
| | | L_{G2G4}/_{LG4G4} (terminating | — | — | — |
| | | between two fourth | | | |
| | | inclined grooves adjacent | | | |
| | | to each other in tire | | | |
| | | circumferential direction) | | | |
| | Third | Presence | No | No | No |
| | inclined | Orientation of acute angle | — | — | — |
| | groove | formed by inclined groove | | | |
| | | and tire width direction | | | |
| | | Position of terminating end | — | — | — |
| | | portion on vehicle | | | |
| | | mounting outer side | | | |
| | | (whether terminating end | | | |
| | | portion reaches and | | | |
| | | terminates between end | | | |
| | | portions on vehicle | | | |
| | | mounting inner side of two | | | |
| | | adjacent first inclined | | | |
| | | grooves in tire | | | |
| | | circumferential direction) | | | |
| | Fourth | Presence | No | No | No |
| | inclined | Orientation of acute angle | — | — | — |
| | groove | formed by inclined groove | | | |
| | | and tire width direction | | | |
| | | Position of terminating end | — | — | — |
| | | portion on vehicle | | | |
| | | mounting inner side | | | |
| | | (whether terminating end | | | |
| | | portion reaches and | | | |
| | | terminates between end | | | |
| | | portions on vehicle | | | |
| | | mounting outer side of two | | | |
| | | adjacent second inclined | | | |
| | | grooves in tire | | | |
| | | circumferential direction) | | | |
| | d_{IG1 to 4}/d_{G} | | — | — | — |
| | S_{SI}/S_{SO} | | 1.0 | 1.0 | 1.0 |
| | θ_{GI}/θ_{GO} | | 1.0 | 1.0 | 1.0 |
| Results | Dry steering stability | | 100 | 101 | 103 |
| | Wet steering stability | | 100 | 99 | 99 |
| | | | Inventive | Inventive | Inventive |
| | | | Example | Example | Example |
| Example | | | 52 | 53 | 54 |
| Conditions | First | Presence | Yes | Yes | Yes |
| | inclined | Presence of terminating | Yes | Yes | Yes |
| | groove | end in land portion | | | |
| | | adjacent to circumferential | | | |
| | | main groove | | | |
| | | L_{IG1}/L_{IG2} | 0.2 or | 0.2 or | 0.2 or |
| | | | more and | more and | more and |
| | | | 0.4 or less | 0.4 or less | 0.4 or less |
| | | Inner side starting point | Projected | Recessed | Recessed |
| | | Outer side starting point | Recessed | Projected | Projected |
| | | L_{IG1}/L_{L} | 0.2 or less | 0.2 or less | More than |
| | | | | | 0.2 and |
| | | | | | less than |
| | | | | | 0.6 |
| | | Relationship between | d_{IG1′} = | d_{IG1′} = | d_{IG1′} = |
| | | d_{IG1′}, d_{IG1″} and d_{G1} | d_{IG1″} < d_{G1} | d_{IG1″} < d_{G1} | d_{IG1″} < d_{G1} |
| | | Orientation of acute angle | Oriented | Oriented | Oriented |
| | | formed by inclined groove | to vehicle | to vehicle | to vehicle |
| | | and tire width direction | mounting | mounting | mounting |
| | | | inner side | inner side | inner side |
| | Second | Presence | Yes | Yes | Yes |
| | inclined | Presence of terminating | Yes | Yes | Yes |
| | groove | end in land portion | | | |
| | | adjacent to circumferential | | | |
| | | main groove | | | |
| | | Outer side starting point | Recessed | Recessed | Recessed |
| | | Orientation of acute angle | Oriented | Oriented | Oriented |
| | | formed by inclined groove | to vehicle | to vehicle | to vehicle |
| | | and tire width direction | mounting | mounting | mounting |
| | | | inner side | inner side | inner side |
| | | L_{G2G4}/_{LG4G4} (terminating | — | — | — |
| | | between two fourth | | | |
| | | inclined grooves adjacent | | | |
| | | to each other in tire | | | |
| | | circumferential direction) | | | |
| | Third | Presence | No | No | No |
| | inclined | Orientation of acute angle | — | — | — |
| | groove | formed by inclined groove | | | |
| | | and tire width direction | | | |
| | | Position of terminating end | — | — | — |
| | | portion on vehicle | | | |
| | | mounting outer side | | | |
| | | (whether terminating end | | | |
| | | portion reaches and | | | |
| | | terminates between end | | | |
| | | portions on vehicle | | | |
| | | mounting inner side of two | | | |
| | | adjacent first inclined | | | |
| | | grooves in tire | | | |
| | | circumferential direction) | | | |
| | Fourth | Presence | No | No | No |
| | inclined | Orientation of acute angle | — | — | — |
| | groove | formed by inclined groove | | | |
| | | and tire width direction | | | |
| | | Position of terminating end | — | — | — |
| | | portion on vehicle | | | |
| | | mounting inner side | | | |
| | | (whether terminating end | | | |
| | | portion reaches and | | | |
| | | terminates between end | | | |
| | | portions on vehicle | | | |
| | | mounting outer side of two | | | |
| | | adjacent second inclined | | | |
| | | grooves in tire | | | |
| | | circumferential direction) | | | |

| | | | | |
|---|---|---|---|---|
| | d_{IG1 to 4}/d_{G} | — | — | — |
| | S_{SI}/S_{SO} | 1.0 | 1.0 | 1.0 |
| | θ_{GI}/θ_{GO} | 1.0 | 1.0 | 1.0 |
| Results | Dry steering stability | 105 | 106 | 104 |
| | Wet steering stability | 99 | 100 | 100 |

| | | | Inventive | Inventive |
|---|---|---|---|---|
| Example | | | Example 55 | Example 56 |
| Conditions | First | Presence | Yes | Yes |
| | inclined | Presence of terminating end in land | Yes | Yes |
| | groove | portion adjacent to circumferential | | |
| | | main groove | | |
| | | L_{IG1}/L_{IG2} | 0.2 or more | 0.2 or more |
| | | | and 0.4 or | and 0.4 or |
| | | | less | less |
| | | Inner side starting point | Recessed | Recessed |
| | | Outer side starting point | Projected | Projected |
| | | L_{IG1}/L_{L} | More than | More than |
| | | | 0.2 and less | 0.2 and less |
| | | | than 0.6 | than 0.6 |
| | | Relationship between | d_{IG1′} < | d_{IG1′} < |
| | | d_{IG1′}, d_{IG1″} and d_{G1} | d_{IG1″} < d_{G1} | d_{IG1″} < d_{G1} |
| | | Orientation of acute angle formed | Oriented to | Oriented to |
| | | by inclined groove and tire width | vehicle | vehicle |
| | | direction | mounting | mounting |
| | | | inner side | inner side |
| | Second | Presence | Yes | Yes |
| | inclined | Presence of terminating end in land | Yes | Yes |
| | groove | portion adjacent to circumferential | | |
| | | main groove | | |
| | | Outer side starting point | Recessed | Projected |
| | | Orientation of acute angle formed | Oriented to | Oriented to |
| | | by inclined groove and tire width | vehicle | vehicle |
| | | direction | mounting | mounting |
| | | | inner side | inner side |
| | | L_{G2G4}/_{LG4G4} (terminating between | — | — |
| | | two fourth inclined grooves | | |
| | | adjacent to each other in tire | | |
| | | circumferential direction) | | |
| | Third | Presence | No | No |
| | inclined | Orientation of acute angle formed | — | — |
| | groove | by inclined groove and tire width | | |
| | | direction | | |
| | | Position of terminating end portion | — | — |
| | | on vehicle mounting outer side | | |
| | | (whether terminating end portion | | |
| | | reaches and terminates between | | |
| | | end portions on vehicle mounting | | |
| | | inner side of two adjacent first | | |
| | | inclined grooves in tire | | |
| | | circumferential direction) | | |
| | Fourth | Presence | No | No |
| | inclined | Orientation of acute angle formed | — | — |
| | groove | by inclined groove and tire width | | |
| | | direction | | |
| | | Position of terminating end portion | — | — |
| | | on vehicle mounting inner side | | |
| | | (whether terminating end portion | | |
| | | reaches and terminates between | | |
| | | end portions on vehicle mounting | | |
| | | outer side of two adjacent second | | |
| | | inclined grooves in tire | | |
| | | circumferential direction) | | |
| | d_{IG1 to 4}/d_{G} | | — | — |
| | S_{SI}/S_{SO} | | 1.0 | 1.0 |
| | θ_{GI}/θ_{GO} | | 1.0 | 1.0 |
| Results | Dry steering stability | | 106 | 107 |
| | Wet steering stability | | 98 | 101 |
| | | | Inventive | Inventive |
| Example | | | Example 57 | Example 58 |
| Conditions | First | Presence | Yes | Yes |
| | inclined | Presence of terminating end | Yes | Yes |
| | groove | in land portion adjacent to | | |
| | | circumferential main groove | | |
| | | L_{IG1}/L_{IG2} | 0.2 or more | 0.2 or more |
| | | | and 0.4 or | and 0.4 or |
| | | | less | less |
| | | Inner side starting point | Recessed | Recessed |
| | | Outer side starting point | Projected | Projected |
| | | L_{IG1}/L_{L} | More than | More than |
| | | | 0.2 and less | 0.2 and less |
| | | | than 0.6 | than 0.6 |
| | | Relationship between | d_{IG1′} < | d_{IG1′} < |
| | | d_{IG1′}, d_{IG1″} and d_{G1} | d_{IG1″} < d_{G1} | d_{IG1″} < d_{G1} |
| | | Orientation of acute angle | Oriented to | Oriented to |
| | | formed by inclined groove | vehicle | vehicle |
| | | and tire width direction | mounting | mounting |
| | | | inner side | inner side |
| | Second | Presence | Yes | Yes |
| | inclined | Presence of terminating end | Yes | Yes |
| | groove | in land portion adjacent to | | |
| | | circumferential main groove | | |
| | | Outer side starting point | Projected | Projected |
| | | Orientation of acute angle | Oriented to | Oriented to |
| | | formed by inclined groove | vehicle | vehicle |
| | | and tire width direction | mounting | mounting |
| | | | inner side | inner side |
| | | L_{G2G4}/_{LG4G4} (terminating | L_{G2G4}/_{LG4G4} < | L_{G2G4}/_{LG4G4} < |
| | | between two fourth inclined | 0.40 | 0.40 |
| | | grooves adjacent to each | | |
| | | other in tire circumferential | | |
| | | direction) | | |
| | Third | Presence | Yes | Yes |
| | inclined | Orientation of acute angle | Oriented to | Oriented to |
| | groove | formed by inclined groove | vehicle | vehicle |
| | | and tire width direction | mounting | mounting |
| | | | inner side | outer side |
| | | Position of terminating end | Terminating | Terminating |
| | | portion on vehicle mounting | without | without |
| | | outer side (whether | reaching | reaching |
| | | terminating end portion | | |
| | | reaches and terminates | | |
| | | between end portions on | | |
| | | vehicle mounting inner side | | |
| | | of two adjacent first | | |
| | | inclined grooves in tire | | |
| | | circumferential direction) | | |
| | Fourth | Presence | Yes | Yes |
| | inclined | Orientation of acute angle | Oriented to | Oriented to |
| | groove | formed by inclined groove | vehicle | vehicle |
| | | and tire width direction | mounting | mounting |
| | | | inner side | inner side |
| | | Position of terminating end | Terminating | Terminating |
| | | portion on vehicle mounting | without | without |
| | | inner side (whether | reaching | reaching |
| | | terminating end portion | | |
| | | reaches and terminates | | |
| | | between end portions on | | |
| | | vehicle mounting outer side | | |
| | | of two adjacent second | | |
| | | inclined grooves in tire | | |
| | | circumferential direction) | | |
| | d_{IG1 to 4}/d_{G} | | 0.05 | 0.05 |
| | S_{SI}/S_{SO} | | 1.0 | 1.0 |
| | θ_{GI}/θ_{GO} | | 1.0 | 1.0 |
| Results | Dry steering stability | | 97 | 97 |
| | Wet steering stability | | 111 | 112 |
| | | | Inventive | Inventive |
| Example | | | Example 59 | Example 60 |
| Conditions | First | Presence | Yes | Yes |
| | inclined | Presence of terminating | Yes | Yes |
| | groove | end in land portion | | |
| | | adjacent to | | |
| | | circumferential main | | |
| | | groove | | |
| | | L_{IG1}/L_{IG2} | 0.2 or more | 0.2 or more |
| | | | and 0.4 or | and 0.4 or |
| | | | less | less |
| | | Inner side starting point | Recessed | Recessed |
| | | Outer side starting point | Projected | Projected |
| | | L_{IG1}/L_{L} | More than | More than |
| | | | 0.2 and less | 0.2 and less |
| | | | than 0.6 | than 0.6 |
| | | Relationship between | d_{IG1′} < | d_{IG1′} < |
| | | d_{IG1′}, d_{IG1″} and d_{G1} | d_{IG1″} < d_{G1} | d_{IG1″} < d_{G1} |
| | | Orientation of acute angle | Oriented to | Oriented to |
| | | formed by inclined groove | vehicle | vehicle |
| | | and tire width direction | mounting | mounting |
| | | | inner side | inner side |
| | Second | Presence | Yes | Yes |
| | inclined | Presence of terminating | Yes | Yes |
| | groove | end in land portion | | |
| | | adjacent to | | |
| | | circumferential main | | |
| | | groove | | |
| | | Outer side starting point | Projected | Projected |
| | | Orientation of acute angle | Oriented to | Oriented to |
| | | formed by inclined groove | vehicle | vehicle |
| | | and tire width direction | mounting | mounting |
| | | | inner side | inner side |
| | | L_{G2G4}/_{LG4G4} (terminating | L_{G2G4}/_{LG4G4} < | 0.40 < |
| | | between two fourth | 0.40 | L_{G2G4}/_{LG4G4} < |
| | | inclined grooves adjacent | | 0.60 |
| | | to each other in tire | | |
| | | circumferential direction) | | |
| | Third | Presence | Yes | Yes |
| | inclined | Orientation of acute angle | Oriented to | Oriented to |
| | groove | formed by inclined groove | vehicle | vehicle |
| | | and tire width direction | mounting | mounting |
| | | | outer side | outer side |
| | | Position of terminating | Reaching and | Reaching |
| | | end portion on vehicle | terminating | and |
| | | mounting outer side | | terminating |
| | | (whether terminating end | | |
| | | portion reaches and | | |
| | | terminates between end | | |
| | | portions on vehicle | | |
| | | mounting inner side of | | |
| | | two adjacent first inclined | | |
| | | grooves in tire | | |
| | | circumferential direction) | | |
| | Fourth | Presence | Yes | Yes |
| | inclined | Orientation of acute angle | Oriented to | Oriented to |
| | groove | formed by inclined groove | vehicle | vehicle |
| | | and tire width direction | mounting | mounting |
| | | | inner side | inner side |
| | | Position of terminating | Reaching and | Reaching |
| | | end portion on vehicle | terminating | and |
| | | mounting inner side | | terminating |
| | | (whether terminating end | | |
| | | portion reaches and | | |
| | | terminates between end | | |
| | | portions on vehicle | | |
| | | mounting outer side of | | |
| | | two adjacent second | | |
| | | inclined grooves in tire | | |
| | | circumferential direction) | | |
| | d_{IG1 to 4}/d_{G} | | 0.05 | 0.05 |
| | S_{SI}/S_{SO} | | 1.0 | 1.0 |
| | θ_{GI}/θ_{GO} | | 1.0 | 1.0 |
| Results | Dry steering stability | | 96 | 97 |
| | Wet steering stability | | 113 | 113 |
| | | | Inventive | Inventive |
| | | | Example | Example |
| Example | | | 61 | 62 |
| Conditions | First | Presence | Yes | Yes |
| | inclined | Presence of terminating end in | Yes | Yes |
| | groove | land portion adjacent to | | |
| | | circumferential main groove | | |
| | | L_{IG1}/L_{IG2} | 0.2 or | 0.2 or |
| | | | more and | more and |
| | | | 0.4 or less | 0.4 or less |
| | | Inner side starting point | Recessed | Recessed |
| | | Outer side starting point | Projected | Projected |
| | | L_{IG1}/L_{L} | More than | More than |
| | | | 0.2 and | 0.2 and |
| | | | less than | less than |
| | | | 0.6 | 0.6 |
| | | Relationship between | d_{IG1′} < | d_{IG1′} < |
| | | d_{IG1′}, d_{IG1″} and d_{G1} | d_{IG1″} < d_{G1} | d_{IG1″} < d_{G1} |
| | | Orientation of acute angle | Oriented to | Oriented to |
| | | formed by inclined groove and | vehicle | vehicle |
| | | tire width direction | mounting | mounting |
| | | | inner side | inner side |
| | Second | Presence | Yes | Yes |
| | inclined | Presence of terminating end in | Yes | Yes |
| | groove | land portion adjacent to | | |
| | | circumferential main groove | | |
| | | Outer side starting point | Projected | Projected |
| | | Orientation of acute angle | Oriented to | Oriented to |
| | | formed by inclined groove and | vehicle | vehicle |
| | | tire width direction | mounting | mounting |
| | | | inner side | inner side |
| | | L_{G2G4}/_{LG4G4} (terminating | 0.40 < | 0.40 < |
| | | between two fourth inclined | L_{G2G4}/L_{G4G4} < | L_{G2G4}/L_{G4G4} < |
| | | grooves adjacent to each other in | 0.60 | 0.60 |
| | | tire circumferential direction) | | |
| | Third | Presence | Yes | Yes |
| | inclined | Orientation of acute angle | Oriented to | Oriented to |
| | groove | formed by inclined groove and | vehicle | vehicle |
| | | tire width direction | mounting | mounting |
| | | | outer side | outer side |
| | | Position of terminating end | Reaching | Reaching |
| | | portion on vehicle mounting | and | and |
| | | outer side (whether terminating | terminating | terminating |
| | | end portion reaches and | | |
| | | terminates between end portions | | |
| | | on vehicle mounting inner side | | |
| | | of two adjacent first inclined | | |
| | | grooves in tire circumferential | | |
| | | direction) | | |
| | Fourth | Presence | Yes | Yes |
| | inclined | Orientation of acute angle | Oriented to | Oriented to |
| | groove | formed by inclined groove and | vehicle | vehicle |
| | | tire width direction | mounting | mounting |
| | | | inner side | inner side |
| | | Position of terminating end | Reaching | Reaching |
| | | portion on vehicle mounting | and | and |
| | | inner side (whether terminating | terminating | terminating |
| | | end portion reaches and | | |
| | | terminates between end portions | | |
| | | on vehicle mounting outer side | | |
| | | of two adjacent second inclined | | |
| | | grooves in tire circumferential | | |
| | | direction) | | |

| | | | |
|---|---|---|---|
| | d_{IG1 to 4}/d_{G} | More than | More than |
| | | 0.05 and | 0.05 and |
| | | less | less |
| | | than 0.85 | than 0.85 |
| | S_{SI}/S_{SO} | 1.0 | 1.3 |
| | θ_{GI}/θ_{GO} | 1.0 | 1.0 |
| Results | Dry steering stability | 98 | 99 |
| | Wet steering stability | 113 | 114 |

| | | | Inventive |
|---|---|---|---|
| Example | | | Example 63 |
| Conditions | First | Presence | Yes |
| | inclined | Presence of terminating end in land | Yes |
| | groove | portion adjacent to circumferential | |
| | | main groove | |
| | | L_{IG1}/L_{IG2} | 0.2 or more and |
| | | | 0.4 or less |
| | | Inner side starting point | Recessed |
| | | Outer side starting point | Projected |
| | | L_{IG1}/L_{L} | More than 0.2 |
| | | | and less than 0.6 |
| | | Relationship between d_{IG1′}, d_{IG1″} and d_{G1} | d_{IG1′} < d_{IG1″} < d_{G1} |
| | | Orientation of acute angle formed by | Oriented to |
| | | inclined groove and tire width direction | vehicle mounting |
| | | | inner side |
| | Second | Presence | Yes |
| | inclined | Presence of terminating end in land | Yes |
| | groove | portion adjacent to circumferential | |
| | | main groove | |
| | | Outer side starting point | Projected |
| | | Orientation of acute angle formed by | Oriented to |
| | | inclined groove and tire width direction | vehicle mounting |
| | | | inner side |
| | | L_{G2G4}/L_{G4G4} (terminating between two | 0.40 < |
| | | fourth inclined grooves adjacent to each | L_{G2G4}/_{LG4G4} < 0.60 |
| | | other in tire circumferential direction) | |
| | Third | Presence | Yes |
| | inclined | Orientation of acute angle formed by | Oriented to |
| | groove | inclined groove and tire width direction | vehicle mounting |
| | | | outer side |
| | | Position of terminating end portion on | Reaching and |
| | | vehicle mounting outer side (whether | terminating |
| | | terminating end portion reaches and | |
| | | terminates between end portions on | |
| | | vehicle mounting inner side of two | |
| | | adjacent first inclined grooves in tire | |
| | | circumferential direction) | |
| | Fourth | Presence | Yes |
| | inclined | Orientation of acute angle formed by | Oriented to |
| | groove | inclined groove and tire width direction | vehicle mounting |
| | | | inner side |
| | | Position of terminating end portion on | Reaching and |
| | | vehicle mounting inner side (whether | terminating |
| | | terminating end portion reaches and | |
| | | terminates between end portions on | |
| | | vehicle mounting outer side of two | |
| | | adjacent second inclined grooves in | |
| | | tire circumferential direction) | |

| | | |
|---|---|---|
| | d_{IG1 to 4}/d_{G} | More than 0.05 |
| | | and less than 0.85 |
| | S_{SI}/S_{SO} | 1.3 |
| | θ_{GI}/θ_{GO} | 3.5 |
| Results | Dry steering stability | 100 |
| | Wet steering stability | 113 |

As can be seen from Tables 5 and 6, any of the pneumatic tires of Inventive Examples 32 to 63, complying with the technical scope of the present technology, provides improved dry steering stability and wet steering stability in a well-balanced manner.

### Pneumatic Tires of Inventive Examples 32-1, 32-2, 49-1, and 49-2

Regarding Inventive Example 32, the tire in which the average groove width of the first circumferential main groove 110 was equal to the average groove width of the second circumferential main groove 120 was produced as Inventive Example 32-1, and the tire in which the average groove width of the first circumferential main groove 110 was larger than the average groove width of the second circumferential main groove 120 was produced as Inventive Example 32-2. Note that the tire size of the pneumatic tire in each Example was 255/35R19 (defined by JATMA).

Also, regarding Inventive Example 49, the tire in which the average groove widths of the first circumferential main groove 210, the second circumferential main groove 220, and the third circumferential main groove 230 were equal was produced as Inventive Example 49-1, and the tire in which the average groove width is larger in the order of the third circumferential main groove 230, the second circumferential main groove 220, and the first circumferential main groove 210 was produced as Inventive Example 49-2.

The aforementioned “evaluation of dry steering stability” and the aforementioned “evaluation of wet steering stability” were conducted on the pneumatic tires of Inventive Examples 32-1,32-2, 49-1, and 49-2. Note that in these Inventive Examples, wet steering stability was evaluated when the vehicle was traveling forward and when the vehicle was traveling backward.

When the evaluations of dry steering stability and wet steering stability in Inventive Example 32-1 were 100, the evaluations of dry steering stability and wet steering stability in Inventive Example 32-2 were 99 and 101. When the evaluations of dry steering stability and wet steering stability in Inventive Example 49-1 were 100, the evaluations of dry steering stability and wet steering stability in Inventive Example 49-2 were 99 and 101.

1-41. (canceled)

42. A pneumatic tire in which a mounting direction with respect to a vehicle is designated, the pneumatic tire comprising:
a plurality of circumferential main grooves on a tread surface of a tread portion,
in a tire plan view,
a groove center line of the circumferential main grooves being periodically displaced in a tire width direction while extending in a tire circumferential direction, and
a vehicle mounting inner side chamfered portion being formed at an edge portion on a vehicle mounting inner side of the circumferential main groove, a chamfer width of the vehicle mounting inner side chamfered portion being constant.

43. The pneumatic tire according to claim 42, wherein a vehicle mounting outer side chamfered portion, the chamfer width of which is constant, is formed at an edge portion on a vehicle mounting outer side of at least the circumferential main groove disposed on a vehicle mounting innermost side, of the plurality of circumferential main grooves.

44. The pneumatic tire according to claim 43, wherein the following relationship (1) is satisfied, where W_{AI} is a chamfer width of the vehicle mounting inner side chamfered portion and W_{AO} is a chamfer width of the vehicle mounting outer side chamfered portion:
W_{AO}<W_{AI} (1).

45. The pneumatic tire according to claim 42, wherein the following relationship (2) is satisfied, where S_{SI} is a total groove area on the vehicle mounting inner side of the circumferential main groove with respect to a tire equatorial plane and S_{SO} is a total groove area on a vehicle mounting outer side of the circumferential main groove with respect to the tire equatorial plane:
S_{SO}<S_{SI} (2).

46. The pneumatic tire according to claim 42, wherein an average groove width of the circumferential main groove on the vehicle mounting inner side is larger than an average groove width of the circumferential main groove on a vehicle mounting outer side in relation to any one pair of two of the circumferential main grooves adjacent to each other.

47. The pneumatic tire according to claim 42, wherein an average groove width of the circumferential main groove on the vehicle mounting inner side is larger than an average groove width of the circumferential main groove on a vehicle mounting outer side in all combinations of two of the circumferential main grooves adjacent to each other.

48. The pneumatic tire according to claim 42, wherein, in a tire meridian cross-sectional view, the following relationship (3) is satisfied, where d_{G} is a maximum value of a length in a tire radial direction from a tire surface profile, when the circumferential main groove is not present, to a groove bottom of the circumferential main groove and d_{CI} is a maximum value of a length in the tire radial direction from the tire surface profile to an innermost position in the tire radial direction of the vehicle mounting inner side chamfered portion:
0.05<d_{CI}/d_{G}<0.40 (3).

49. The pneumatic tire according to claim 42, wherein, in a tire meridian cross-sectional view, in relation to at least the circumferential main groove disposed on a vehicle mounting innermost side, of the plurality of circumferential main grooves, the following relationship (4) is satisfied, where θ_{GI} is an inclination angle of a vehicle mounting inner side groove wall of the circumferential main groove with respect to a tire radial direction and θ_{GO} is an inclination angle of a vehicle mounting outer side groove wall of the circumferential main groove with respect to the tire radial direction:
θ_{GI}<θ_{GO} (4).

50. The pneumatic tire according to claim 42, further comprising first inclined grooves, second inclined grooves, third inclined grooves, and fourth inclined grooves, wherein
the first inclined grooves extend toward respective vehicle mounting sides from the circumferential main groove, as a starting point, disposed on a vehicle mounting innermost side, of the plurality of circumferential main grooves, and a terminating end portion in a vehicle mounting outer side direction of the first inclined grooves terminates in a land portion adjacent on a vehicle mounting outer side to the circumferential main groove disposed on the vehicle mounting innermost side, of the plurality of circumferential main grooves, and a terminating end portion in a vehicle mounting inner side direction of the first inclined grooves terminates in a land portion adjacent on the vehicle mounting inner side to the circumferential main groove disposed on the vehicle mounting innermost side, of the plurality of circumferential main grooves,
the second inclined grooves extend toward the vehicle mounting outer side from the circumferential main groove, as a starting point, disposed on a vehicle mounting outermost side, of the plurality of circumferential main grooves, and a terminating end portion in the vehicle mounting outer side direction of the second inclined groove terminates in a land portion adjacent on the vehicle mounting outer side to the circumferential main groove disposed on the vehicle mounting outermost side, of the plurality of circumferential main grooves, and a terminating end portion in the vehicle mounting inner side direction of the second inclined groove terminates in communication with the circumferential main groove disposed on the vehicle mounting outermost side, of the plurality of circumferential main grooves,
the third inclined grooves are disposed such that both ends of the third inclined grooves terminate in the land portion adjacent on the vehicle mounting inner side to the circumferential main groove disposed on the vehicle mounting innermost side, of the plurality of circumferential main groove, and
the fourth inclined grooves are disposed such that both ends of the fourth inclined grooves terminate in the land portion adjacent on the vehicle mounting outer side to the circumferential main groove disposed on the vehicle mounting outermost side, of the plurality of circumferential main grooves.

51. The pneumatic tire according to claim 50, further comprising fifth inclined grooves disposed such that both ends of the fifth inclined grooves terminate in the land portion adjacent on the vehicle mounting outer side to the circumferential main groove disposed on the vehicle mounting outermost side, of the plurality of circumferential main grooves, the fifth inclined grooves being shorter in groove length than the fourth inclined grooves.

52. The pneumatic tire according to claim 51, wherein with respect to the tire width direction, the third inclined groove and the fourth inclined groove extend across ground contact edges, respectively, and the fifth inclined groove terminates at a tire equatorial plane side with respect to the ground contact edge.

53. The pneumatic tire according to claim 51, wherein an orientation of an acute angle formed by each of the second inclined groove, the third inclined groove, and the fourth inclined groove with respect to the tire width direction is equal to an orientation of an acute angle formed by the first inclined groove with respect to the tire width direction, and an orientation of an acute angle formed by the fifth inclined groove with respect to the tire width direction is different from the orientation of the acute angle formed by the first inclined groove with respect to the tire width direction.

54. The pneumatic tire according to claim 50, wherein an orientation of an acute angle formed by each of the second inclined groove and the fourth inclined groove with respect to the tire width direction is equal to an orientation of an acute angle formed by the first inclined groove with respect to the tire width direction, and an orientation of an acute angle formed by the third inclined groove with respect to the tire width direction is different from the orientation of the acute angle formed by the first inclined groove with respect to the tire width direction.

55. The pneumatic tire according to claim 50, wherein with respect to the tire circumferential direction, a terminating end portion on the vehicle mounting outer side of the third inclined groove terminates between end portions on the vehicle mounting inner side of two of the first inclined grooves adjacent to each other, and/or a terminating end portion on the vehicle mounting inner side of the fourth inclined groove terminates between end portions on the vehicle mounting outer side of two of the second inclined grooves adjacent to each other.

56. The pneumatic tire according to claim 50, wherein the first inclined grooves extend toward the respective vehicle mounting sides to communicate with a portion projected toward the vehicle mounting inner side and a portion recessed toward the vehicle mounting outer side of the circumferential main groove disposed on the vehicle mounting innermost side, of the plurality of circumferential main grooves.

57. The pneumatic tire according to claim 50, wherein the terminating end portion on the vehicle mounting inner side of the second inclined groove is in communication with a portion projected toward the vehicle mounting outer side of the circumferential main groove disposed on the vehicle mounting outermost side, of the plurality of circumferential main grooves.

58. The pneumatic tire according to claim 50, wherein the following relationship (5) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{L} is a length in the tire width direction of the land portion adjacent on the vehicle mounting outer side to the circumferential main groove disposed on the vehicle mounting innermost side, of the plurality of circumferential main grooves:
0.20<L_{IG1}/L_{L}<0.60 (5).

59. The pneumatic tire according to claim 50, wherein
the terminating end portion in the vehicle mounting outer side direction of the second inclined groove terminates between two of the fourth inclined grooves adjacent to each other in the tire circumferential direction, and
the following relationship (6) is satisfied, where L_{G4G4} is a length in the tire circumferential direction from one to an other of two of the fourth inclined grooves adjacent to each other and L_{G2G4} is a length in the tire circumferential direction from one of two of the fourth inclined grooves adjacent to each other to the terminating end portion of the second inclined groove:
0.40<L_{G2G4}/L_{G4G4}<0.60 (6).

60. The pneumatic tire according to claim 50, wherein the following relationships (7) to (10) are satisfied, where in a tire meridian cross-sectional view, d_{G} is a maximum value of a length in a tire radial direction from a tire surface profile, when the circumferential main groove and the inclined grooves are not present, to a groove bottom of the circumferential main groove and d_{IG1}, d_{IG2}, d_{IG3}, and d_{IG4} are respectively maximum values of lengths in the tire radial direction from the tire surface profile to groove bottoms of the first inclined groove, the second inclined groove, the third inclined groove, and the fourth inclined groove:
0.05<d_{IG1}/d_{G}<0.85 (7),
0.05<d_{IG2}/d_{G}<0.85 (8),
0.05<d_{IG3}/d_{G}<0.85 (9), and
0.05<d_{IG4}/d_{G}<0.85 (10).

61. The pneumatic tire according to claim 50, wherein the following relationship (11) is satisfied, where in a tire meridian cross-sectional view, d_{G1} is a maximum value of a length in a tire radial direction from a tire surface profile, when the circumferential main groove and the inclined grooves are not present, to a groove bottom of the circumferential main groove disposed on the vehicle mounting innermost side, of the plurality of circumferential main grooves, d_{IG1′} is a maximum value of a length in the tire radial direction from the tire surface profile to a groove bottom in a portion of the first inclined groove, which is located on the vehicle mounting outer side from the circumferential main groove, as a starting point, disposed on the vehicle mounting innermost side, of the plurality of circumferential main grooves, and d_{IG1″} is a maximum value of a length in the tire radial direction length from the tire surface profile to a groove bottom in a portion of the first inclined groove, which is located on the vehicle mounting inner side from the circumferential main groove, as a starting point, disposed on the vehicle mounting innermost side, of the plurality of circumferential main grooves:
d_{IG1′}<d_{IG1″}<d_{G1} (11).

62. The pneumatic tire according to claim 50, wherein the following relationship (12) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{IG2} is a length in the tire width direction of a portion of the first inclined groove, which extends toward the vehicle mounting inner side from the circumferential main groove disposed on the vehicle mounting innermost side, of the plurality of circumferential main grooves:
L_{IG1}<L_{IG2} (12).

63. A pneumatic tire in which a mounting direction with respect to a vehicle is designated, the pneumatic tire comprising:
a plurality of circumferential main grooves, first inclined grooves, and second inclined grooves on a tread surface of a tread portion,
in a tire plan view, a groove center line of the circumferential main grooves being periodically displaced in a tire width direction while extending in a tire circumferential direction,
the first inclined grooves extending toward respective vehicle mounting sides from the circumferential main groove, as a starting point, disposed on a vehicle mounting innermost side, of the plurality of circumferential main grooves, and
the second inclined grooves extending toward a vehicle mounting outer side from the circumferential main groove, as a starting point, disposed on a vehicle mounting outermost side, of the plurality of circumferential main grooves.

64. The pneumatic tire according to claim 63, wherein a terminating end portion in a vehicle mounting outer side direction of the first inclined grooves terminates in a land portion adjacent on the vehicle mounting outer side to the circumferential main groove disposed on the vehicle mounting innermost side, of the plurality of circumferential main grooves, and a terminating end portion in a vehicle mounting inner side direction of the first inclined grooves terminates in a land portion adjacent on a vehicle mounting inner side to the circumferential main groove disposed on the vehicle mounting innermost side, of the plurality of circumferential main grooves.

65. The pneumatic tire according to claim 63, wherein a terminating end portion in a vehicle mounting outer side direction of the second inclined groove terminates in a land portion adjacent on the vehicle mounting outer side to the circumferential main groove disposed on the vehicle mounting outermost side, of the plurality of circumferential main grooves, and a terminating end portion in a vehicle mounting inner side direction of the second inclined groove terminates in communication with the circumferential main groove disposed on the vehicle mounting outermost side, of the plurality of circumferential main grooves.

66. The pneumatic tire according to claim 63, wherein the following relationship (13) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{IG2} is a length in the tire width direction of a portion of the first inclined groove, which extends toward a vehicle mounting inner side from the circumferential main groove disposed on the vehicle mounting innermost side, of the plurality of circumferential main grooves:
L_{IG1}<L_{IG2} (13).

67. The pneumatic tire according to claim 63, wherein the first inclined grooves extend toward the respective vehicle mounting sides to communicate with a portion projected toward a vehicle mounting inner side and a portion recessed toward the vehicle mounting outer side of the circumferential main groove disposed on the vehicle mounting innermost side, of the plurality of circumferential main grooves.

68. The pneumatic tire according to claim 63, wherein the following relationship (14) is satisfied, where L_{IG1} is a length in the tire width direction of a portion of the first inclined groove, which extends toward the vehicle mounting outer side from the circumferential main groove disposed on the vehicle mounting innermost side, of the plurality of circumferential main grooves, and L_{L} is a length in the tire width direction of a land portion adjacent on the vehicle mounting outer side to the circumferential main groove disposed on the vehicle mounting innermost side, of the plurality of circumferential main grooves:
0.20<L_{IG1}/L_{L}<0.60 (14).

69. The pneumatic tire according to claim 63, wherein the following relationship (15) is satisfied, where in a tire meridian cross-sectional view, d_{G1} is a maximum value of a length in a tire radial direction from a tire surface profile, when the circumferential main groove and the inclined grooves are not present, to a groove bottom of the circumferential main groove disposed on the vehicle mounting innermost side, of the plurality of circumferential main grooves, d_{IG1′} is a maximum value of a length in the tire radial direction from the tire surface profile to a groove bottom in a portion of the first inclined groove, which is located on the vehicle mounting outer side from the circumferential main groove, as a starting point, disposed on the vehicle mounting innermost side, of the plurality of circumferential main grooves, and d_{IG1″} is a maximum value of a length in the tire radial direction length from the tire surface profile to a groove bottom in a portion of the first inclined groove, which is located on a vehicle mounting inner side from the circumferential main groove, as a starting point, disposed on the vehicle mounting innermost side, of the plurality of circumferential main grooves:
d_{IG1′}<d_{IG1″}<d_{G1} (15).

70. The pneumatic tire according to claim 63, wherein a terminating end portion on a vehicle mounting inner side of the second inclined groove is in communication with a portion projected toward the vehicle mounting outer side of the circumferential main groove disposed on the vehicle mounting outermost side, of the plurality of circumferential main grooves.

71. The pneumatic tire according to claim 63, further comprising third inclined grooves and fourth inclined grooves, wherein
the third inclined grooves are disposed such that both ends of the third inclined grooves terminate in a land portion adjacent on a vehicle mounting inner side to the circumferential main groove disposed on the vehicle mounting innermost side, of the plurality of circumferential main groove, and
the fourth inclined grooves are disposed such that both ends of the fourth inclined grooves terminate in a land portion adjacent on the vehicle mounting outer side to the circumferential main groove disposed on the vehicle mounting outermost side, of the plurality of circumferential main grooves.

72. The pneumatic tire according to claim 71, further comprising fifth inclined grooves disposed such that both ends of the fifth inclined grooves terminate in the land portion adjacent on the vehicle mounting outer side to the circumferential main groove disposed on the vehicle mounting outermost side, of the plurality of circumferential main grooves, the fifth inclined grooves being shorter in groove length than the fourth inclined grooves.

73. The pneumatic tire according to claim 72, wherein with respect to the tire width direction, the third inclined groove and the fourth inclined groove extend across ground contact edges, respectively, and the fifth inclined groove terminates at a tire equatorial plane side with respect to the ground contact edge.

74. The pneumatic tire according to claim 72, wherein an orientation of an acute angle formed by each of the second inclined groove, the third inclined groove, and the fourth inclined groove with respect to the tire width direction is equal to an orientation of an acute angle formed by the first inclined groove with respect to the tire width direction, and an orientation of an acute angle formed by the fifth inclined groove with respect to the tire width direction is different from the orientation of the acute angle formed by the first inclined groove with respect to the tire width direction.

75. The pneumatic tire according to claim 71, wherein an orientation of an acute angle formed by each of the second inclined groove and the fourth inclined groove with respect to the tire width direction is equal to an orientation of an acute angle formed by the first inclined groove with respect to the tire width direction, and an orientation of an acute angle formed by the third inclined groove with respect to the tire width direction is different from the orientation of the acute angle formed by the first inclined groove with respect to the tire width direction.

76. The pneumatic tire according to claim 71, wherein with respect to the tire circumferential direction, a terminating end portion on the vehicle mounting outer side of the third inclined groove terminates between end portions on the vehicle mounting inner side of two of the first inclined grooves adjacent to each other, and/or a terminating end portion on the vehicle mounting inner side of the fourth inclined groove terminates between end portions on the vehicle mounting outer side of two of the second inclined grooves adjacent to each other.

77. The pneumatic tire according to claim 71, wherein
a terminating end portion in a vehicle mounting outer side direction of the second inclined groove terminates between two of the fourth inclined grooves adjacent to each other in the tire circumferential direction, and
the following relationship (16) is satisfied, where L_{G4G4} is a length in the tire circumferential direction from one to an other of two of the fourth inclined grooves adjacent to each other and L_{G2G4} is a length in the tire circumferential direction from one of two of the fourth inclined grooves adjacent to each other to the terminating end portion of the second inclined groove:
0.40<L_{G2G4}/L_{G4G4}<0.60 (16).

78. The pneumatic tire according to claim 71, wherein the following relationships (17) to (20) are satisfied, where in a tire meridian cross-sectional view, d_{G} is a maximum value of a length in a tire radial direction from a tire surface profile, when the circumferential main groove and the inclined grooves are not present, to a groove bottom of the circumferential main groove and d_{IG1}, d_{IG2}, d_{IG3}, and d_{IG4} are respectively maximum values of lengths in the tire radial direction from the tire surface profile to groove bottoms of the first inclined groove, the second inclined groove, the third inclined groove, and the fourth inclined groove:
0.05<d_{IG1}/d_{G}<0.85 (17),
0.05<d_{IG2}/d_{G}<0.85 (18),
0.05<d_{IG3}/d_{G}<0.85 (19), and
0.05<d_{IG4}/d_{G}<0.85 (20).

79. The pneumatic tire according to claim 63, wherein the following relationship (21) is satisfied, where S_{SI} is a total groove area on a vehicle mounting inner side of the circumferential main groove with respect to a tire equatorial plane and S_{SO} is a total groove area on the vehicle mounting outer side of the circumferential main groove with respect to the tire equatorial plane:
S_{SO}<S_{SI} (21).

80. The pneumatic tire according to claim 63, wherein an average groove width of the circumferential main groove on a vehicle mounting inner side is larger than an average groove width of the circumferential main groove on the vehicle mounting outer side in relation to any one pair of two of the circumferential main grooves adjacent to each other.

81. The pneumatic tire according to claim 63, wherein an average groove width of the circumferential main groove on a vehicle mounting inner side is larger than an average groove width of the circumferential main groove on the vehicle mounting outer side in all combinations of two of the circumferential main grooves adjacent to each other.

82. The pneumatic tire according to claim 63, wherein in a tire meridian cross-sectional view, in relation to at least the circumferential main groove disposed on the vehicle mounting innermost side, of the plurality of circumferential main grooves, the following relationship (22) is satisfied, where OM is an inclination angle of a vehicle mounting inner side groove wall of the circumferential main groove with respect to a tire radial direction and θ_{GO} is an inclination angle of a vehicle mounting outer side groove wall of the circumferential main groove with respect to the tire radial direction:
θ_{GI}<θ_{GO} (22).
